(19) United States
(12) Patent Application Publication
(10) Pub. No.: US 2011/0275583 A1
(43) Pub. Date: Nov. 10, 2011

(54) Synergistic active compound combinations

(75) Inventors: Thomas BRETSCHNEIDER, Lohmar (DE); Heike HUNGENBERG, Langenfeld (DE); Martin Füsslein, Dusseldorf (DE)

(73) Assignee: Bayer CropScience AG, Monheim am Rhein (DE)

(21) Appl. No.: 13/096,096

(22) Filed: Apr. 28, 2011

Related U.S. Application Data
(60) Provisional application No. 61/328,800, filed on Apr. 28, 2010.

(30) Foreign Application Priority Data
Apr. 28, 2010 (EP) 10161282.8
Nov. 9, 2010 (EP) 10190522.2

(51) Int. Cl. A01N 43/16; A01N 43/54; A01P 7/00; A01N 43/08; A01N 37/34; A01N 43/56; A01N 43/40; A01N 43/88

(52) U.S. Cl. 514/30; 514/333; 514/256; 514/341; 514/229.2; 514/471; 514/53; 514/521; 514/406

(57) ABSTRACT

Novel active compound combinations comprising compounds of the formula (I) and compounds of the formula (II) have very good insecticidal and acaricidal properties.

### BACKGROUND OF THE INVENTION

It is already known that compounds of the formula (I)

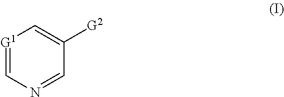

in which
(Ia)
G¹ represents N, CH or C-halogen,
G² represents

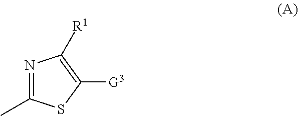

wherein
R¹ represents hydrogen or alkyl and
G³ represents optionally substituted heterocyclyl, represents optionally substituted heteroaryl or represents optionally substituted aryl or
(Ib)
G¹ represents N or C-halogen,
G² represents

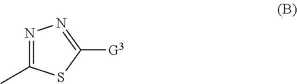

wherein
G³ represents optionally substituted heterocyclyl, represents optionally substituted heteroaryl or represents optionally substituted aryl or
(Ic)
G¹ represents CH,
G² represents

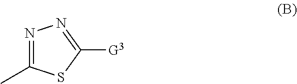

wherein
G³ represents optionally substituted heterocyclyl or represents substituted furanyl or represents thienyl which is substituted by halogen, nitro, amino, alkylamino, dialkylamino, haloalkyl, cycloalkylalkyl, alkoxy, haloalkoxy, alkylthio, alkoxyalkyl, bis(alkoxy)alkyl, alkoxycarbonyl, alpha-hydroxyiminoalkoxycarbonylmethyl, alpha-alkoxyiminoalkoxycarbonylmethyl, C(X)NR²R³, (in which X represents oxygen or sulphur, R² represents hydrogen or alkyl and R³ represents alkyl, haloalkyl, alkoxy, cyanoalkyl, alkynyl, cycloalkyl, cycloalkylalkyl, alkoxyalkyl, alkylthioalkyl or arylalkyl or R² and R³ together with the nitrogen atom to which they are attached form a ring), alkylsulphinyl, alkylsulphonyl, heterocyclyl, aryl (which for its part may be substituted by halogen, cyano, nitro, alkyl or haloalkyl), heteroaryl (which for its part may be substituted by halogen, nitro, alkyl, haloalkyl, alkoxy, haloalkoxy, alkoxyalkyl, alkylthio, alkylthioalkyl or cycloalkyl), heteroarylalkyl (which for its part may be substituted by halogen, nitro, alkyl, haloalkyl, alkoxy, haloalkoxy, alkoxyalkyl, alkylthio, alkylthioalkyl or cycloalkyl) or represents in each case optionally substituted hetaryl from the group consisting of pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl or represents cyano-, nitro-, haloalkoxy- or heterocyclyl-substituted aryl
or
(Id)
G¹ represents N, CH or C-halogen,
G² represents

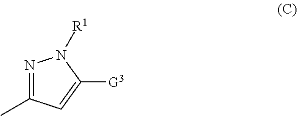

wherein
R¹ represents hydrogen or alkyl and
G³ represents optionally substituted heterocyclyl or represents optionally substituted heteroaryl or represents optionally substituted aryl,
   and also salts, metal complexes and N-oxides of the compounds of the formula (I) have insecticidal activity (cf. WO 2010/006713).

However, the acaricidal and/or insecticidal activity and/or the activity spectrum and/or the compatibility of these compounds with plants, in particular with respect to crop plants, is not always sufficient.

### SUMMARY OF THE INVENTION

The present application relates to novel active compound combinations which comprise, firstly, at least one compound of the formula (I) and, secondly, at least one further active compound from the class of the macrolides, the carboxylates, the neonicotinoids, the chitin synthesis inhibitors, the moulting hormone agonists, the organophosphates or the carbamates, the phthalic acid diamides, the tetronic or tetramic acid, the pyrethroids or other classes and which are highly suitable for controlling animal pests such as insects and unwanted acarids. The invention also relates to methods for controlling animal pests on plants and seed, to a method for protecting seed and not least to the seed treated with the active compound combinations according to the invention.

### DETAILED DESCRIPTION OF THE INVENTION

It has now been found that active compound combinations comprising at least one and preferably exactly one compound of the formula (I)

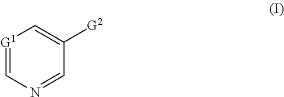

in which
(Ia)
G¹ represents N, CH or C-halogen,
G² represents

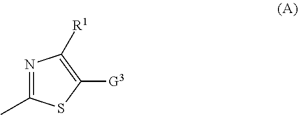

wherein
R¹ represents hydrogen or alkyl and
G³ represents optionally substituted heterocyclyl, represents optionally substituted heteroaryl or represents optionally substituted aryl or
(Ib)
G¹ represents N or C-halogen,
G² represents

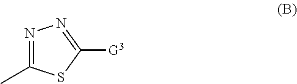

wherein
G³ represents optionally substituted heterocyclyl, represents optionally substituted heteroaryl or represents optionally substituted aryl or
(Ic)
G¹ represents CH,
G² represents

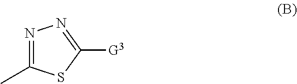

wherein
G³ represents optionally substituted heterocyclyl or represents substituted furanyl or represents thienyl which is substituted by halogen, nitro, amino, alkylamino, dialkylamino, haloalkyl, cycloalkylalkyl, alkoxy, haloalkoxy, alkylthio, alkoxyalkyl, bis(alkoxy)alkyl, alkoxycarbonyl, alpha-hydroxyiminoalkoxycarbonylmethyl, alpha-alkoxyiminoalkoxycarbonylmethyl, C(X)NR²R³, (in which X represents oxygen or sulphur, R² represents hydrogen or alkyl and R³ represents alkyl, haloalkyl, alkoxy, cyanoalkyl, alkynyl, cycloalkyl, cycloalkylalkyl, alkoxyalkyl, alkylthioalkyl or arylalkyl or R² and R³ together with the nitrogen atom to which they are attached form a ring), alkylsulphinyl, alkylsulphonyl, heterocyclyl, aryl (which for its part may be substituted by halogen, cyano, nitro, alkyl or haloalkyl), heteroaryl (which for its part may be substituted by halogen, nitro, alkyl, haloalkyl, alkoxy, haloalkoxy, alkoxyalkyl, alkylthio, alkylthioalkyl or cycloalkyl), heteroarylalkyl (which for its part may be substituted by halogen, nitro, alkyl, haloalkyl, alkoxy, haloalkoxy, alkoxyalkyl, alkylthio, alkylthioalkyl or cycloalkyl) or represents in each case optionally substituted hetaryl from the group consisting of pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl or represents cyano-, nitro-, haloalkoxy- or heterocyclyl-substituted aryl
or
(Id)
G¹ represents N, CH or C-halogen,
G² represents

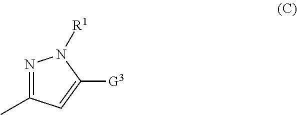

wherein
R¹ represents hydrogen or alkyl and
G³ represents optionally substituted heterocyclyl or represents optionally substituted heteroaryl or represents optionally substituted aryl,
   and also salts, metal complexes and N-oxides of the compounds of the formula (I)
   and one or more further active compounds from the group (of the formula) (II) are highly suitable for controlling animal pests such as, for example, insects and/or acarids.

The active compounds of the formula (II) have been classified according to the IRAC Classification (Version 6.1 August 2008) in various classes (1-29) and groups according to their mechanism of action:

Acetylcholine Esterase (AChE) Inhibitors II-1

II-1.A carbamates,

for example alanycarb (II-1.A-1), aldicarb (II-1.A-2), aldoxycarb (II-1.A-3), allyxycarb (II-1.A-4), aminocarb (II-1.A-5), bendiocarb (II-1.A-6), benfuracarb (II-1.A-7), bufencarb (II-1.A-8), butacarb (II-1.A-9), butocarboxim (II-1.A-10), butoxycarboxim (II-1.A-11), carbaryl (II-1.A-12), carbofuran (II-1.A-13), carbosulfan (II-1.A-14), cloethocarb (II-1.A-15), dimetilan (II-1.A-16), ethiofencarb (II-1.A-17), fenobucarb (II-1.A-18), fenothiocarb (II-1.A-19), formetanate (II-1.A-20), furathiocarb (II-1.A-21), isoprocarb (II-1.A-22), metam-sodium (II-1.A-23), methiocarb (II-1.A-24), methomyl (II-1.A-25), metolcarb (II-1.A-26), oxamyl (II-1.A-27), pirimicarb (II-1.A-28), promecarb (II-1.A-29), propoxur (II-1.A-30), thiodicarb (II-1.A-31), thiofanox (II-1.A-32), trimethacarb (II-1.A-33), XMC (II-1.A-34), xylylcarb (II-1.A-35)

II-1.B organophosphates,

for example acephate azamethiphos (II-1.B-2), azinphos (-methyl, -ethyl) (II-1.B-3), bromophos-ethyl (II-1.B-4), bromfenvinfos (-methyl) (II-1.B-5), butathiofos (II-1.B-6), cadusafos (II-1.B-7), carbophenothion (II-1.B-8), chlorethoxyfos (II-1.B-9), chlorfenvinphos (II-1.B-10), chlormephos (II-1.B-11), chlorpyrifos (-methyl/-ethyl) (II-1.B-12), coumaphos (II-1.B-13), cyanofenphos (II-1.B-14), cyanophos (II-1.B-15), chlorfenvinphos (II-1.B-16), demeton-S-methyl (II-1.B-17), demeton-S-methylsulphone (II-1.B-18), dialifos (II-1.B-19), diazinon dichlofenthion (II-1.B-21), dichlorvos/DDVP (II-1.B-22), dicrotophos (II-1.B-23), dimethoate (II-1.B-24), dimethylvinphos (II-1.B-25), dioxabenzofos (II-1.B-26), disulfoton (II-1.B-27), EPN (II-1.B-28), ethion (II-1.B-29), ethoprophos (II-1.B-30), etrimfos (II-1.B-31), famphur (II-1.B-32), fenamiphos (II-1.B-33), fenitrothion (II-1.B-34), fensulfothion (II-1.B-35), fenthion (II-1.B-36), flupyrazofos (II-1.B-37), fonofos (II-1.B-38), formothion (II-1.B-39), fosmethilan (II-1.B-40), fosthiazate (II-1.B-41), heptenophos (II-1.B-42), iodofenphos (II-1.B-43), iprobenfos isazofos (II-1.B-45), isofenphos (II-1.B-46), isopropyl (II-1.B-47), O-salicylate (II-1.B-48), isoxathion (II-1.B-49), malathion mecarbam (II-1.B-51), methacrifos (II-1.B-52), methamidophos (II-1.B-53), methidathion (II-1.B-54), mevinphos (II-1.B-55), monocrotophos (II-1.B-56), naled (II-1.B-57), omethoate (II-1.B-58), oxydemeton-methyl (II-1.B-59), parathion (-methyl/-ethyl) (II-1.B-60), phenthoate (II-1.B-61), phorate (II-1.B-62), phosalone (II-1.B-63), phosmet (II-1.B-64), phosphamidon phosphocarb (II-1.B-66), phoxim (II-1.B-67), pirimiphos (-methyl/-ethyl) (II-1.B-68), profenofos (II-1.B-69), propaphos (II-1.B-70), propetamphos (II-1.B-71), prothiofos (II-1.B-72), prothoate (II-1.B-73), pyraclofos (II-1.B-74), pyridaphenthion (II-1.B-75), pyridathion (II-1.B-76), quinalphos (II-1.B-77), sebufos (II-1.B-78), sulfotep (II-1.B-79), sulprofos (II-1.B-80), tebupirimfos (II-1.B-81), temephos (II-1.B-82), terbufos (II-1.B-83), tetrachlorvinphos (II-1.B-84), thiometon (II-1.B-85), triazophos (II-1.B-86), triclorfon (II-1.B-87), vamidothion (II-1.B-88)

GABA-Controlled Chloride Channel Antagonists II-2

II-2A Organochlorines,

for example camphechlor (II-2A-1), chlordane (II-2A-2), endosulfan (II-2A-3), gamma-HCH (II-2A-4), HCH (II-2A-5), heptachlor (II-2A-6), lindane (II-2A-7), methoxychlor (II-2A-8)

II-2B Fiproles (Phenylpyrazoles),

for example acetoprole (II-2B-1), ethiprole (II-2B-2), fipronil (II-2B-3), pyrafluprole (II-2B-4), pyriprole (II-2B-5), vaniliprole (II-2B-6) sodium channel modulators/voltage-dependent sodium channel blockers II-3

II-3 Pyrethroids,

for example acrinathrin (II-3-1), allethrin (d-cis-trans, d-trans) (II-3-2), beta-cyfluthrin (II-3-3), bifenthrin (II-3-4), bioallethrin (II-3-5), bioallethrin S-cyclopentyl isomer (II-3-6), bioethanomethrin (II-3-7), biopermethrin (II-3-8), bioresmethrin (II-3-9), chlovaporthrin (II-3-10), cis-cypermethrin (II-3-11), cis-resmethrin (II-3-12), cis-permethrin (II-3-13), clocythrin (II-3-14), cycloprothrin (II-3-15), cyfluthrin (II-3-16), cyhalothrin (II-3-17), cypermethrin (alpha-, beta-, theta-, zeta-)(II-3-18), cyphenothrin (II-3-19), deltamethrin (II-3-20), empenthrin (1R isomer) (II-3-21), esfenvalerate (II-3-22), etofenprox (II-3-23), fenfluthrin (II-3-24), fenpropathrin (II-3-25), fenpyrithrin (II-3-26), fenvalerate (II-3-27), flubrocythrinate (II-3-28), flucythrinate (II-3-29), flufenprox (II-3-30), flumethrin (II-3-31), fluvalinate (II-3-32), fubfenprox (II-3-33), gamma-cyhalothrin (II-3-34), imiprothrin (II-3-35), kadethrin (II-3-36), lambda-cyhalothrin (II-3-37), metofluthrin (II-3-38), permethrin (cis-, trans-) (II-3-39), phenothrin (1R-trans isomer) (II-3-40), prallethrin (II-3-41), profluthrin (II-3-42), protrifenbute (II-3-43), pyresmethrin (II-3-44), resmethrin (II-3-45), RU 15525 (II-3-46), silafluofen (II-3-47), tau-fluvalinate (II-3-48), tefluthrin (II-3-49), terallethrin (II-3-50), tetramethrin (−1R isomer) (II-3-51), tralomethrin (II-3-52), transfluthrin (II-3-53), ZXI 8901 (II-3-54), pyrethrin (pyrethrum) (II-3-55), eflusilanate (II-3-56), DDT (II-3-57), methoxychlor (II-3-58),

Agonists/Antagonists of the Nicotinergic Acetylcholine Receptor II-4

II-4A Chloronicotinyls,

for example acetamiprid (II-4A-1), clothianidin (II-4A-2), dinotefuran (II-4A-3), imidacloprid (II-4A-4), imidaclothiz (II-4A-5), nitenpyram (II-4A-6), nithiazine (II-4A-7), thiacloprid (II-4A-8), thiamethoxam (II-4A-9),

II-4B nicotine (II-4B-1), bensultap (II-4B-2), cartap (II-4B-3), thiosulfap-sodium (II-4B-4), thiocylam (II-4C-4)

Allosteric Modulators of the Acetylcholine Receptor (Agonists)

II-5 Spinosyns,

for example spinosad (II-5-1), spinetoram (II-5-2)

Chloride Channel Activators

II-6 Mectins/Macrolides,

for example abamectin (II-6-1), emamectin (II-6-2), emamectin benzoate (II-6-3), ivermectin (II-6-4), lepimectin (II-6-5), milbemectin (II-6-6)

II-7A Juvenile Hormone Analogues,

for example hydroprene (II-7A-1), kinoprene (II-7A-2), methoprene (II-7A-3), epofenonane (II-7A-4), triprene (II-7A-5), fenoxycarb (II-7B-1),

pyriproxifen (II-7C-1), diofenolan (II-7C-2)

Active Compounds Having Unknown or Non-Specific Mechanisms of Action

II-8 Fumigants,

for example methyl bromide (II-8A-1), chloropicrin (II-8B-1), sulphuryl fluoride (II-8C-1)

II-9 Selective Antifeedants,

for example cryolite (II-9A-1), pymetrozine (II-9B-1), pyrifluquinazone (NNI0101) (II-9B-2), flonicamid (II-9C-1)

II-10 Mite Growth Inhibitors,

for example clofentezine (II-10A-1), hexythiazox (II-10A-2), etoxazole (II-10B-1)

Inhibitors of Oxidative Phosphorylation, ATP Disruptors II-12

II-12A Diafenthiuron (II-12A-1)

II-12B Organotin Compounds,

for example azocyclotin (II-12B-1), cyhexatin (II-12B-2), fenbutatin oxide (II-12B-3)

II-12C Propargite (II-12C-1), Tetradifon (II-12C-2)

Decouplers of Oxidative Phosphorylation by Interruption of the H-Proton Gradient II-13

chlorfenapyr (II-13-1)

binapacyrl (II-13-2), dinobuton (II-13-3), dinocap (II-13-4), DNOC (II-13-5)

Microbial Disruptors of the Insect Gut Membrane

Bacillus thuringiensis strains (II-13-6)

Inhibitors of Chitin Biosynthesis

II-15 Benzoylureas,

for example bistrifluoron (II-15-1), chlorfluazuron (II-15-2), diflubenzuron (II-15-3), fluazuron (II-15-4), flucycloxuron (II-15-5), flufenoxuron (II-15-6), hexaflumuron (II-15-7), lufenuron (II-15-8), novaluron (II-15-9), noviflumuron (II-15-10), penfluoron (II-15-11), teflubenzuron (II-15-12), triflumuron (II-15-13)

II-16 Buprofezin (II-16-1)

moulting disruptors cyromazine (II-17-1)

ecdysone agonists/disruptors (II-18)

II-18A Diacylhydrazines,

for example chromafenozide (II-18A-1), halofenozide (II-18A-2), methoxyfenozide (II-18A-3), tebufenozide (II-18A-4), fufenozide (JS-118) (II-18A-5)

azadirachtin (II-18B-1)

Octopaminergic Agonists

for example amitraz (II-19-1)

II-20 Site III Electron Transport Inhibitors/Site II Electron Transport Inhibitors

hydramethylnon (II-20A-1)

acequinocyl (II-20B-1)

fluacrypyrim (II-20C-1)

cyflumetofen (II-20D-1), cyenopyrafen (II-20D-2)

Electron Transport Inhibitors

II-21 Site I Electron Transport Inhibitors

from the group of the METI acaricides,

for example fenazaquin (II-

II-22 Blockers of Voltage-Gated Sodium Channels

for example indoxacarb (II-22A-1)

for example metaflumizone (BAS 3201) (II-22B-1)

II-23 Inhibitors of Fatty Acid Biosynthesis

II-23A Tetronic Acid Derivatives

for example spirodiclofen (II-23A-1), spiromesifen (II-23A-2)

II-23B Tetramic Acid Derivatives,

for example spirotetramat (II-23B-1)

II-25 Neuronal Inhibitors Having an Unknown Mechanism of Action

bifenazate (II-25-1)

ryanodine receptor effectors

II-28 Diamides,

for example flubendiamides (II-28-1),

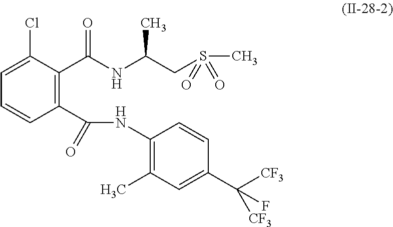

chlorantraniliprole (Rynaxypyr, II-28-3),

cyantraniliprole (Cyazypyr, II-28-4)

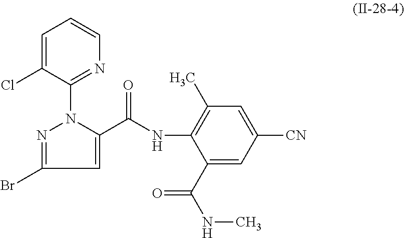

II-29 Active Compounds Having an Unknown Mechanism of Action

amidoflumet (II-29-1), benclothiaz (II-29-2), benzoximate (II-29-3), bromopropylate (II-29-4), buprofezin (II-29-5), chinomethionat (II-29-6), chlordimeform (II-29-7), chlorobenzilate (II-29-8), clothiazoben (II-29-9), cycloprene (II-29-10), dicofol (II-29-11), dicyclanil (II-29-12), fenoxacrim (II-29-13), fentrifanil (II-29-14), flubenzimine (II-29-15), fluensulfone (5-chloro-2-[(3,4,4-trifluorobut-3-en-1-yl)sulphonyl]-1,3-thiazole), flufenerim (II-29-16), flutenzin (II-29-17), gossyplure (II-29-18), japonilure (II-29-19), metoxadiazone (II-29-20), petroleum (II-29-21), potassium oleate (II-29-22), pyridalyl (II-29-23), sulfluramid (II-29-24), tetrasul (II-29-25), triarathene (II-29-26), verbutin (II-29-27), furthermore preparations based on Bacillus firmus (I-1582, BioNeem, Votivo), 4-{[(6-chloropyrid-3-yl)methyl](methyl)amino}furan-2(5H)-one (known, from EP-A-0 539 588) (II-29-28), 4-{[(6-chloropyrid-3-yl)methyl](2,2-difluoroethyl)amino}furan-2(5H)-one (known from WO 2007/115644) (II-29-29), 4-{[(6-chloropyrid-3-yl)methyl](cyclopropyl)amino}furan-2(5H)-one (known from EP-A-0 539 588) (II-29-30), 1-{2-fluoro-4-methyl-5-[(2,2,2-trifluoroethyl)sulphinyl]phenyl}-3-(trifluoromethyl)-1H-1,2,4-triazol-5-amine (known from WO 2006/043635) (II-29-31) and sulfoxaflor (II-29-32).

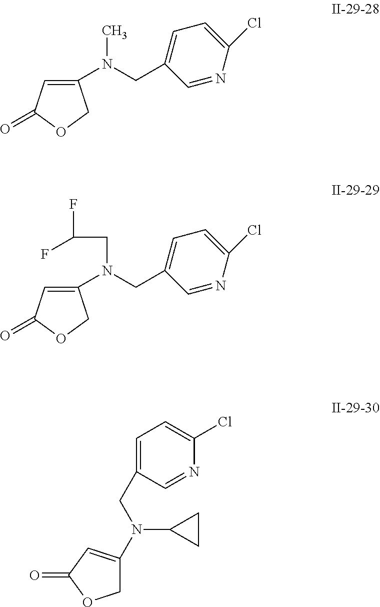

The active compounds referred to in this description by their common name are known, for example, from “The Pesticide Manual” 13th Ed., British Crop Protection Council 2003, and the website http://www.alanwood.net/pesticides/.

If, in the context of this description, the short form of the common name of an active compound is used, this comprises in each case all customary derivatives, such as the esters and salts, and isomers, in particular optical isomers, especially the commercially available form or forms. If the common name refers to an ester or a salt, this in each case also comprises all other customary derivatives, such as other esters and salts, the free acids and neutral compounds, and isomers, in particular optical isomers, especially the commercially available form or forms. The given chemical compound names refer to at least one of the compounds embraced by the common name, frequently to a preferred compound.

Depending, inter alia, on the nature of the substituents, the compounds of the formula (I) can be present as optical isomers or mixtures of isomers in varying compositions, which can be separated, if desired, in a customary manner. The present invention provides both the pure isomers and the isomer mixtures, their preparation and use and compositions comprising them. However, the following text will, for the sake of simplicity, always mention compounds of the formula (I), even though this is understood as meaning not only the pure compounds, but also, if appropriate, mixtures with various amounts of isomeric compounds.

The active compound combinations according to the invention preferably comprise compounds of the formula (I)

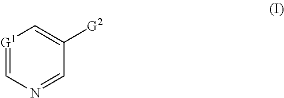

in which
(Ia)
G¹ represents N, CH or C-halogen,
G² represents

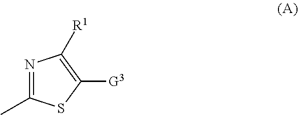

wherein
R¹ represents hydrogen or C₁-C₆-alkyl and
G³ represents in each case optionally halogen-, cyano-, nitro-, C₁-C₆-alkyl-, C₁-C₆-haloalkyl-, C₃-C₆-cycloalkyl-, C₁-C₆-alkoxy-, C₁-C₆-haloalkoxy-, C₁-C₆-alkylthio-, C₁-C₆-haloalkylthio-, C₁-C₆-alkylsulphinyl-, C₁-C₆-alkyl sulphonyl-, C₁-C₆-haloalkylsulphinyl-, C₁-C₆-haloalkylsulphonyl-, amino-, C₁-C₆-alkylamino-, di(C₁-C₆-alkyl)amino-, C₁-C₆-alkylcarbonylamino-, C₁-C₆-alkoxycarbonylamino-, C₁-C₆-alkoxy-C₁-C₆-alkyl-, C₁-C₆-haloalkoxy-C₁-C₆-alkyl-, C₂-C₆-alkenyl-, C₂-C₆-alkynyl-, C₁-C₆-alkyl-C₃-C₆-cycloalkyl-, C₁-C₆-alkylcarbonyl-, C₁-C₆-alkoxycarbonyl-, aminocarbonyl-, pyridyl- or pyrimidyl-substituted oxazolinyl, dihydrooxadiazinyl, dihydrodioxazinyl or hydroxypyridyl,
represents pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl (in particular pyridyl, pyrimidyl, imidazolyl, pyrazolyl, triazinyl, thiazolyl, thiadiazolyl, oxadiazolyl or oxazolyl), each of which is optionally substituted by halogen, nitro, amino, C₁-C₆-alkylamino, di(C₁-C₆-alkyl)amino, C₁-C₆-alkyl, C₁-C₆-haloalkyl, C₃-C₆-cycloalkyl-C₁-C₆-alkyl, C₁-C₆-alkoxy, C₁-C₆-haloalkoxy, C₁-C₆-alkylthio, C₁-C₆-alkoxy-C₁-C₆-alkyl, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, cyano-C₁-C₆-alkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₃-C₅-alkanediyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl or C₃-C₆-cycloalkyl), the heteroarylalkyl radicals triazolyl-C₁-C₆-alkyl, pyridyl-C₁-C₆-alkyl, pyrimidyl-C₁-C₆-alkyl or oxadiazolyl-C₁-C₆-alkyl (which for their part may be substituted by C₁-C₆-alkyl) or
represents optionally halogen-, cyano-, C₁-C₆-alkyl-, C₁-C₆-haloalkyl-, C₁-C₆-alkoxy-, C₁-C₆-haloalkoxy-, dioxolanyl-, piperidinonyl-, pyrrolidinonyl- or dihydrodioxazinyl-substituted phenyl or
(Ib)
G¹ represents N or C-halogen,
G² represents

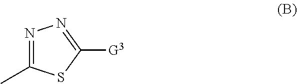

wherein
G³ represents in each case optionally halogen-, cyano-, nitro-, C₁-C₆-alkyl-, C₁-C₆-haloalkyl-, C₃-C₆-cycloalkyl-, C₁-C₆-alkoxy-, C₁-C₆-haloalkoxy-, C₁-C₆-alkylthio-, C₁-C₆-haloalkylthio-, C₁-C₆-alkylsulphinyl-, C₁-C₆-alkylsulphonyl-, C₁-C₆-haloalkylsulphinyl-, C₁-C₆-haloalkylsulphonyl-, amino-, C₁-C₆-alkylamino-, di(C₁-C₆-alkyl)amino-, C₁-C₆-alkylcarbonylamino-, C₁-C₆-alkoxycarbonylamino-, C₁-C₆-alkoxy-C₁-C₆-alkyl-, C₁-C₆-haloalkoxy-C₁-C₆-alkyl-, C₂-C₆-alkenyl-, C₂-C₆-alkynyl-, C₁-C₆-alkyl-C₃-C₆-cycloalkyl-, C₁-C₆-alkylcarbonyl-, C₁-C₆-alkoxycarbonyl-, aminocarbonyl-, pyridyl- or pyrimidyl-substituted oxazolinyl, dihydrooxadiazinyl, dihydrodioxazinyl or hydroxypyridyl,
represents pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl (in particular pyridyl, pyrimidyl, imidazolyl, pyrazolyl, triazinyl, thiazolyl, thiadiazolyl, oxadiazolyl or oxazolyl), each of which is optionally substituted by halogen, nitro, amino, C₁-C₆-alkylamino, di(C₁-C₆-alkyl)amino, C₁-C₆-alkyl, C₁-C₆-haloalkyl, C₃-C₆-cycloalkyl-C₁-C₆-alkyl, C₁-C₆-alkoxy, C₁-C₆-haloalkoxy, C₁-C₆-alkylthio, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, cyano-C₁-C₆-alkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl or C₃-C₆-cycloalkyl), the heteroarylalkyl radicals triazolyl-C₁-C₆-alkyl, pyridyl-C₁-C₆-alkyl, pyrimidyl-C₁-C₆-alkyl or oxadiazolyl-C₁-C₆-alkyl (which for their part may be substituted by C₁-C₆-alkyl) or
represents optionally halogen-, cyano-, C₁-C₆-alkyl-, C₁-C₆-haloalkyl-, C₁-C₆-alkoxy-, C₁-C₆-haloalkoxy-, dioxolanyl-, piperidinonyl-, pyrrolidinonyl- or dihydrodioxazinyl-substituted phenyl or
(Ic)
G¹ represents CH,
G² represents

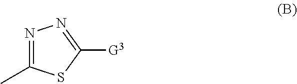

wherein
G³ represents in each case optionally halogen-, cyano-, nitro-, C₁-C₆-alkyl-, C₁-C₆-haloalkyl-, C₃-C₆-cycloalkyl-, C₁-C₆-alkoxy-, C₁-C₆-haloalkoxy-, C₁-C₆-alkylthio-, C₁-C₆-haloalkylthio-, C₁-C₆-alkylsulphinyl-, C₁-C₆-alkylsulphonyl-, C₁-C₆-haloalkylsulphinyl-, C₁-C₆-haloalkylsulphonyl-, amino-, C₁-C₆-alkylamino-, di(C₁-C₆-alkyl)amino-, C₁-C₆-alkylcarbonylamino-, C₁-C₆-alkoxycarbonylamino-, C₁-C₆-alkoxy-C₁-C₆-alkyl-, C₁-C₆-haloalkoxy-C₁-C₆-alkyl-, C₂-C₆-alkenyl-, C₂-C₆-alkynyl-, C₁-C₆-alkyl-C₃-C₆-cycloalkyl-, C₁-C₆-alkylcarbonyl-, C₁-C₆-alkoxycarbonyl-, aminocarbonyl-, pyridyl- or pyrimidyl-substituted oxazolinyl, dihydrooxadiazinyl, dihydrodioxazinyl or hydroxypyridyl or
represents furanyl which is substituted by halogen, nitro, amino, C₁-C₆-alkylamino, di-C₁-C₆-alkylamino, C₁-C₆-alkyl, C₁-C₆-haloalkyl, C₃-C₆-cycloalkyl-C₁-C₆-alkyl, C₁-C₆-alkoxy, C₁-C₆-haloalkoxy, C₁-C₆-alkylthio, C₁-C₆-alkoxy-C₁-C₆-alkyl, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, C₁-C₆-cyanoalkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl and C₃-C₆-cycloalkyl), the heteroarylalkyl radicals triazolylalkyl, pyridylalkyl, pyrimidylalkyl or oxadiazolylalkyl (which for their part may be substituted by C₁-C₆-alkyl) or
represents thienyl which is substituted by halogen, nitro, amino, C₁-C₆-alkylamino, di-C₁-C₆-alkylamino, C₁-C₆-haloalkyl, C₃-C₆-cycloalkyl-C₁-C₆-alkyl, C₁-C₆-alkoxy, C₁-C₆-haloalkoxy, C₁-C₆-alkylthio, C₁-C₆-alkoxy-C₁-C₆-alkyl, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, C₁-C₆-cyanoalkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl or C₃-C₆-cycloalkyl), the heteroarylalkyl radicals triazolylalkyl, pyridylalkyl, pyrimidylalkyl or oxadiazolylalkyl (which for their part may be substituted by C₁-C₆-alkyl) or
represents pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl (in particular pyridyl, pyrimidyl, imidazolyl, pyrazolyl, triazinyl, thiazolyl, thiadiazolyl, oxadiazolyl or oxazolyl), each of which is optionally substituted by halogen, nitro, amino, C₁-C₆-alkylamino, di(C₁-C₆-alkyl)amino, C₁-C₆-alkyl, C₁-C₆-haloalkyl, C₃-C₆-cycloalkyl-C₁-C₆-alkyl, C₁-C₆-alkoxy, C₁-C₆-haloalkoxy, C₁-C₆-alkylthio, C₁-C₆-alkoxy-C₁-C₆-alkyl, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, cyano-C₁-C₆-alkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylthio, C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl or C₃-C₆-cycloalkyl), the heteroarylalkyl radicals triazolyl-C₁-C₆-alkyl, pyridyl-C₁-C₆-alkyl, pyrimidyl-C₁-C₆-alkyl or oxadiazolyl-C₁-C₆-alkyl (which for their part may be substituted by C₁-C₆-alkyl) or
represents cyano-, nitro-, C₁-C₆-haloalkoxy-, dioxolanyl-, piperidinonyl-, pyrrolidinonyl- or dihydrodioxazinyl-substituted phenyl
or
(Id)
G¹ represents N, CH or C-halogen,
G² represents

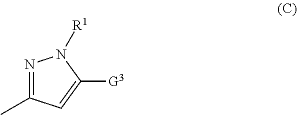

wherein
R¹ represents hydrogen or C₁-C₆-alkyl and
G³ represents in each case optionally halogen-, cyano-, nitro-, C₁-C₆-alkyl-, C₁-C₆-haloalkyl-, C₃-C₆-cycloalkyl-, C₁-C₆-alkoxy-, C₁-C₆-haloalkoxy-, C₁-C₆-alkylthio-, C₁-C₆-haloalkylthio-, C₁-C₆-alkylsulphinyl-, C₁-C₆-alkylsulphonyl-, C₁-C₆-haloalkylsulphinyl-, C₁-C₆-haloalkylsulphonyl-, amino-, C₁-C₆-alkylamino-, di(C₁-C₆-alkyl)amino-, C₁-C₆-alkylcarbonylamino-, C₁-C₆-alkoxycarbonylamino-, C₁-C₆-alkoxy-C₁-C₆-alkyl-, C₁-C₆-haloalkoxy-C₁-C₆-alkyl-, C₂-C₆-alkenyl-, C₂-C₆-alkynyl-, C₁-C₆-alkyl-C₃-C₆-cycloalkyl-, C₁-C₆-alkylcarbonyl-, C₁-C₆-alkoxycarbonyl-, aminocarbonyl-, pyridyl- or pyrimidyl-substituted oxazolinyl, dihydrooxadiazinyl, dihydrodioxazinyl or hydroxypyridyl,
represents pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl (in particular pyridyl, pyrimidyl, imidazolyl, pyrazolyl, triazinyl, thiazolyl, thiadiazolyl, oxadiazolyl or oxazolyl), each of which is optionally substituted by halogen, nitro, amino, C₁-C₆-alkylamino, di(C₁-C₆-alkyl)amino, C₁-C₆-alkyl, C₁-C₆-haloalkyl, C₃-C₆-cycloalkyl-C₁-C₆-alkyl, C₁-C₆-alkoxy, C₁-C₆-haloalkoxy, C₁-C₆-alkylthio, C₁-C₆-alkoxy-C₁-C₆-alkyl, bis(C₁-C₆-alkoxy)-C₁-C₆-alkyl, C₁-C₆-alkoxycarbonyl, alpha-hydroxyimino-C₁-C₆-alkoxycarbonylmethyl, alpha-C₁-C₆-alkoxyimino-C₁-C₆-alkoxycarbonylmethyl, C(X)NR²R³, (in which X represents oxygen or sulphur, R² represents hydrogen or C₁-C₆-alkyl and R³ represents C₁-C₆-alkyl, C₁-C₆-haloalkyl, C₁-C₆-alkoxy, cyano-C₁-C₆-alkyl, C₂-C₆-alkynyl, C₃-C₆-cycloalkyl, C₃-C₆-cycloalkyl-C₁-C₆-alkyl, C₁-C₆-alkoxy-C₁-C₆-alkyl, C₁-C₆-alkylthio-C₁-C₆-alkyl or phenyl-C₁-C₆-alkyl), C₁-C₆-alkylsulphinyl, C₁-C₆-alkylsulphonyl, the heterocyclyl radicals morpholinyl, triazolinonyl, dihydrodioxazinyl, dihydrooxadiazinyl, dioxolanyl, dioxanyl, piperidinonyl, pyrrolidinonyl and pyrazolinonyl (which for their part may be substituted by C₁-C₆-alkyl or C₁-C₆-haloalkyl), phenyl (which for its part may be substituted by halogen, cyano, nitro, C₁-C₆-alkyl or C₁-C₆-haloalkyl), the heteroaryl radicals pyrrolyl, pyridyl, pyridyl N-oxide, pyrimidyl, imidazolyl, pyrazolyl, oxazolyl, thiazolyl, furanyl, thienyl, triazolyl, oxadiazolyl, thiadiazolyl, pyrazinyl, triazinyl, tetrazinyl and isoquinolinyl (which for their part may be substituted by halogen, nitro, C₁-C₆-alkyl, C₁-C₆-haloalkyl, C₁-C₆-alkoxy, C₁-C₆-haloalkoxy, C₁-C₆-alkoxy-C₁-C₆-alkyl, C₁-C₆-alkylthio, C₁-C₆-alkylthio-C₁-C₆-alkyl or C₃-C₆-cycloalkyl), the heteroarylalkyl radicals triazolyl-C₁-C₆-alkyl, pyridyl-C₁-C₆-alkyl, pyrimidyl-C₁-C₆-alkyl or oxadiazolyl-C₁-C₆-alkyl (which for their part may be substituted by C₁-C₆-alkyl) or
represents optionally halogen-, cyano-, C₁-C₆-alkyl-, C₁-C₆-haloalkyl-, C₁-C₆-alkoxy-, C₁-C₆-haloalkoxy-, dioxolanyl-, piperidinonyl-, pyrrolidinonyl- or dihydrodioxazinyl-substituted phenyl
and also salts and N-oxides of the compounds of the formula (I).

Preference according to the invention is given to using compounds of the formula (I) which contain a combination of the meanings listed above as being preferred.

Preferred subgroups of the compounds of the formula (I) in the active compound combinations according to the invention are listed below:

A group of compounds emphasized for the use according to the invention are the compounds defined under (Ia).

A further group of compounds emphasized for the use according to the invention are the compounds defined under (Ib).

A further group of compounds emphasized for the use according to the invention are the compounds defined under (Ic).

A further group of compounds emphasized for the use according to the invention are the compounds defined under (Id).

In a further emphasized group of compounds (Ia) to be used according to the invention, G¹ represents CH.

In a further emphasized group of compounds (Ia) to be used according to the invention, G¹ represents N.

In a further emphasized group of compounds (Ia) to be used according to the invention, G¹ represents C-halogen.

In a further emphasized group of compounds (Ib) to be used according to the invention, G¹ represents N.

In a further emphasized group of compounds (Ib) to be used according to the invention, G¹ represents C-halogen.

In a further emphasized group of compounds (Id) to be used according to the invention, G¹ represents CH.

In a further emphasized group of compounds (Id) to be used according to the invention, G¹ represents N.

In a further emphasized group of compounds (Id) to be used according to the invention, G¹ represents C-halogen.

In a further emphasized group of compounds (Ia) to be used according to the invention, G¹ represents CH and R¹ represents hydrogen.

In a further emphasized group of compounds (Ia) to be used according to the invention, G¹ represents N and R¹ represents hydrogen.

In a further emphasized group of compounds (Ia) to be used according to the invention, G¹ represents C-halogen and R¹ represents hydrogen.

In a further emphasized group of compounds (Ia) to be used according to the invention, G¹ represents CH and R¹ represents methyl.

In a further emphasized group of compounds (Ia) to be used according to the invention, G¹ represents N and R¹ represents methyl.

In a further emphasized group of compounds (Ia) to be used according to the invention, G¹ represents C-halogen and R¹ represents methyl.

In a further emphasized group of compounds (Id) to be used according to the invention, G¹ represents CH and R¹ represents hydrogen.

In a further emphasized group of compounds (Id) to be used according to the invention, G¹ represents N and R¹ represents hydrogen.

In a further emphasized group of compounds (Id) to be used according to the invention, G¹ represents C-halogen and R¹ represents hydrogen.

In a further emphasized group of compounds (Id) to be used according to the invention, G¹ represents CH and R¹ represents methyl.

In a further emphasized group of compounds (Id) to be used according to the invention, G¹ represents N and R¹ represents methyl.

In a further emphasized group of compounds (Id) to be used according to the invention, G¹ represents C-halogen and R¹ represents methyl.

The compounds of the general formula (I) may, where appropriate, depending on the nature of the substituents, be in the form of geometric and/or optically active isomers or corresponding isomer mixtures of varying composition. The invention relates both to the pure isomers and to the isomer mixtures.

Specific mention may be made of the following compounds of the formula (I) known from WO 2010/006713:

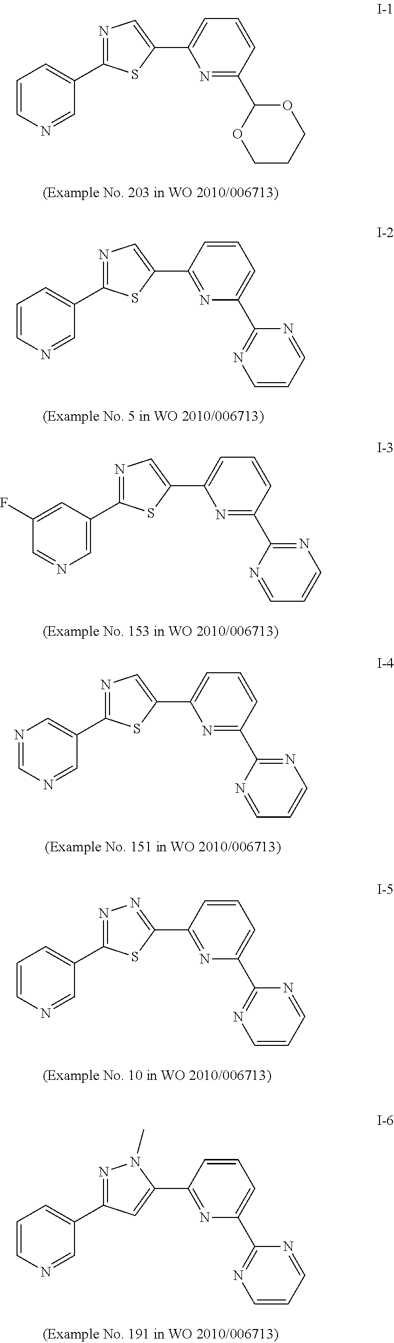

The active compound combinations according to the invention preferably comprise the following compounds of the formula (I):

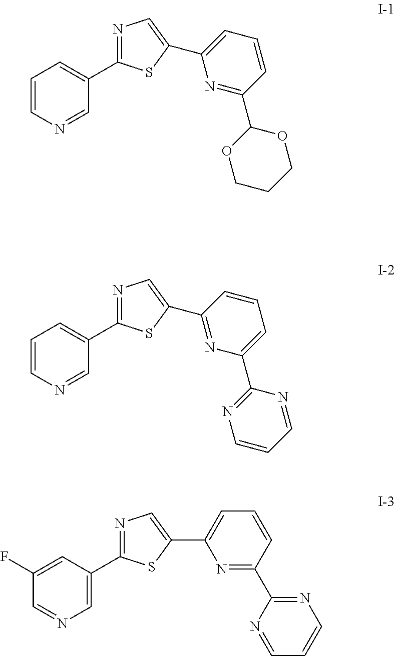

Surprisingly, the insecticidal and/or acaricidal action of the active compound combinations according to the invention considerably exceeds the total of the actions of the individual active compounds. A true synergistic effect which could not have been predicted exists, not just a complementation of action.

Preference is given to active compound combinations comprising at least one, in particular exactly one, compound of the formulae (I-1) to (I-6) and at least one, in particular exactly one, active compound of the formula (II).

Particular preference is given to active compound combinations comprising at least one, in particular exactly one, compound of the formulae (I-1) to (I-3) and at least one, in particular exactly one, active compound of the formula (II).

The following combinations are of particular interest:

| | | |
|---|---|---|
| I-1 + II-1A-1 | I-1 + II-1B-4 | I-1 + II-1B-42 |
| I-1 + II-1A-2 | I-1 + II-1B-5 | I-1 + II-1B-43 |
| I-1 + II-1A-3 | I-1 + II-1B-6 | I-1 + II-1B-44 |
| I-1 + II-1A-4 | I-1 + II-1B-7 | I-1 + II-1B-45 |
| I-1 + II-1A-5 | I-1 + II-1B-8 | I-1 + II-1B-46 |
| I-1 + II-1A-6 | I-1 + II-1B-9 | I-1 + II-1B-47 |
| I-1 + II-1A-7 | I-1 + II-1B-10 | I-1 + II-1B-48 |
| I-1 + II-1A-8 | I-1 + II-1B-11 | I-1 + II-1B-49 |
| I-1 + II-1A-9 | I-1 + II-1B-12 | I-1 + II-1B-50 |
| I-1 + II-1A-10 | I-1 + II-1B-13 | I-1 + II-1B-51 |
| I-1 + II-1A-11 | I-1 + II-1B-14 | I-1 + II-1B-52 |
| I-1 + II-1A-12 | I-1 + II-1B-15 | I-1 + II-1B-53 |
| I-1 + II-1A-13 | I-1 + II-1B-16 | I-1 + II-1B-54 |
| I-1 + II-1A-14 | I-1 + II-1B-17 | I-1 + II-1B-55 |
| I-1 + II-1A-15 | I-1 + II-1B-18 | I-1 + II-1B-56 |
| I-1 + II-1A-16 | I-1 + II-1B-19 | I-1 + II-1B-57 |
| I-1 + II-1A-17 | I-1 + II-1B-20 | I-1 + II-1B-58 |
| I-1 + II-1A-18 | I-1 + II-1B-21 | I-1 + II-1B-59 |
| I-1 + II-1A-19 | I-1 + II-1B-22 | I-1 + II-1B-60 |
| I-1 + II-1A-20 | I-1 + II-1B-23 | I-1 + II-1B-61 |
| I-1 + II-1A-21 | I-1 + II-1B-24 | I-1 + II-1B-62 |
| I-1 + II-1A-22 | I-1 + II-1B-25 | I-1 + II-1B-63 |
| I-1 + II-1A-23 | I-1 + II-1B-26 | I-1 + II-1B-64 |
| I-1 + II-1A-24 | I-1 + II-1B-27 | I-1 + II-1B-65 |
| I-1 + II-1A-25 | I-1 + II-1B-28 | I-1 + II-1B-66 |
| I-1 + II-1A-26 | I-1 + II-1B-29 | I-1 + II-1B-67 |
| I-1 + II-1A-27 | I-1 + II-1B-30 | I-1 + II-1B-68 |
| I-1 + II-1A-28 | I-1 + II-1B-31 | I-1 + II-1B-69 |
| I-1 + II-1A-29 | I-1 + II-1B-32 | I-1 + II-1B-70 |
| I-1 + II-1A-30 | I-1 + II-1B-33 | I-1 + II-1B-71 |
| I-1 + II-1A-31 | I-1 + II-1B-34 | I-1 + II-1B-72 |
| I-1 + II-1A-32 | I-1 + II-1B-35 | I-1 + II-1B-73 |
| I-1 + II-1A-33 | I-1 + II-1B-36 | I-1 + II-1B-74 |
| I-1 + II-1A-34 | I-1 + II-1B-37 | I-1 + II-1B-75 |
| I-1 + II-1A-35 | I-1 + II-1B-38 | I-1 + II-1B-76 |
| I-1 + II-1B-1 | I-1 + II-1B-39 | I-1 + II-1B-77 |
| I-1 + II-1B-2 | I-1 + II-1B-40 | I-1 + II-1B-78 |
| I-1 + II-1B-3 | I-1 + II-1B-41 | I-1 + II-1B-79 |
| I-1 + II-1B-80 | I-1 + II-3-27 | I-1 + II-6-2 |
| I-1 + II-1B-81 | I-1 + II-3-28 | I-1 + II-6-3 |
| I-1 + II-1B-82 | I-1 + II-3-29 | I-1 + II-6-4 |
| I-1 + II-1B-83 | I-1 + II-3-30 | I-1 + II-6-5 |
| I-1 + II-1B-84 | I-1 + II-3-31 | I-1 + II-6-6 |
| I-1 + II-1B-85 | I-1 + II-3-32 | I-1 + II-7A-1 |
| I-1 + II-1B-86 | I-1 + II-3-33 | I-1 + II-7A-2 |
| I-1 + II-1B-87 | I-1 + II-3-34 | I-1 + II-7A-3 |
| I-1 + II-1B-88 | I-1 + II-3-35 | I-1 + II-7A-4 |
| I-1 + II-2A-1 | I-1 + II-3-36 | I-1 + II-7A-5 |
| I-1 + II-2A-2 | I-1 + II-3-37 | I-1 + II-7B-1 |
| I-1 + II-2A-3 | I-1 + II-3-38 | I-1 + II-7C-1 |
| I-1 + II-2A-4 | I-1 + II-3-39 | I-1 + II-7C-2 |
| I-1 + II-2A-5 | I-1 + II-3-40 | I-1 + II-8A-1 |
| I-1 + II-2A-6 | I-1 + II-3-41 | I-1 + II-8B-1 |
| I-1 + II-2A-7 | I-1 + II-3-42 | I-1 + II-8C-1 |
| I-1 + II-2A-8 | I-1 + II-3-43 | I-1 + II-9A-1 |
| I-1 + II-2B-1 | I-1 + II-3-44 | I-1 + II-9B-1 |
| I-1 + II-2B-2 | I-1 + II-3-45 | I-1 + II-9B-2 |
| I-1 + II-2B-3 | I-1 + II-3-46 | I-1 + II-9C-1 |
| I-1 + II-2B-4 | I-1 + II-3-47 | I-1 + II-10A-1 |
| I-1 + II-2B-5 | I-1 + II-3-48 | I-1 + II-10A-2 |
| I-1 + II-2B-6 | I-1 + II-3-49 | I-1 + II-10B-1 |
| I-1 + II-3-1 | I-1 + II-3-50 | I-1 + II-12A-1 |
| I-1 + II-3-2 | I-1 + II-3-51 | I-1 + II-12B-1 |
| I-1 + II-3-3 | I-1 + II-3-52 | I-1 + II-12B-2 |
| I-1 + II-3-4 | I-1 + II-3-53 | I-1 + II-12B-3 |
| I-1 + II-3-5 | I-1 + II-3-54 | I-1 + II-12C-1 |
| I-1 + II-3-6 | I-1 + II-3-55 | I-1 + II-12C-2 |
| I-1 + II-3-7 | I-1 + II-3-56 | I-1 + II-13-1 |
| I-1 + II-3-8 | I-1 + II-3-57 | I-1 + II-13-2 |
| I-1 + II-3-9 | I-1 + II-3-58 | I-1 + II-13-3 |
| I-1 + II-3-10 | I-1 + II-4A-1 | I-1 + II-13-4 |
| I-1 + II-3-11 | I-1 + II-4A-2 | I-1 + II-13-5 |
| I-1 + II-3-12 | I-1 + II-4A-3 | I-1 + II-13-6 |
| I-1 + II-3-13 | I-1 + II-4A-4 | I-1 + II-15-1 |
| I-1 + II-3-14 | I-1 + II-4A-5 | I-1 + II-15-2 |
| I-1 + II-3-15 | I-1 + II-4A-6 | I-1 + II-15-3 |
| I-1 + II-3-16 | I-1 + II-4A-7 | I-1 + II-15-4 |
| I-1 + II-3-17 | I-1 + II-4A-8 | I-1 + II-15-5 |
| I-1 + II-3-18 | I-1 + II-4A-9 | I-1 + II-15-6 |
| I-1 + II-3-19 | I-1 + II-4B-1 | I-1 + II-15-7 |
| I-1 + II-3-20 | I-1 + II-4B-2 | I-1 + II-15-8 |
| I-1 + II-3-21 | I-1 + II-4B-3 | I-1 + II-15-9 |
| I-1 + II-3-22 | I-1 + II-4B-4 | I-1 + II-15-10 |
| I-1 + II-3-23 | I-1 + II-4C-4 | I-1 + II-15-11 |
| I-1 + II-3-24 | I-1 + II-5-1 | I-1 + II-15-12 |
| I-1 + II-3-25 | I-1 + II-5-2 | I-1 + II-15-13 |
| I-1 + II-3-26 | I-1 + II-6-1 | I-1 + II-16-1 |
| I-1 + II-17-1 | I-1 + II-29-20 | I-2 + II-1B-2 |
| I-1 + II-18A-1 | I-1 + II-29-21 | I-2 + II-1B-3 |
| I-1 + II-18A-2 | I-1 + II-29-22 | I-2 + II-1B-4 |
| I-1 + II-18A-3 | I-1 + II-29-23 | I-2 + II-1B-5 |
| I-1 + II-18A-4 | I-1 + II-29-24 | I-2 + II-1B-6 |
| I-1 + II-18A-5 | I-1 + II-29-25 | I-2 + II-1B-7 |
| I-1 + II-18B-1 | I-1 + II-29-26 | I-2 + II-1B-8 |
| I-1 + II-19-1 | I-1 + II-29-27 | I-2 + II-1B-9 |
| I-1 + II-20A-1 | I-1 + II-29-28 | I-2 + II-1B-10 |
| I-1 + II-20B-1 | I-1 + II-29-29 | I-2 + II-1B-11 |
| I-1 + II-20C-1 | I-1 + II-29-30 | I-2 + II-1B-12 |
| I-1 + II-20D-1 | I-1 + II-29-31 | I-2 + II-1B-13 |
| I-1 + II-20D-2 | I-1 + II-29-32 | I-2 + II-1B-14 |
| I-1 + II-21-1 | I-2 + II-1A-1 | I-2 + II-1B-15 |
| I-1 + II-21-2 | I-2 + II-1A-2 | I-2 + II-1B-16 |
| I-1 + II-21-3 | I-2 + II-1A-3 | I-2 + II-1B-17 |
| I-1 + II-21-4 | I-2 + II-1A-4 | I-2 + II-1B-18 |
| I-1 + II-21-5 | I-2 + II-1A-5 | I-2 + II-1B-19 |
| I-1 + II-21-6 | I-2 + II-1A-6 | I-2 + II-1B-20 |
| I-1 + II-21-7 | I-2 + II-1A-7 | I-2 + II-1B-21 |
| I-1 + II-22A-1 | I-2 + II-1A-8 | I-2 + II-1B-22 |
| I-1 + II-22B-1 | I-2 + II-1A-9 | I-2 + II-1B-23 |
| I-1 + II-23A-1 | I-2 + II-1A-10 | I-2 + II-1B-24 |
| I-1 + II-23A-2 | I-2 + II-1A-11 | I-2 + II-1B-25 |
| I-1 + II-23B-1 | I-2 + II-1A-12 | I-2 + II-1B-26 |
| I-1 + II-25-1 | I-2 + II-1A-13 | I-2 + II-1B-27 |
| I-1 + II-28-1 | I-2 + II-1A-14 | I-2 + II-1B-28 |
| I-1 + II-28-2 | I-2 + II-1A-15 | I-2 + II-1B-29 |
| I-1 + II-28-3 | I-2 + II-1A-16 | I-2 + II-1B-30 |
| I-1 + II-28-4 | I-2 + II-1A-17 | I-2 + II-1B-31 |
| I-1 + II-29-1 | I-2 + II-1A-18 | I-2 + II-1B-32 |
| I-1 + II-29-2 | I-2 + II-1A-19 | I-2 + II-1B-33 |
| I-1 + II-29-3 | I-2 + II-1A-20 | I-2 + II-1B-34 |
| I-1 + II-29-4 | I-2 + II-1A-21 | I-2 + II-1B-35 |
| I-1 + II-29-5 | I-2 + II-1A-22 | I-2 + II-1B-36 |
| I-1 + II-29-6 | I-2 + II-1A-23 | I-2 + II-1B-37 |
| I-1 + II-29-7 | I-2 + II-1A-24 | I-2 + II-1B-38 |
| I-1 + II-29-8 | I-2 + II-1A-25 | I-2 + II-1B-39 |
| I-1 + II-29-9 | I-2 + II-1A-26 | I-2 + II-1B-40 |
| I-1 + II-29-10 | I-2 + II-1A-27 | I-2 + II-1B-41 |
| I-1 + II-29-11 | I-2 + II-1A-28 | I-2 + II-1B-42 |
| I-1 + II-29-12 | I-2 + II-1A-29 | I-2 + II-1B-43 |
| I-1 + II-29-13 | I-2 + II-1A-30 | I-2 + II-1B-44 |
| I-1 + II-29-14 | I-2 + II-1A-31 | I-2 + II-1B-45 |
| I-1 + II-29-15 | I-2 + II-1A-32 | I-2 + II-1B-46 |
| I-1 + II-29-16 | I-2 + II-1A-33 | I-2 + II-1B-47 |
| I-1 + II-29-17 | I-2 + II-1A-34 | I-2 + II-1B-48 |
| I-1 + II-29-18 | I-2 + II-1A-35 | I-2 + II-1B-49 |
| I-1 + II-29-19 | I-2 + II-1B-1 | I-2 + II-1B-50 |
| I-2 + II-1B-51 | I-2 + II-2B-4 | I-2 + II-3-47 |
| I-2 + II-1B-52 | I-2 + II-2B-5 | I-2 + II-3-48 |
| I-2 + II-1B-53 | I-2 + II-2B-6 | I-2 + II-3-49 |
| I-2 + II-1B-54 | I-2 + II-3-1 | I-2 + II-3-50 |
| I-2 + II-1B-55 | I-2 + II-3-2 | I-2 + II-3-51 |
| I-2 + II-1B-56 | I-2 + II-3-3 | I-2 + II-3-52 |
| I-2 + II-1B-57 | I-2 + II-3-4 | I-2 + II-3-53 |
| I-2 + II-1B-58 | I-2 + II-3-5 | I-2 + II-3-54 |
| I-2 + II-1B-59 | I-2 + II-3-6 | I-2 + II-3-55 |
| I-2 + II-1B-60 | I-2 + II-3-7 | I-2 + II-3-56 |
| I-2 + II-1B-61 | I-2 + II-3-8 | I-2 + II-3-57 |
| I-2 + II-1B-62 | I-2 + II-3-9 | I-2 + II-3-58 |
| I-2 + II-1B-63 | I-2 + II-3-10 | I-2 + II-4A-1 |
| I-2 + II-1B-64 | I-2 + II-3-11 | I-2 + II-4A-2 |
| I-2 + II-1B-65 | I-2 + II-3-12 | I-2 + II-4A-3 |
| I-2 + II-1B-66 | I-2 + II-3-13 | I-2 + II-4A-4 |
| I-2 + II-1B-67 | I-2 + II-3-14 | I-2 + II-4A-5 |
| I-2 + II-1B-68 | I-2 + II-3-15 | I-2 + II-4A-6 |
| I-2 + II-1B-69 | I-2 + II-3-16 | I-2 + II-4A-7 |
| I-2 + II-1B-70 | I-2 + II-3-17 | I-2 + II-4A-8 |
| I-2 + II-1B-71 | I-2 + II-3-18 | I-2 + II-4A-9 |
| I-2 + II-1B-72 | I-2 + II-3-19 | I-2 + II-4B-1 |
| I-2 + II-1B-73 | I-2 + II-3-20 | I-2 + II-4B-2 |
| I-2 + II-1B-74 | I-2 + II-3-21 | I-2 + II-4B-3 |
| I-2 + II-1B-75 | I-2 + II-3-22 | I-2 + II-4B-4 |
| I-2 + II-1B-76 | I-2 + II-3-23 | I-2 + II-4C-4 |
| I-2 + II-1B-77 | I-2 + II-3-24 | I-2 + II-5-1 |
| I-2 + II-1B-78 | I-2 + II-3-25 | I-2 + II-5-2 |
| I-2 + II-1B-79 | I-2 + II-3-26 | I-2 + II-6-1 |
| I-2 + II-1B-80 | I-2 + II-3-27 | I-2 + II-6-2 |
| I-2 + II-1B-81 | I-2 + II-3-28 | I-2 + II-6-3 |
| I-2 + II-1B-82 | I-2 + II-3-29 | I-2 + II-6-4 |
| I-2 + II-1B-83 | I-2 + II-3-30 | I-2 + II-6-5 |
| I-2 + II-1B-84 | I-2 + II-3-31 | I-2 + II-6-6 |
| I-2 + II-1B-85 | I-2 + II-3-32 | I-2 + II-7A-1 |
| I-2 + II-1B-86 | I-2 + II-3-33 | I-2 + II-7A-2 |
| I-2 + II-1B-87 | I-2 + II-3-34 | I-2 + II-7A-3 |
| I-2 + II-1B-88 | I-2 + II-3-35 | I-2 + II-7A-4 |
| I-2 + II-2A-1 | I-2 + II-3-36 | I-2 + II-7A-5 |
| I-2 + II-2A-2 | I-2 + II-3-37 | I-2 + II-7B-1 |
| I-2 + II-2A-3 | I-2 + II-3-38 | I-2 + II-7C-1 |
| I-2 + II-2A-4 | I-2 + II-3-39 | I-2 + II-7C-2 |
| I-2 + II-2A-5 | I-2 + II-3-40 | I-2 + II-8A-1 |
| I-2 + II-2A-6 | I-2 + II-3-41 | I-2 + II-8B-1 |
| I-2 + II-2A-7 | I-2 + II-3-42 | I-2 + II-8C-1 |
| I-2 + II-2A-8 | I-2 + II-3-43 | I-2 + II-9A-1 |
| I-2 + II-2B-1 | I-2 + II-3-44 | I-2 + II-9B-1 |
| I-2 + II-2B-2 | I-2 + II-3-45 | I-2 + II-9B-2 |
| I-2 + II-2B-3 | I-2 + II-3-46 | I-2 + II-9C-1 |
| I-2 + II-10A-1 | I-2 + II-22A-1 | I-3 + II-1A-8 |
| I-2 + II-10A-2 | I-2 + II-22B-1 | I-3 + II-1A-9 |
| I-2 + II-10B-1 | I-2 + II-23A-1 | I-3 + II-1A-10 |
| I-2 + II-12A-1 | I-2 + II-23A-2 | I-3 + II-1A-11 |
| I-2 + II-12B-1 | I-2 + II-23B-1 | I-3 + II-1A-12 |
| I-2 + II-12B-2 | I-2 + II-25-1 | I-3 + II-1A-13 |
| I-2 + II-12B-3 | I-2 + II-28-1 | I-3 + II-1A-14 |
| I-2 + II-12C-1 | I-2 + II-28-2 | I-3 + II-1A-15 |
| I-2 + II-12C-2 | I-2 + II-28-3 | I-3 + II-1A-16 |
| I-2 + II-13-1 | I-2 + II-28-4 | I-3 + II-1A-17 |
| I-2 + II-13-2 | I-2 + II-29-1 | I-3 + II-1A-18 |
| I-2 + II-13-3 | I-2 + II-29-2 | I-3 + II-1A-19 |
| I-2 + II-13-4 | I-2 + II-29-3 | I-3 + II-1A-20 |
| I-2 + II-13-5 | I-2 + II-29-4 | I-3 + II-1A-21 |
| I-2 + II-13-6 | I-2 + II-29-5 | I-3 + II-1A-22 |
| I-2 + II-15-1 | I-2 + II-29-6 | I-3 + II-1A-23 |
| I-2 + II-15-2 | I-2 + II-29-7 | I-3 + II-1A-24 |
| I-2 + II-15-3 | I-2 + II-29-8 | I-3 + II-1A-25 |
| I-2 + II-15-4 | I-2 + II-29-9 | I-3 + II-1A-26 |
| I-2 + II-15-5 | I-2 + II-29-10 | I-3 + II-1A-27 |
| I-2 + II-15-6 | I-2 + II-29-11 | I-3 + II-1A-28 |
| I-2 + II-15-7 | I-2 + II-29-12 | I-3 + II-1A-29 |
| I-2 + II-15-8 | I-2 + II-29-13 | I-3 + II-1A-30 |
| I-2 + II-15-9 | I-2 + II-29-14 | I-3 + II-1A-31 |
| I-2 + II-15-10 | I-2 + II-29-15 | I-3 + II-1A-32 |
| I-2 + II-15-11 | I-2 + II-29-16 | I-3 + II-1A-33 |
| I-2 + II-15-12 | I-2 + II-29-17 | I-3 + II-1A-34 |
| I-2 + II-15-13 | I-2 + II-29-18 | I-3 + II-1A-35 |
| I-2 + II-16-1 | I-2 + II-29-19 | I-3 + II-1B-1 |
| I-2 + II-17-1 | I-2 + II-29-20 | I-3 + II-1B-2 |
| I-2 + II-18A-1 | I-2 + II-29-21 | I-3 + II-1B-3 |
| I-2 + II-18A-2 | I-2 + II-29-22 | I-3 + II-1B-4 |
| I-2 + II-18A-3 | I-2 + II-29-23 | I-3 + II-1B-5 |
| I-2 + II-18A-4 | I-2 + II-29-24 | I-3 + II-1B-6 |
| I-2 + II-18A-5 | I-2 + II-29-25 | I-3 + II-1B-7 |
| I-2 + II-18B-1 | I-2 + II-29-26 | I-3 + II-1B-8 |
| I-2 + II-19-1 | I-2 + II-29-27 | I-3 + II-1B-9 |
| I-2 + II-20A-1 | I-2 + II-29-28 | I-3 + II-1B-10 |
| I-2 + II-20B-1 | I-2 + II-29-29 | I-3 + II-1B-11 |
| I-2 + II-20C-1 | I-2 + II-29-30 | I-3 + II-1B-12 |
| I-2 + II-20D-1 | I-2 + II-29-31 | I-3 + II-1B-13 |
| I-2 + II-20D-2 | I-2 + II-29-32 | I-3 + II-1B-14 |
| I-2 + II-21-1 | I-3 + II-1A-1 | I-3 + II-1B-15 |
| I-2 + II-21-2 | I-3 + II-1A-2 | I-3 + II-1B-16 |
| I-2 + II-21-3 | I-3 + II-1A-3 | I-3 + II-1B-17 |
| I-2 + II-21-4 | I-3 + II-1A-4 | I-3 + II-1B-18 |
| I-2 + II-21-5 | I-3 + II-1A-5 | I-3 + II-1B-19 |
| I-2 + II-21-6 | I-3 + II-1A-6 | I-3 + II-1B-20 |
| I-2 + II-21-7 | I-3 + II-1A-7 | I-3 + II-1B-21 |
| I-3 + II-1B-22 | I-3 + II-1B-71 | I-3 + II-3-18 |
| I-3 + II-1B-23 | I-3 + II-1B-72 | I-3 + II-3-19 |
| I-3 + II-1B-24 | I-3 + II-1B-73 | I-3 + II-3-20 |
| I-3 + II-1B-25 | I-3 + II-1B-74 | I-3 + II-3-21 |
| I-3 + II-1B-26 | I-3 + II-1B-75 | I-3 + II-3-22 |
| I-3 + II-1B-27 | I-3 + II-1B-76 | I-3 + II-3-23 |
| I-3 + II-1B-28 | I-3 + II-1B-77 | I-3 + II-3-24 |
| I-3 + II-1B-29 | I-3 + II-1B-78 | I-3 + II-3-25 |
| I-3 + II-1B-30 | I-3 + II-1B-79 | I-3 + II-3-26 |
| I-3 + II-1B-31 | I-3 + II-1B-80 | I-3 + II-3-27 |
| I-3 + II-1B-32 | I-3 + II-1B-81 | I-3 + II-3-28 |
| I-3 + II-1B-33 | I-3 + II-1B-82 | I-3 + II-3-29 |
| I-3 + II-1B-34 | I-3 + II-1B-83 | I-3 + II-3-30 |
| I-3 + II-1B-35 | I-3 + II-1B-84 | I-3 + II-3-31 |
| I-3 + II-1B-36 | I-3 + II-1B-85 | I-3 + II-3-32 |
| I-3 + II-1B-37 | I-3 + II-1B-86 | I-3 + II-3-33 |
| I-3 + II-1B-38 | I-3 + II-1B-87 | I-3 + II-3-34 |
| I-3 + II-1B-39 | I-3 + II-1B-88 | I-3 + II-3-35 |
| I-3 + II-1B-40 | I-3 + II-2A-1 | I-3 + II-3-36 |
| I-3 + II-1B-41 | I-3 + II-2A-2 | I-3 + II-3-37 |
| I-3 + II-1B-42 | I-3 + II-2A-3 | I-3 + II-3-38 |
| I-3 + II-1B-43 | I-3 + II-2A-4 | I-3 + II-3-39 |
| I-3 + II-1B-44 | I-3 + II-2A-5 | I-3 + II-3-40 |
| I-3 + II-1B-45 | I-3 + II-2A-6 | I-3 + II-3-41 |
| I-3 + II-1B-46 | I-3 + II-2A-7 | I-3 + II-3-42 |
| I-3 + II-1B-47 | I-3 + II-2A-8 | I-3 + II-3-43 |
| I-3 + II-1B-48 | I-3 + II-2B-1 | I-3 + II-3-44 |
| I-3 + II-1B-49 | I-3 + II-2B-2 | I-3 + II-3-45 |
| I-3 + II-1B-50 | I-3 + II-2B-3 | I-3 + II-3-46 |
| I-3 + II-1B-51 | I-3 + II-2B-4 | I-3 + II-3-47 |
| I-3 + II-1B-52 | I-3 + II-2B-5 | I-3 + II-3-48 |
| I-3 + II-1B-53 | I-3 + II-2B-6 | I-3 + II-3-49 |
| I-3 + II-1B-54 | I-3 + II-3-1 | I-3 + II-3-50 |
| I-3 + II-1B-55 | I-3 + II-3-2 | I-3 + II-3-51 |
| I-3 + II-1B-56 | I-3 + II-3-3 | I-3 + II-3-52 |
| I-3 + II-1B-57 | I-3 + II-3-4 | I-3 + II-3-53 |
| I-3 + II-1B-58 | I-3 + II-3-5 | I-3 + II-3-54 |
| I-3 + II-1B-59 | I-3 + II-3-6 | I-3 + II-3-55 |
| I-3 + II-1B-60 | I-3 + II-3-7 | I-3 + II-3-56 |
| I-3 + II-1B-61 | I-3 + II-3-8 | I-3 + II-3-57 |
| I-3 + II-1B-62 | I-3 + II-3-9 | I-3 + II-3-58 |
| I-3 + II-1B-63 | I-3 + II-3-10 | I-3 + II-4A-1 |
| I-3 + II-1B-64 | I-3 + II-3-11 | I-3 + II-4A-2 |
| I-3 + II-1B-65 | I-3 + II-3-12 | I-3 + II-4A-3 |
| I-3 + II-1B-66 | I-3 + II-3-13 | I-3 + II-4A-4 |
| I-3 + II-1B-67 | I-3 + II-3-14 | I-3 + II-4A-5 |
| I-3 + II-1B-68 | I-3 + II-3-15 | I-3 + II-4A-6 |
| I-3 + II-1B-69 | I-3 + II-3-16 | I-3 + II-4A-7 |
| I-3 + II-1B-70 | I-3 + II-3-17 | I-3 + II-4A-8 |
| I-3 + II-4A-9 | I-3 + II-15-6 | I-3 + II-29-11 |
| I-3 + II-4B-1 | I-3 + II-15-7 | I-3 + II-29-12 |
| I-3 + II-4B-2 | I-3 + II-15-8 | I-3 + II-29-13 |
| I-3 + II-4B-3 | I-3 + II-15-9 | I-3 + II-29-14 |
| I-3 + II-4B-4 | I-3 + II-15-10 | I-3 + II-29-15 |
| I-3 + II-4C-4 | I-3 + II-15-11 | I-3 + II-29-16 |
| I-3 + II-5-1 | I-3 + II-15-12 | I-3 + II-29-17 |
| I-3 + II-5-2 | I-3 + II-15-13 | I-3 + II-29-18 |
| I-3 + II-6-1 | I-3 + II-16-1 | I-3 + II-29-19 |
| I-3 + II-6-2 | I-3 + II-17-1 | I-3 + II-29-20 |
| I-3 + II-6-3 | I-3 + II-18A-1 | I-3 + II-29-21 |
| I-3 + II-6-4 | I-3 + II-18A-2 | I-3 + II-29-22 |
| I-3 + II-6-5 | I-3 + II-18A-3 | I-3 + II-29-23 |
| I-3 + II-6-6 | I-3 + II-18A-4 | I-3 + II-29-24 |
| I-3 + II-7A-1 | I-3 + II-18A-5 | I-3 + II-29-25 |
| I-3 + II-7A-2 | I-3 + II-18B-1 | I-3 + II-29-26 |
| I-3 + II-7A-3 | I-3 + II-19-1 | I-3 + II-29-27 |
| I-3 + II-7A-4 | I-3 + II-20A-1 | I-3 + II-29-28 |
| I-3 + II-7A-5 | I-3 + II-20B-1 | I-3 + II-29-29 |
| I-3 + II-7B-1 | I-3 + II-20C-1 | I-3 + II-29-30 |
| I-3 + II-7C-1 | I-3 + II-20D-1 | I-3 + II-29-31 |
| I-3 + II-7C-2 | I-3 + II-20D-2 | I-3 + II-29-32 |
| I-3 + II-8A-1 | I-3 + II-21-1 | I-4 + II-1A-1 |
| I-3 + II-8B-1 | I-3 + II-21-2 | I-4 + II-1A-2 |
| I-3 + II-8C-1 | I-3 + II-21-3 | I-4 + II-1A-3 |
| I-3 + II-9A-1 | I-3 + II-21-4 | I-4 + II-1A-4 |
| I-3 + II-9B-1 | I-3 + II-21-5 | I-4 + II-1A-5 |
| I-3 + II-9B-2 | I-3 + II-21-6 | I-4 + II-1A-6 |
| I-3 + II-9C-1 | I-3 + II-21-7 | I-4 + II-1A-7 |
| I-3 + II-10A-1 | I-3 + II-22A-1 | I-4 + II-1A-8 |
| I-3 + II-10A-2 | I-3 + II-22B-1 | I-4 + II-1A-9 |
| I-3 + II-10B-1 | I-3 + II-23A-1 | I-4 + II-1A-10 |
| I-3 + II-12A-1 | I-3 + II-23A-2 | I-4 + II-1A-11 |
| I-3 + II-12B-1 | I-3 + II-23B-1 | I-4 + II-1A-12 |
| I-3 + II-12B-2 | I-3 + II-25-1 | I-4 + II-1A-13 |
| I-3 + II-12B-3 | I-3 + II-28-1 | I-4 + II-1A-14 |
| I-3 + II-12C-1 | I-3 + II-28-2 | I-4 + II-1A-15 |
| I-3 + II-12C-2 | I-3 + II-28-3 | I-4 + II-1A-16 |
| I-3 + II-13-1 | I-3 + II-28-4 | I-4 + II-1A-17 |
| I-3 + II-13-2 | I-3 + II-29-1 | I-4 + II-1A-18 |
| I-3 + II-13-3 | I-3 + II-29-2 | I-4 + II-1A-19 |
| I-3 + II-13-4 | I-3 + II-29-3 | I-4 + II-1A-20 |
| I-3 + II-13-5 | I-3 + II-29-4 | I-4 + II-1A-21 |
| I-3 + II-13-6 | I-3 + II-29-5 | I-4 + II-1A-22 |
| I-3 + II-15-1 | I-3 + II-29-6 | I-4 + II-1A-23 |
| I-3 + II-15-2 | I-3 + II-29-7 | I-4 + II-1A-24 |
| I-3 + II-15-3 | I-3 + II-29-8 | I-4 + II-1A-25 |
| I-3 + II-15-4 | I-3 + II-29-9 | I-4 + II-1A-26 |
| I-3 + II-15-5 | I-3 + II-29-10 | I-4 + II-1A-27 |
| I-4 + II-1A-28 | I-4 + II-1B-42 | I-4 + II-2A-3 |
| I-4 + II-1A-29 | I-4 + II-1B-43 | I-4 + II-2A-4 |
| I-4 + II-1A-30 | I-4 + II-1B-44 | I-4 + II-2A-5 |
| I-4 + II-1A-31 | I-4 + II-1B-45 | I-4 + II-2A-6 |
| I-4 + II-1A-32 | I-4 + II-1B-46 | I-4 + II-2A-7 |
| I-4 + II-1A-33 | I-4 + II-1B-47 | I-4 + II-2A-8 |
| I-4 + II-1A-34 | I-4 + II-1B-48 | I-4 + II-2B-1 |
| I-4 + II-1A-35 | I-4 + II-1B-49 | I-4 + II-2B-2 |
| I-4 + II-1B-1 | I-4 + II-1B-50 | I-4 + II-2B-3 |
| I-4 + II-1B-2 | I-4 + II-1B-51 | I-4 + II-2B-4 |
| I-4 + II-1B-3 | I-4 + II-1B-52 | I-4 + II-2B-5 |
| I-4 + II-1B-4 | I-4 + II-1B-53 | I-4 + II-2B-6 |
| I-4 + II-1B-5 | I-4 + II-1B-54 | I-4 + II-3-1 |
| I-4 + II-1B-6 | I-4 + II-1B-55 | I-4 + II-3-2 |
| I-4 + II-1B-7 | I-4 + II-1B-56 | I-4 + II-3-3 |
| I-4 + II-1B-8 | I-4 + II-1B-57 | I-4 + II-3-4 |
| I-4 + II-1B-9 | I-4 + II-1B-58 | I-4 + II-3-5 |
| I-4 + II-1B-10 | I-4 + II-1B-59 | I-4 + II-3-6 |
| I-4 + II-1B-11 | I-4 + II-1B-60 | I-4 + II-3-7 |
| I-4 + II-1B-12 | I-4 + II-1B-61 | I-4 + II-3-8 |
| I-4 + II-1B-13 | I-4 + II-1B-62 | I-4 + II-3-9 |
| I-4 + II-1B-14 | I-4 + II-1B-63 | I-4 + II-3-10 |
| I-4 + II-1B-15 | I-4 + II-1B-64 | I-4 + II-3-11 |
| I-4 + II-1B-16 | I-4 + II-1B-65 | I-4 + II-3-12 |
| I-4 + II-1B-17 | I-4 + II-1B-66 | I-4 + II-3-13 |
| I-4 + II-1B-18 | I-4 + II-1B-67 | I-4 + II-3-14 |
| I-4 + II-1B-19 | I-4 + II-1B-68 | I-4 + II-3-15 |
| I-4 + II-1B-20 | I-4 + II-1B-69 | I-4 + II-3-16 |
| I-4 + II-1B-21 | I-4 + II-1B-70 | I-4 + II-3-17 |
| I-4 + II-1B-22 | I-4 + II-1B-71 | I-4 + II-3-18 |
| I-4 + II-1B-23 | I-4 + II-1B-72 | I-4 + II-3-19 |
| I-4 + II-1B-24 | I-4 + II-1B-73 | I-4 + II-3-20 |
| I-4 + II-1B-25 | I-4 + II-1B-74 | I-4 + II-3-21 |
| I-4 + II-1B-26 | I-4 + II-1B-75 | I-4 + II-3-22 |
| I-4 + II-1B-27 | I-4 + II-1B-76 | I-4 + II-3-23 |
| I-4 + II-1B-28 | I-4 + II-1B-77 | I-4 + II-3-24 |
| I-4 + II-1B-29 | I-4 + II-1B-78 | I-4 + II-3-25 |
| I-4 + II-1B-30 | I-4 + II-1B-79 | I-4 + II-3-26 |
| I-4 + II-1B-31 | I-4 + II-1B-80 | I-4 + II-3-27 |
| I-4 + II-1B-32 | I-4 + II-1B-81 | I-4 + II-3-28 |
| I-4 + II-1B-33 | I-4 + II-1B-82 | I-4 + II-3-29 |
| I-4 + II-1B-34 | I-4 + II-1B-83 | I-4 + II-3-30 |
| I-4 + II-1B-35 | I-4 + II-1B-84 | I-4 + II-3-31 |
| I-4 + II-1B-36 | I-4 + II-1B-85 | I-4 + II-3-32 |
| I-4 + II-1B-37 | I-4 + II-1B-86 | I-4 + II-3-33 |
| I-4 + II-1B-38 | I-4 + II-1B-87 | I-4 + II-3-34 |
| I-4 + II-1B-39 | I-4 + II-1B-88 | I-4 + II-3-35 |
| I-4 + II-1B-40 | I-4 + II-2A-1 | I-4 + II-3-36 |
| I-4 + II-1B-41 | I-4 + II-2A-2 | I-4 + II-3-37 |
| I-4 + II-3-38 | I-4 + II-7C-1 | I-4 + II-20D-1 |
| I-4 + II-3-39 | I-4 + II-7C-2 | I-4 + II-20D-2 |
| I-4 + II-3-40 | I-4 + II-8A-1 | I-4 + II-21-1 |
| I-4 + II-3-41 | I-4 + II-8B-1 | I-4 + II-21-2 |
| I-4 + II-3-42 | I-4 + II-8C-1 | I-4 + II-21-3 |
| I-4 + II-3-43 | I-4 + II-9A-1 | I-4 + II-21-4 |
| I-4 + II-3-44 | I-4 + II-9B-1 | I-4 + II-21-5 |
| I-4 + II-3-45 | I-4 + II-9B-2 | I-4 + II-21-6 |
| I-4 + II-3-46 | I-4 + II-9C-1 | I-4 + II-21-7 |
| I-4 + II-3-47 | I-4 + II-10A-1 | I-4 + II-22A-1 |
| I-4 + II-3-48 | I-4 + II-10A-2 | I-4 + II-22B-1 |
| I-4 + II-3-49 | I-4 + II-10B-1 | I-4 + II-23A-1 |
| I-4 + II-3-50 | I-4 + II-12A-1 | I-4 + II-23A-2 |
| I-4 + II-3-51 | I-4 + II-12B-1 | I-4 + II-23B-1 |
| I-4 + II-3-52 | I-4 + II-12B-2 | I-4 + II-25-1 |
| I-4 + II-3-53 | I-4 + II-12B-3 | I-4 + II-28-1 |
| I-4 + II-3-54 | I-4 + II-12C-1 | I-4 + II-28-2 |
| I-4 + II-3-55 | I-4 + II-12C-2 | I-4 + II-28-3 |
| I-4 + II-3-56 | I-4 + II-13-1 | I-4 + II-28-4 |
| I-4 + II-3-57 | I-4 + II-13-2 | I-4 + II-29-1 |
| I-4 + II-3-58 | I-4 + II-13-3 | I-4 + II-29-2 |
| I-4 + II-4A-1 | I-4 + II-13-4 | I-4 + II-29-3 |
| I-4 + II-4A-2 | I-4 + II-13-5 | I-4 + II-29-4 |
| I-4 + II-4A-3 | I-4 + II-13-6 | I-4 + II-29-5 |
| I-4 + II-4A-4 | I-4 + II-15-1 | I-4 + II-29-6 |
| I-4 + II-4A-5 | I-4 + II-15-2 | I-4 + II-29-7 |
| I-4 + II-4A-6 | I-4 + II-15-3 | I-4 + II-29-8 |
| I-4 + II-4A-7 | I-4 + II-15-4 | I-4 + II-29-9 |
| I-4 + II-4A-8 | I-4 + II-15-5 | I-4 + II-29-10 |
| I-4 + II-4A-9 | I-4 + II-15-6 | I-4 + II-29-11 |
| I-4 + II-4B-1 | I-4 + II-15-7 | I-4 + II-29-12 |
| I-4 + II-4B-2 | I-4 + II-15-8 | I-4 + II-29-13 |
| I-4 + II-4B-3 | I-4 + II-15-9 | I-4 + II-29-14 |
| I-4 + II-4B-4 | I-4 + II-15-10 | I-4 + II-29-15 |
| I-4 + II-4C-4 | I-4 + II-15-11 | I-4 + II-29-16 |
| I-4 + II-5-1 | I-4 + II-15-12 | I-4 + II-29-17 |
| I-4 + II-5-2 | I-4 + II-15-13 | I-4 + II-29-18 |
| I-4 + II-6-1 | I-4 + II-16-1 | I-4 + II-29-19 |
| I-4 + II-6-2 | I-4 + II-17-1 | I-4 + II-29-20 |
| I-4 + II-6-3 | I-4 + II-18A-1 | I-4 + II-29-21 |
| I-4 + II-6-4 | I-4 + II-18A-2 | I-4 + II-29-22 |
| I-4 + II-6-5 | I-4 + II-18A-3 | I-4 + II-29-23 |
| I-4 + II-6-6 | I-4 + II-18A-4 | I-4 + II-29-24 |
| I-4 + II-7A-1 | I-4 + II-18A-5 | I-4 + II-29-25 |
| I-4 + II-7A-2 | I-4 + II-18B-1 | I-4 + II-29-26 |
| I-4 + II-7A-3 | I-4 + II-19-1 | I-4 + II-29-27 |
| I-4 + II-7A-4 | I-4 + II-20A-1 | I-4 + II-29-28 |
| I-4 + II-7A-5 | I-4 + II-20B-1 | I-4 + II-29-29 |
| I-4 + II-7B-1 | I-4 + II-20C-1 | I-4 + II-29-30 |
| I-4 + II-29-31 | I-5 + II-1B-13 | I-5 + II-1B-62 |
| I-4 + II-29-32 | I-5 + II-1B-14 | I-5 + II-1B-63 |
| I-5 + II-1A-1 | I-5 + II-1B-15 | I-5 + II-1B-64 |
| I-5 + II-1A-2 | I-5 + II-1B-16 | I-5 + II-1B-65 |
| I-5 + II-1A-3 | I-5 + II-1B-17 | I-5 + II-1B-66 |
| I-5 + II-1A-4 | I-5 + II-1B-18 | I-5 + II-1B-67 |
| I-5 + II-1A-5 | I-5 + II-1B-19 | I-5 + II-1B-68 |
| I-5 + II-1A-6 | I-5 + II-1B-20 | I-5 + II-1B-69 |
| I-5 + II-1A-7 | I-5 + II-1B-21 | I-5 + II-1B-70 |
| I-5 + II-1A-8 | I-5 + II-1B-22 | I-5 + II-1B-71 |
| I-5 + II-1A-9 | I-5 + II-1B-23 | I-5 + II-1B-72 |
| I-5 + II-1A-10 | I-5 + II-1B-24 | I-5 + II-1B-73 |
| I-5 + II-1A-11 | I-5 + II-1B-25 | I-5 + II-1B-74 |
| I-5 + II-1A-12 | I-5 + II-1B-26 | I-5 + II-1B-75 |
| I-5 + II-1A-13 | I-5 + II-1B-27 | I-5 + II-1B-76 |
| I-5 + II-1A-14 | I-5 + II-1B-28 | I-5 + II-1B-77 |
| I-5 + II-1A-15 | I-5 + II-1B-29 | I-5 + II-1B-78 |
| I-5 + II-1A-16 | I-5 + II-1B-30 | I-5 + II-1B-79 |
| I-5 + II-1A-17 | I-5 + II-1B-31 | I-5 + II-1B-80 |
| I-5 + II-1A-18 | I-5 + II-1B-32 | I-5 + II-1B-81 |
| I-5 + II-1A-19 | I-5 + II-1B-33 | I-5 + II-1B-82 |
| I-5 + II-1A-20 | I-5 + II-1B-34 | I-5 + II-1B-83 |
| I-5 + II-1A-21 | I-5 + II-1B-35 | I-5 + II-1B-84 |
| I-5 + II-1A-22 | I-5 + II-1B-36 | I-5 + II-1B-85 |
| I-5 + II-1A-23 | I-5 + II-1B-37 | I-5 + II-1B-86 |
| I-5 + II-1A-24 | I-5 + II-1B-38 | I-5 + II-1B-87 |
| I-5 + II-1A-25 | I-5 + II-1B-39 | I-5 + II-1B-88 |
| I-5 + II-1A-26 | I-5 + II-1B-40 | I-5 + II-2A-1 |
| I-5 + II-1A-27 | I-5 + II-1B-41 | I-5 + II-2A-2 |
| I-5 + II-1A-28 | I-5 + II-1B-42 | I-5 + II-2A-3 |
| I-5 + II-1A-29 | I-5 + II-1B-43 | I-5 + II-2A-4 |
| I-5 + II-1A-30 | I-5 + II-1B-44 | I-5 + II-2A-5 |
| I-5 + II-1A-31 | I-5 + II-1B-45 | I-5 + II-2A-6 |
| I-5 + II-1A-32 | I-5 + II-1B-46 | I-5 + II-2A-7 |
| I-5 + II-1A-33 | I-5 + II-1B-47 | I-5 + II-2A-8 |
| I-5 + II-1A-34 | I-5 + II-1B-48 | I-5 + II-2B-1 |
| I-5 + II-1A-35 | I-5 + II-1B-49 | I-5 + II-2B-2 |
| I-5 + II-1B-1 | I-5 + II-1B-50 | I-5 + II-2B-3 |
| I-5 + II-1B-2 | I-5 + II-1B-51 | I-5 + II-2B-4 |
| I-5 + II-1B-3 | I-5 + II-1B-52 | I-5 + II-2B-5 |
| I-5 + II-1B-4 | I-5 + II-1B-53 | I-5 + II-2B-6 |
| I-5 + II-1B-5 | I-5 + II-1B-54 | I-5 + II-3-1 |
| I-5 + II-1B-6 | I-5 + II-1B-55 | I-5 + II-3-2 |
| I-5 + II-1B-7 | I-5 + II-1B-56 | I-5 + II-3-3 |
| I-5 + II-1B-8 | I-5 + II-1B-57 | I-5 + II-3-4 |
| I-5 + II-1B-9 | I-5 + II-1B-58 | I-5 + II-3-5 |
| I-5 + II-1B-10 | I-5 + II-1B-59 | I-5 + II-3-6 |
| I-5 + II-1B-11 | I-5 + II-1B-60 | I-5 + II-3-7 |
| I-5 + II-1B-12 | I-5 + II-1B-61 | I-5 + II-3-8 |
| I-5 + II-3-9 | I-5 + II-3-58 | I-5 + II-13-3 |
| I-5 + II-3-10 | I-5 + II-4A-1 | I-5 + II-13-4 |
| I-5 + II-3-11 | I-5 + II-4A-2 | I-5 + II-13-5 |
| I-5 + II-3-12 | I-5 + II-4A-3 | I-5 + II-13-6 |
| I-5 + II-3-13 | I-5 + II-4A-4 | I-5 + II-15-1 |
| I-5 + II-3-14 | I-5 + II-4A-5 | I-5 + II-15-2 |
| I-5 + II-3-15 | I-5 + II-4A-6 | I-5 + II-15-3 |
| I-5 + II-3-16 | I-5 + II-4A-7 | I-5 + II-15-4 |
| I-5 + II-3-17 | I-5 + II-4A-8 | I-5 + II-15-5 |
| I-5 + II-3-18 | I-5 + II-4A-9 | I-5 + II-15-6 |
| I-5 + II-3-19 | I-5 + II-4B-1 | I-5 + II-15-7 |
| I-5 + II-3-20 | I-5 + II-4B-2 | I-5 + II-15-8 |
| I-5 + II-3-21 | I-5 + II-4B-3 | I-5 + II-15-9 |
| I-5 + II-3-22 | I-5 + II-4B-4 | I-5 + II-15-10 |
| I-5 + II-3-23 | I-5 + II-4C-4 | I-5 + II-15-11 |
| I-5 + II-3-24 | I-5 + II-5-1 | I-5 + II-15-12 |
| I-5 + II-3-25 | I-5 + II-5-2 | I-5 + II-15-13 |
| I-5 + II-3-26 | I-5 + II-6-1 | I-5 + II-16-1 |
| I-5 + II-3-27 | I-5 + II-6-2 | I-5 + II-17-1 |
| I-5 + II-3-28 | I-5 + II-6-3 | I-5 + II-18A-1 |
| I-5 + II-3-29 | I-5 + II-6-4 | I-5 + II-18A-2 |
| I-5 + II-3-30 | I-5 + II-6-5 | I-5 + II-18A-3 |
| I-5 + II-3-31 | I-5 + II-6-6 | I-5 + II-18A-4 |
| I-5 + II-3-32 | I-5 + II-7A-1 | I-5 + II-18A-5 |
| I-5 + II-3-33 | I-5 + II-7A-2 | I-5 + II-18B-1 |
| I-5 + II-3-34 | I-5 + II-7A-3 | I-5 + II-19-1 |
| I-5 + II-3-35 | I-5 + II-7A-4 | I-5 + II-20A-1 |
| I-5 + II-3-36 | I-5 + II-7A-5 | I-5 + II-20B-1 |
| I-5 + II-3-37 | I-5 + II-7B-1 | I-5 + II-20C-1 |
| I-5 + II-3-38 | I-5 + II-7C-1 | I-5 + II-20D-1 |
| I-5 + II-3-39 | I-5 + II-7C-2 | I-5 + II-20D-2 |
| I-5 + II-3-40 | I-5 + II-8A-1 | I-5 + II-21-1 |
| I-5 + II-3-41 | I-5 + II-8B-1 | I-5 + II-21-2 |
| I-5 + II-3-42 | I-5 + II-8C-1 | I-5 + II-21-3 |
| I-5 + II-3-43 | I-5 + II-9A-1 | I-5 + II-21-4 |
| I-5 + II-3-44 | I-5 + II-9B-1 | I-5 + II-21-5 |
| I-5 + II-3-45 | I-5 + II-9B-2 | I-5 + II-21-6 |
| I-5 + II-3-46 | I-5 + II-9C-1 | I-5 + II-21-7 |
| I-5 + II-3-47 | I-5 + II-10A-1 | I-5 + II-22A-1 |
| I-5 + II-3-48 | I-5 + II-10A-2 | I-5 + II-22B-1 |
| I-5 + II-3-49 | I-5 + II-10B-1 | I-5 + II-23A-1 |
| I-5 + II-3-50 | I-5 + II-12A-1 | I-5 + II-23A-2 |
| I-5 + II-3-51 | I-5 + II-12B-1 | I-5 + II-23B-1 |
| I-5 + II-3-52 | I-5 + II-12B-2 | I-5 + II-25-1 |
| I-5 + II-3-53 | I-5 + II-12B-3 | I-5 + II-28-1 |
| I-5 + II-3-54 | I-5 + II-12C-1 | I-5 + II-28-2 |
| I-5 + II-3-55 | I-5 + II-12C-2 | I-5 + II-28-3 |
| I-5 + II-3-56 | I-5 + II-13-1 | I-5 + II-28-4 |
| I-5 + II-3-57 | I-5 + II-13-2 | I-5 + II-29-1 |
| I-5 + II-29-2 | I-6 + II-1A-19 | I-6 + II-1B-33 |
| I-5 + II-29-3 | I-6 + II-1A-20 | I-6 + II-1B-34 |
| I-5 + II-29-4 | I-6 + II-1A-21 | I-6 + II-1B-35 |
| I-5 + II-29-5 | I-6 + II-1A-22 | I-6 + II-1B-36 |
| I-5 + II-29-6 | I-6 + II-1A-23 | I-6 + II-1B-37 |
| I-5 + II-29-7 | I-6 + II-1A-24 | I-6 + II-1B-38 |
| I-5 + II-29-8 | I-6 + II-1A-25 | I-6 + II-1B-39 |
| I-5 + II-29-9 | I-6 + II-1A-26 | I-6 + II-1B-40 |
| I-5 + II-29-10 | I-6 + II-1A-27 | I-6 + II-1B-41 |
| I-5 + II-29-11 | I-6 + II-1A-28 | I-6 + II-1B-42 |
| I-5 + II-29-12 | I-6 + II-1A-29 | I-6 + II-1B-43 |
| I-5 + II-29-13 | I-6 + II-1A-30 | I-6 + II-1B-44 |
| I-5 + II-29-14 | I-6 + II-1A-31 | I-6 + II-1B-45 |
| I-5 + II-29-15 | I-6 + II-1A-32 | I-6 + II-1B-46 |
| I-5 + II-29-16 | I-6 + II-1A-33 | I-6 + II-1B-47 |
| I-5 + II-29-17 | I-6 + II-1A-34 | I-6 + II-1B-48 |
| I-5 + II-29-18 | I-6 + II-1A-35 | I-6 + II-1B-49 |
| I-5 + II-29-19 | I-6 + II-1B-1 | I-6 + II-1B-50 |
| I-5 + II-29-20 | I-6 + II-1B-2 | I-6 + II-1B-51 |
| I-5 + II-29-21 | I-6 + II-1B-3 | I-6 + II-1B-52 |
| I-5 + II-29-22 | I-6 + II-1B-4 | I-6 + II-1B-53 |
| I-5 + II-29-23 | I-6 + II-1B-5 | I-6 + II-1B-54 |
| I-5 + II-29-24 | I-6 + II-1B-6 | I-6 + II-1B-55 |
| I-5 + II-29-25 | I-6 + II-1B-7 | I-6 + II-1B-56 |
| I-5 + II-29-26 | I-6 + II-1B-8 | I-6 + II-1B-57 |
| I-5 + II-29-27 | I-6 + II-1B-9 | I-6 + II-1B-58 |
| I-5 + II-29-28 | I-6 + II-1B-10 | I-6 + II-1B-59 |
| I-5 + II-29-29 | I-6 + II-1B-11 | I-6 + II-1B-60 |
| I-5 + II-29-30 | I-6 + II-1B-12 | I-6 + II-1B-61 |
| I-5 + II-29-31 | I-6 + II-1B-13 | I-6 + II-1B-62 |
| I-5 + II-29-32 | I-6 + II-1B-14 | I-6 + II-1B-63 |
| I-6 + II-1A-1 | I-6 + II-1B-15 | I-6 + II-1B-64 |
| I-6 + II-1A-2 | I-6 + II-1B-16 | I-6 + II-1B-65 |
| I-6 + II-1A-3 | I-6 + II-1B-17 | I-6 + II-1B-66 |
| I-6 + II-1A-4 | I-6 + II-1B-18 | I-6 + II-1B-67 |
| I-6 + II-1A-5 | I-6 + II-1B-19 | I-6 + II-1B-68 |
| I-6 + II-1A-6 | I-6 + II-1B-20 | I-6 + II-1B-69 |
| I-6 + II-1A-7 | I-6 + II-1B-21 | I-6 + II-1B-70 |
| I-6 + II-1A-8 | I-6 + II-1B-22 | I-6 + II-1B-71 |
| I-6 + II-1A-9 | I-6 + II-1B-23 | I-6 + II-1B-72 |
| I-6 + II-1A-10 | I-6 + II-1B-24 | I-6 + II-1B-73 |
| I-6 + II-1A-11 | I-6 + II-1B-25 | I-6 + II-1B-74 |
| I-6 + II-1A-12 | I-6 + II-1B-26 | I-6 + II-1B-75 |
| I-6 + II-1A-13 | I-6 + II-1B-27 | I-6 + II-1B-76 |
| I-6 + II-1A-14 | I-6 + II-1B-28 | I-6 + II-1B-77 |
| I-6 + II-1A-15 | I-6 + II-1B-29 | I-6 + II-1B-78 |
| I-6 + II-1A-16 | I-6 + II-1B-30 | I-6 + II-1B-79 |
| I-6 + II-1A-17 | I-6 + II-1B-31 | I-6 + II-1B-80 |
| I-6 + II-1A-18 | I-6 + II-1B-32 | I-6 + II-1B-81 |
| I-6 + II-1B-82 | I-6 + II-3-29 | I-6 + II-6-4 |
| I-6 + II-1B-83 | I-6 + II-3-30 | I-6 + II-6-5 |
| I-6 + II-1B-84 | I-6 + II-3-31 | I-6 + II-6-6 |
| I-6 + II-1B-85 | I-6 + II-3-32 | I-6 + II-7A-1 |
| I-6 + II-1B-86 | I-6 + II-3-33 | I-6 + II-7A-2 |
| I-6 + II-1B-87 | I-6 + II-3-34 | I-6 + II-7A-3 |
| I-6 + II-1B-88 | I-6 + II-3-35 | I-6 + II-7A-4 |
| I-6 + II-2A-1 | I-6 + II-3-36 | I-6 + II-7A-5 |
| I-6 + II-2A-2 | I-6 + II-3-37 | I-6 + II-7B-1 |
| I-6 + II-2A-3 | I-6 + II-3-38 | I-6 + II-7C-1 |
| I-6 + II-2A-4 | I-6 + II-3-39 | I-6 + II-7C-2 |
| I-6 + II-2A-5 | I-6 + II-3-40 | I-6 + II-8A-1 |
| I-6 + II-2A-6 | I-6 + II-3-41 | I-6 + II-8B-1 |
| I-6 + II-2A-7 | I-6 + II-3-42 | I-6 + II-8C-1 |
| I-6 + II-2A-8 | I-6 + II-3-43 | I-6 + II-9A-1 |
| I-6 + II-2B-1 | I-6 + II-3-44 | I-6 + II-9B-1 |
| I-6 + II-2B-2 | I-6 + II-3-45 | I-6 + II-9B-2 |
| I-6 + II-2B-3 | I-6 + II-3-46 | I-6 + II-9C-1 |
| I-6 + II-2B-4 | I-6 + II-3-47 | I-6 + II-10A-1 |
| I-6 + II-2B-5 | I-6 + II-3-48 | I-6 + II-10A-2 |
| I-6 + II-2B-6 | I-6 + II-3-49 | I-6 + II-10B-1 |
| I-6 + II-3-1 | I-6 + II-3-50 | I-6 + II-12A-1 |
| I-6 + II-3-2 | I-6 + II-3-51 | I-6 + II-12B-1 |
| I-6 + II-3-3 | I-6 + II-3-52 | I-6 + II-12B-2 |
| I-6 + II-3-4 | I-6 + II-3-53 | I-6 + II-12B-3 |
| I-6 + II-3-5 | I-6 + II-3-54 | I-6 + II-12C-1 |
| I-6 + II-3-6 | I-6 + II-3-55 | I-6 + II-12C-2 |
| I-6 + II-3-7 | I-6 + II-3-56 | I-6 + II-13-1 |
| I-6 + II-3-8 | I-6 + II-3-57 | I-6 + II-13-2 |
| I-6 + II-3-9 | I-6 + II-3-58 | I-6 + II-13-3 |
| I-6 + II-3-10 | I-6 + II-4A-1 | I-6 + II-13-4 |
| I-6 + II-3-11 | I-6 + II-4A-2 | I-6 + II-13-5 |
| I-6 + II-3-12 | I-6 + II-4A-3 | I-6 + II-13-6 |
| I-6 + II-3-13 | I-6 + II-4A-4 | I-6 + II-15-1 |
| I-6 + II-3-14 | I-6 + II-4A-5 | I-6 + II-15-2 |
| I-6 + II-3-15 | I-6 + II-4A-6 | I-6 + II-15-3 |
| I-6 + II-3-16 | I-6 + II-4A-7 | I-6 + II-15-4 |
| I-6 + II-3-17 | I-6 + II-4A-8 | I-6 + II-15-5 |
| I-6 + II-3-18 | I-6 + II-4A-9 | I-6 + II-15-6 |
| I-6 + II-3-19 | I-6 + II-4B-1 | I-6 + II-15-7 |
| I-6 + II-3-20 | I-6 + II-4B-2 | I-6 + II-15-8 |
| I-6 + II-3-21 | I-6 + II-4B-3 | I-6 + II-15-9 |
| I-6 + II-3-22 | I-6 + II-4B-4 | I-6 + II-15-10 |
| I-6 + II-3-23 | I-6 + II-4C-4 | I-6 + II-15-11 |
| I-6 + II-3-24 | I-6 + II-5-1 | I-6 + II-15-12 |
| I-6 + II-3-25 | I-6 + II-5-2 | I-6 + II-15-13 |
| I-6 + II-3-26 | I-6 + II-6-1 | I-6 + II-16-1 |
| I-6 + II-3-27 | I-6 + II-6-2 | I-6 + II-17-1 |
| I-6 + II-3-28 | I-6 + II-6-3 | I-6 + II-18A-1 |
| I-6 + II-18A-2 | I-6 + II-23A-1 | I-6 + II-29-13 |
| I-6 + II-18A-3 | I-6 + II-23A-2 | I-6 + II-29-14 |
| I-6 + II-18A-4 | I-6 + II-23B-1 | I-6 + II-29-15 |
| I-6 + II-18A-5 | I-6 + II-25-1 | I-6 + II-29-16 |
| I-6 + II-18B-1 | I-6 + II-28-1 | I-6 + II-29-17 |
| I-6 + II-19-1 | I-6 + II-28-2 | I-6 + II-29-18 |
| I-6 + II-20A-1 | I-6 + II-28-3 | I-6 + II-29-19 |
| I-6 + II-20B-1 | I-6 + II-28-4 | I-6 + II-29-20 |
| I-6 + II-20C-1 | I-6 + II-29-1 | I-6 + II-29-21 |
| I-6 + II-20D-1 | I-6 + II-29-2 | I-6 + II-29-22 |
| I-6 + II-20D-2 | I-6 + II-29-3 | I-6 + II-29-23 |
| I-6 + II-21-1 | I-6 + II-29-4 | I-6 + II-29-24 |
| I-6 + II-21-2 | I-6 + II-29-5 | I-6 + II-29-25 |
| I-6 + II-21-3 | I-6 + II-29-6 | I-6 + II-29-26 |
| I-6 + II-21-4 | I-6 + II-29-7 | I-6 + II-29-27 |
| I-6 + II-21-5 | I-6 + II-29-8 | I-6 + II-29-28 |
| I-6 + II-21-6 | I-6 + II-29-9 | I-6 + II-29-29 |
| I-6 + II-21-7 | I-6 + II-29-10 | I-6 + II-29-30 |
| I-6 + II-22A-1 | I-6 + II-29-11 | I-6 + II-29-31 |
| I-6 + II-22B-1 | I-6 + II-29-12 | I-6 + II-29-32 |

A preferred group of active compound combinations according to the invention are those which, in addition to an active compound of the formula (II), in particular one of the active compounds 1 to 105 listed below and referred to as being very particularly preferred, comprise the compound of the formula (I-1).

A further preferred group of active compound combinations according to the invention are those which, in addition to an active compound of the formula (II), in particular one of the active compounds 1 to 105 listed below and referred to as being very particularly preferred, comprise the compound of the formula (I-2).

A further preferred group of active compound combinations according to the invention are those which, in addition to an active compound of the formula (II), in particular one of the active compounds 1 to 105 listed below and referred to as being very particularly preferred, comprise the compound of the formula (I-3).

A further preferred group of active compound combinations according to the invention are those which, in addition to an active compound of the formula (II), in particular one of the active compounds 1 to 105 listed below and referred to as being very particularly preferred, comprise the compound of the formula (I-4).

A further preferred group of active compound combinations according to the invention are those which, in addition to an active compound of the formula (II), in particular one of the active compounds 1 to 105 listed below and referred to as being very particularly preferred, comprise the compound of the formula (I-5).

A further preferred group of active compound combinations according to the invention are those which, in addition to an active compound of the formula (II), in particular one of the active compounds 1 to 105 listed below and referred to as being very particularly preferred, comprise the compound of the formula (I-6).

The following active compounds of the formula (II) are used with very particular preference in the active compound combinations according to the invention:

1. Acrinathrin (II-3-1)

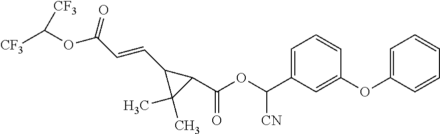

known from EP-A-048 186

2. Alpha-Cypermethrin (II-3-18)

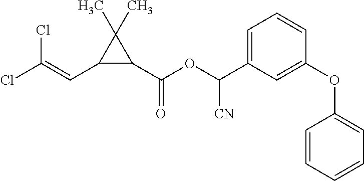

known from EP-A-067 461

3. Betacyfluthrin (II-3-3)

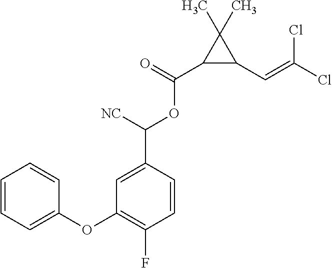

known from EP-A-206 149

4. Cyhalothrin (II-3-17)

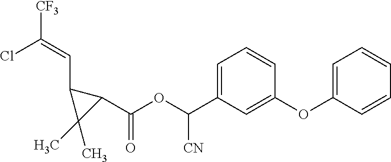

known from DE-A-2 802 962

5. Cypermethrin (II-3-18)

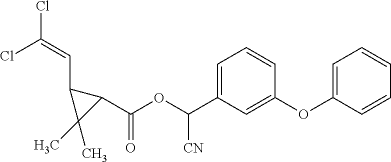

known from DE-A-2 326 077

6. Deltamethrin (II-3-20)

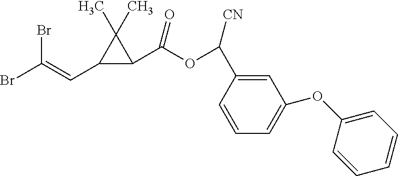

known from DE-A-2 326 077

7. Esfenvalerate (II-3-22)

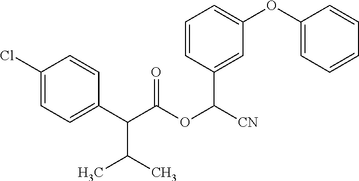

known from DE-A-2 737 297

8. Etofenprox (II-3-23)

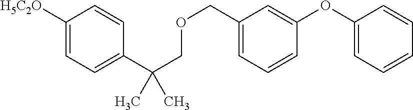

known from DE-A-3 117 510

9. Fenpropathrin (II-3-25)

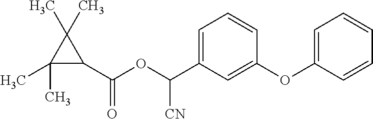

known from DE-A-2 231 312

10. Fenvalerate (II-3-27)

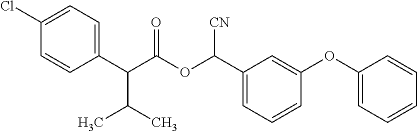

known from DE-A-2 335 347

11. Flucythrinate (II-3-29)

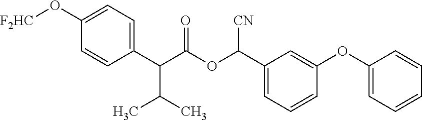

known from DE-A-2 757 066

12a. Lambda-Cyhalothrin (II-3-37)

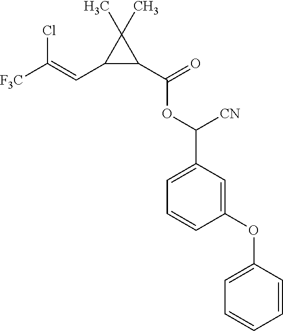

known from EP-A-106 469

12b. Gamma-Cyhalothrin (II-3-34)

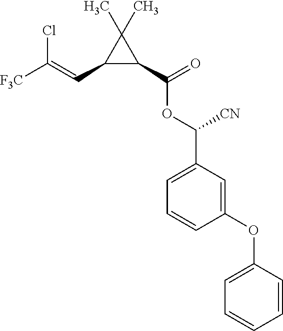

known from GB-A-02143823

13. Permethrin (II-3-39)

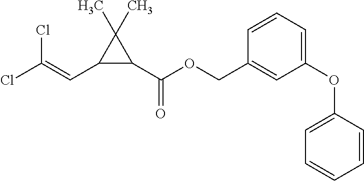

known from DE-A-2 326 077

14. Taufluvalinate (II-3-48)

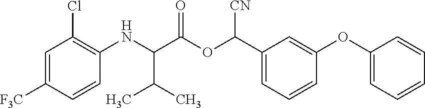

known from EP-A-038 617

15. Tralomethrin (II-3-52)

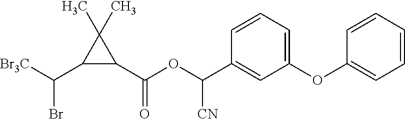

known from DE-A-2 742 546

16. Zeta-Cypermethrin (II-3-18)

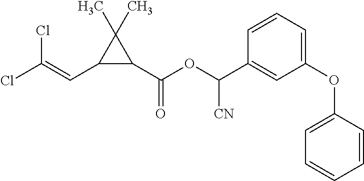

known from EP-A-026 542

17. Cyfluthrin (II-3-16)

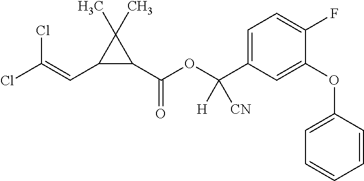

known from DE-A-27 09 264

18. Bifenthrin (II-3-4)

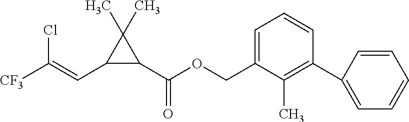

known from EP-A-049 977

19. Cycloprothrin (II-3-15)

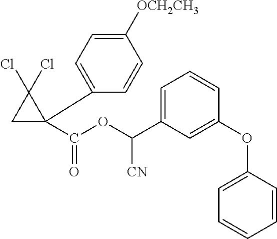

known from DE-A-2653189

20. Eflusilanate (II-3-56)

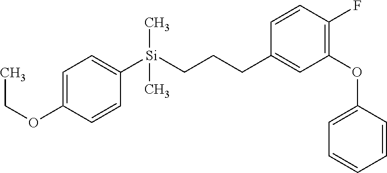

known from DE-A-36 04 781

21. Fubfenprox (II-3-33)

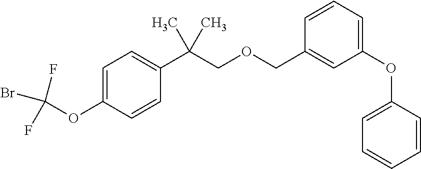

known from DE-A-37 08 231

22. Transfluthrin (II-3-53)

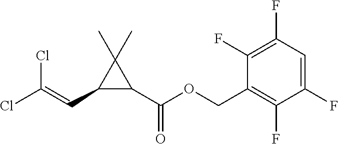

known from EP 0 279 325

23. Pyrethrin (II-3-55)

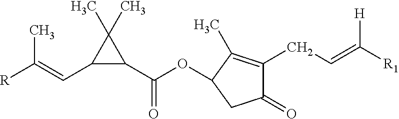

R═—CH₃ or —CO₂CH₃

R₁═—CH═CH₂ or —CH₃ or —CH₂CH₃

known from The Pesticide Manual, 1997, 11th Edition, p. 1056

24. Resmethrin (II-3-45)

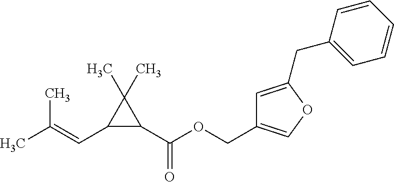

known from GB-A-1 168 797

25. Imidacloprid (II-4A-4)

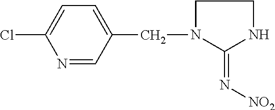

known from EP-A-00192060

26. Acetamiprid (II-4A-1)

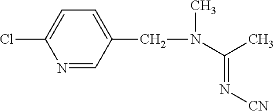

known from WO 91/04965

27. Thiamethoxam (II-4A-9)

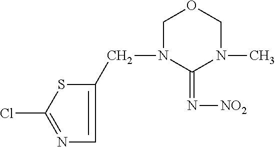

known from EP-A-00580553

28. Nitenpyram (II-4A-6)

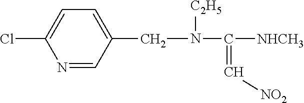

known from EP-A-00302389

29. Thiacloprid (II-4A-8)

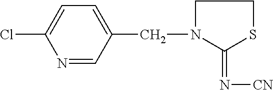

known from EP-A-00235725

30. Dinotefuran (II-4A-3)

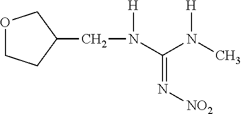

known from EP-A-00649845

31. Clothianidin (II-4A-2)

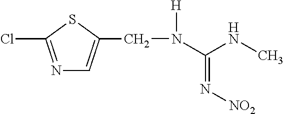

known from EP-A-00376279

32. Imidaclothiz (II-4A-5)

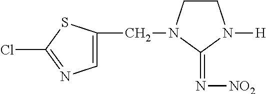

known from EP-A-00192060

33. Chlorfluazuron (II-15-2)

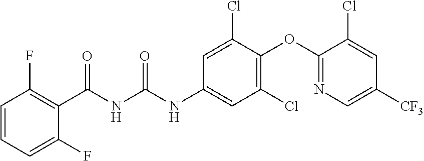

known from DE-A-2 818 830

34. Diflubenzuron (II-15-3)

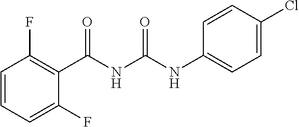

known from DE-A 2 123 236

35. Lufenuron (II-15-8)

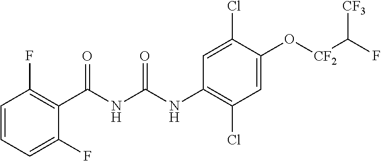

known from EP-A-179 022

36. Teflubenzuron (II-15-12)

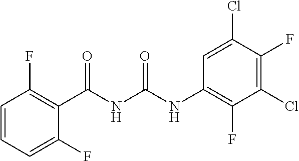

known from EP-A-052 833

37. Triflumuron (II-15-13)

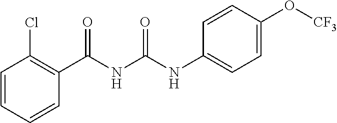

known from DE-A-2 601 780

38. Novaluron (II-15-9)

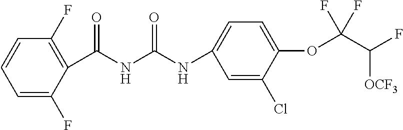

known from U.S. Pat. No. 4,980,376

39. Flufenoxuron (II-15-6)

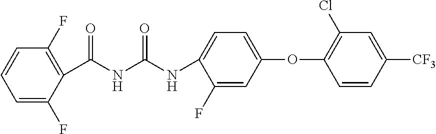

known from EP-A 161 019

40. Hexaflumuron (II-15-7)

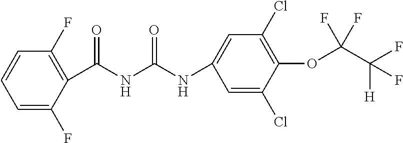

known from EP-A 71 279

41. Bistrifluoron (II-15-1)

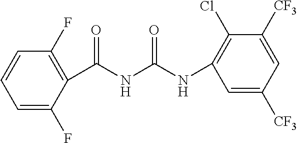

known from WO 98/00394

42. Noviflumuron (II-15-10)

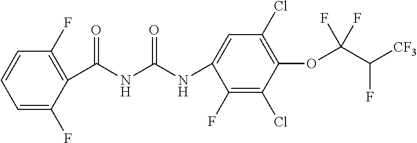

known from WO 98/19542

43. Buprofezin (II-16-1)

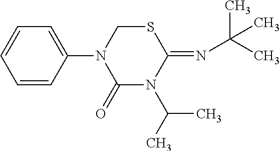

known from DE-A-2 824 126

44. Cyromazine (II-17-1)

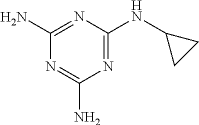

known from DE-A-2 736 876

45. Methoxyfenozide (II-18A-3)

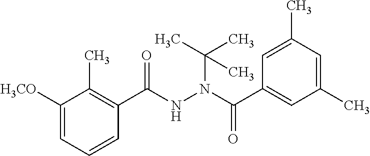

known from EP-A-639 559

46. Tebufenozide (II-18A-4)

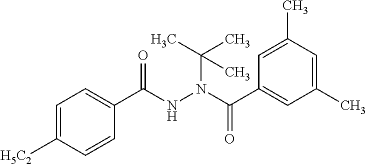

known from EP-A-339 854

47. Halofenozide (II-18A-2)

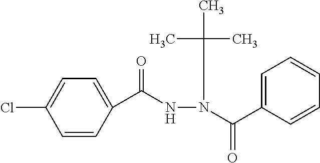

known from EP-A 228 564

48. Fufenozide (JS-118) (II-18A-5)

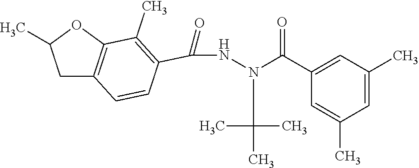

known from ZL 01108161.9, trade name Fu-Shen,
Modern Agrochemicals, Vol. 4, No. 3, 2005, 1-7

49. Chromafenozide (II-18A-1)

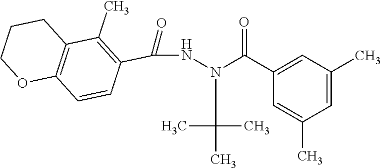

known from EP-A-496342

50. Endosulfan (II-2A-3)

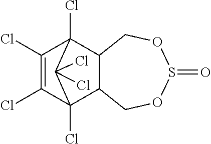

51. Fipronil (II-2B-3)

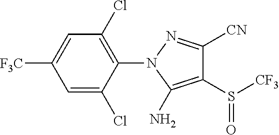

known from EP-A-295 117

52. Ethiprole (II-2B-2)

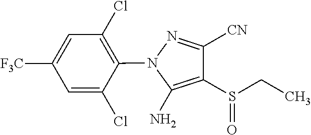

known from WO 97/22593

53. Pyrafluprole (II-2B-4)

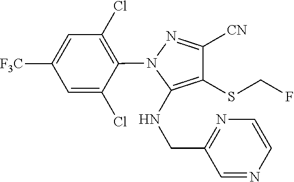

known from WO 01/00614

54. Pyriprole (II-2B-5)

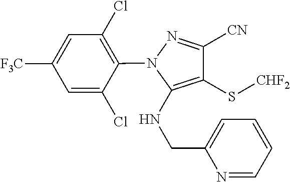

known from WO 02/10153

55. Flubendiamide (II-28-1)

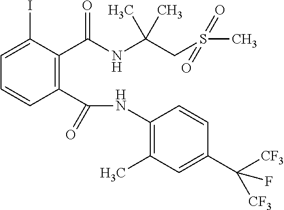

known from EP-A-01006107

56. The Compound (II-28-2)

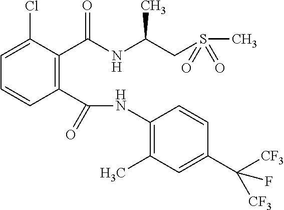

known from WO 06/022225

57. Rynaxypyr (II-28-3)

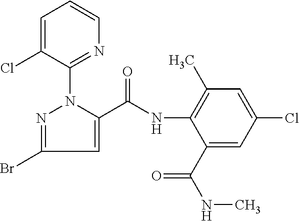

known from WO 03/015519

57. Cyazypyr (HGW86) (II-28-4)

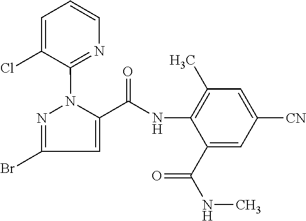

known from WO 04/067528

59. Emamectin (II-6-2)
known from EP-A-089 202

60. Emamectin Benzoate (II-6-3)
known from EP-A-089202

61. Abamectin (II-6-1)
known from DE-A-27 17 040

62. Ivermectin (II-6-4)
known from EP-A-001 689

63. Milbemectin (II-6-6)
known from The Pesticide Manual, 11th edition, 1997, p. 846

64. Lepimectin (II-6-5)
known from EP-A-675 133

65. Tebufenpyrad (II-21-5)

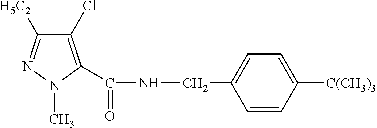

known from EP-A-289 879

66. Fenpyroximate (II-21-2)

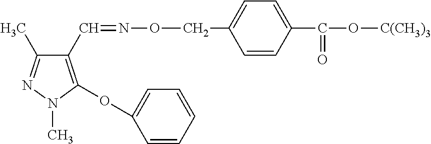

known from EP-A-234 045

67. Pyridaben (II-21-4)

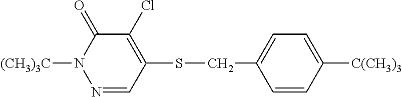

known from EP-A-134 439

68. Fenazaquin (II-21-1)

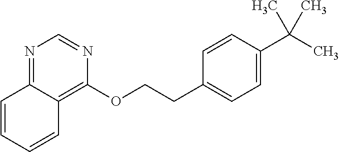

known from EP-A-326 329

69. Pyrimidifen (II-21-3)

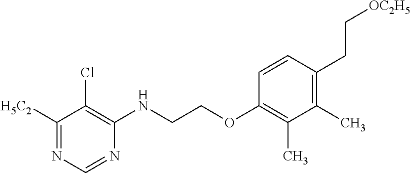

known from EP-A-196 524

70. Tolfenpyrad (II-21-6)

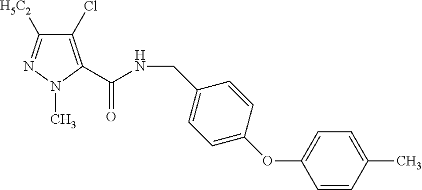

known from EP-A-365 925

71. Dicofol (II-29-11)

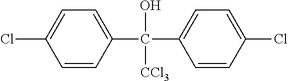

known from U.S. Pat. No. 2,812,280

72. Cyenopyrafen (II-20D-2)
(1E)-2-cyano-2-[4-(1,1-dimethylethyl)phenyl]-1-(1,3,4-trimethyl-1H-pyrazol-5-yl)ethenyl-2,2-dimethylpropanoate

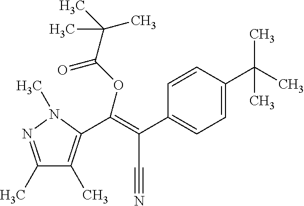

known from JP-A-2003 201 280

73. Cyflumetofen (II-20D-1)
2-methoxyethyl alpha-cyano-alpha-[4-(1,1-dimethylethyl)phenyl]-beta-oxo-2-(trifluoromethyl)benzenepropanoate

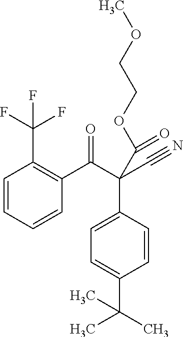

known from WO 2002/014263

74. Acequinocyl (II-20B-1)

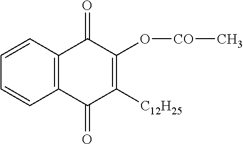

known from DE-A-26 41 343

75. Fluacrypyrim (II-20C-1)

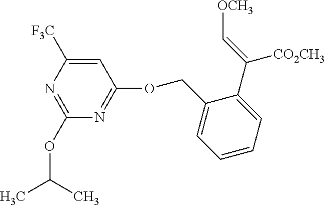

known from WO 96/16047

76. Bifenazate (II-25-1)

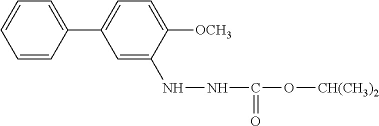

known from WO 93/10 083

77. Diafenthiuron (II-12A-1)

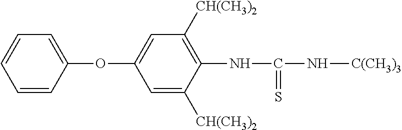

known from EP-A-210 487

78. Etoxazole (II-10B-1)

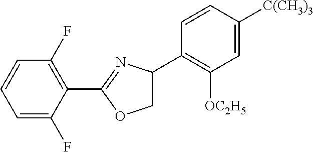

known from WO 93/22 297

79. Clofentezine (II-10A-1)

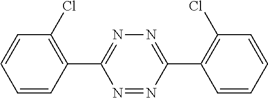

known from EP-A-005 912

80. The Macrolide of the Formula

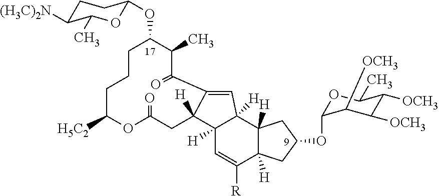

spinosad (II-5-1) a mixture of preferably
85% of spinosyn A R═H
15% of spinosyn B R═CH₃
known from EP-A-375 316

81. Triarathen (II-29-26)

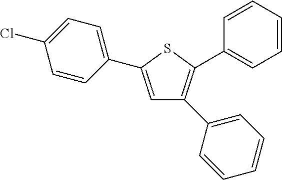

known from DE-A-2 724 494

82. Tetradifon (II-12C-2)

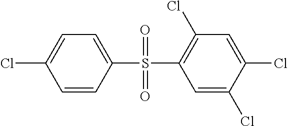

known from U.S. Pat. No. 2,812,281

83. Propargite (H-12C-1)

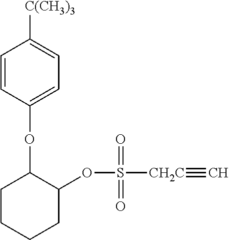

known from U.S. Pat. No. 3,272,854

84. Hexythiazox (II-10A-2)

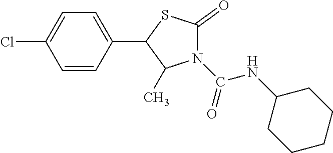

known from DE-A-3 037 105

85. Bromopropylate (II-29-4)

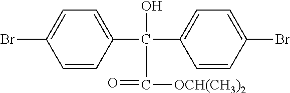

known from U.S. Pat. No. 3,784,696

86. Chinomethionat (II-29-6)

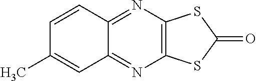

known from DE-A-1 100 372

87. Amitraz (II-19-1)

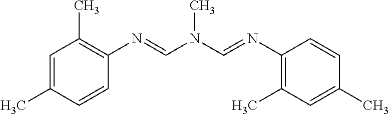

known from DE-A-2 061 132

88. Pyrifluquinazon (II-9B-2)
1-acetyl-3,4-dihydro-3-[(3-pyridinylmethyl)amino]-6-[1,2,2,2-tetrafluoro-1-(trifluoromethyl)ethyl-2(1H)-quinazolinone

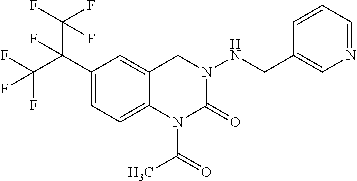

known from EP-A-01097932

89. Pymetrozine (II-9B-1)

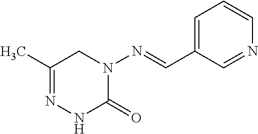

known from EP-A-314 615

90. Flonicamid (II-9C-1)

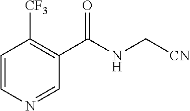

known from EP-A-00580374

91. Pyriproxyfen (II-7C-1)

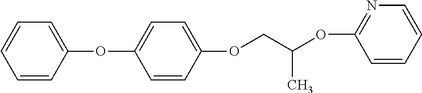

known from EP-A-128 648

92Diofenolan (II-7C-2)

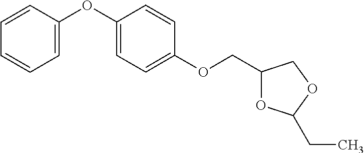

known from DE-A 2 655 910

93. Chlorfenapyr (II-13-1)

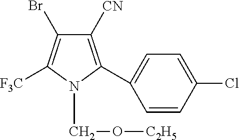

known from EP-A-347 488

94. Metaflumizone (II-22B-1)

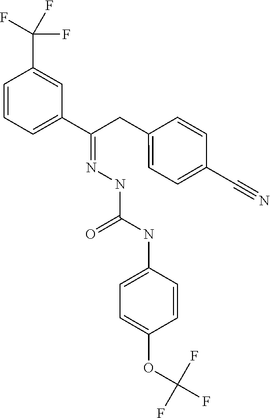

known from EP-A-00462456

95. Indoxacarb (II-22A-1)

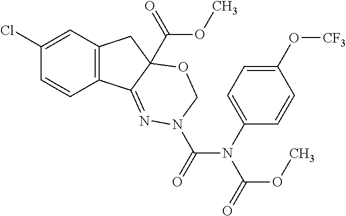

known from WO 92/11249 and also the +-enantiomer DPX-KN 128 known from ACS Symposium Series 800, p. 178

96. Chlorpyrifos (II-1B-12)

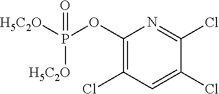

known from U.S. Pat. No. 3,244,586

97. Spirodiclofen (II-23A-1)

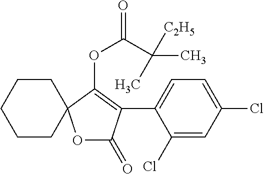

known from EP-A-528 156

98. Spiromesifen (II-23A-2)

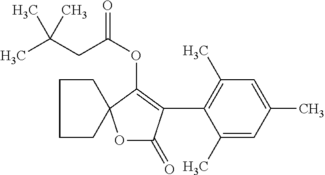

known from EP-A-528 156

99. Spirotetramat (II-23B-1)

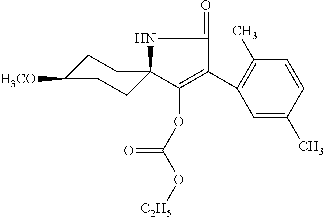

known from WO 04/007 448

99. Pyridalyl (II-29-23)

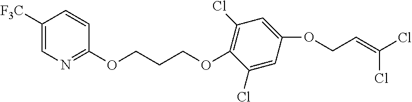

known from WO 96/11909

101. 4-{[(6-chloropyrid-3-yl)methyl](methyl)amino}furan-2(5H)-one (II-29-28)
known from EP-A-0 539 588)

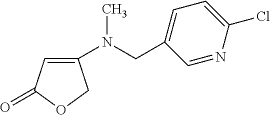

known from EP-A-0 539 588

102. 4-{[(6-chloropyrid-3-yl)methyl](2,2-difluoroethyl)amino}furan-2(5H)-one (II-29-29)
known from WO 2007/115644

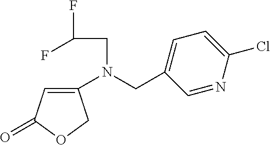

known from DE-A-102006015467

103. Spinetoram (II-5-2)

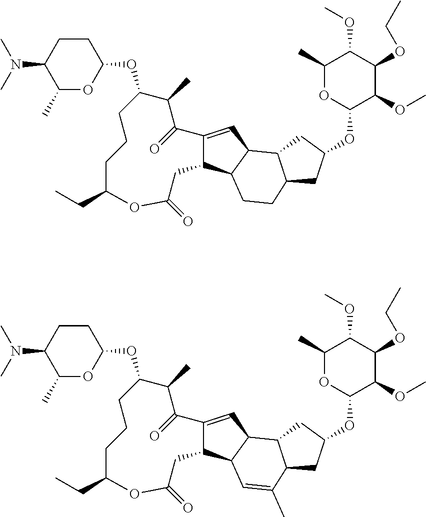

known from WO 97/00265, Crouse G D et al. Pest Management Science 57, 177-185, (2001)

104. 1-{2-fluoro-4-methyl-5-[(2,2,2-trifluoroethyl)sulphinyl]phenyl}-3-(trifluoromethyl)-1H-1,2,4-triazole-5-amine (II-29-31)

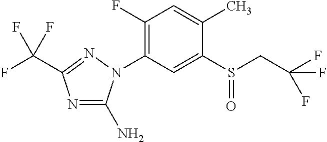

known from WO 2006/043635

105. Sulfoxaflor (II-29-32)

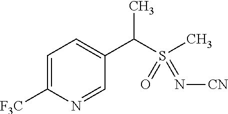

known from WO 2007/095229 A2 and WO 2007/149134.

Most preference is given to active compound combinations
comprising, as compound of the formula (I), the compound of the formula (I-1) and, as active compound of the formula (II), an active compound selected from the group consisting of abamectin, acephate, acetamiprid, AKD 1022, alpha-cypermethrin, amitraz, bifenthrin, buprofezin, chloranthraniliprole, chlorfenapyr, chlorpyrifos, clothianidin, cyazypyr, cyenopyrafen, cyflumetofen, cypermethrin, cyromazine, deltamethrin, diafenthiuron, dinotefuran, emamectin benzoate, ethiprole, fenpyroximate, fipronil, flonicamid, flubendiamid, flufenoxuron, gamma-cyhalothrin, IKA 2002, imidacloprid, imidaclothiz, indoxacarb, L-cyhalothrin, lufenuron, metaflumizone, methoxyfenozide, milbemectin, novaluron, profenofos, pymetrozine, pyridaben, pyridalyl, rynaxypyr, spinetoram, spinosad, β-cyfluthrin, sulfoxaflor, tebufenpyrad, thiacloprid, thiamethoxam, transfluthrin, triazophos, triflumuron, compound II-28-2, compound II-29-28, compound II-29-29 and compound II-29-31,
comprising, as compound of the formula (I), the compound of the formula (I-2) and, as active compound of the formula (II), an active compound selected from the group consisting of abamectin, acephate, acetamiprid, AKD 1022, alpha-cypermethrin, amitraz, bifenthrin, buprofezin, chloranthraniliprole, chlorfenapyr, chlorpyrifos, clothianidin, cyazypyr, cyenopyrafen, cyflumetofen, cypermethrin, cyromazine, deltamethrin, diafenthiuron, dinotefuran, emamectin benzoate, ethiprole, fenpyroximate, fipronil, flonicamid, flubendiamid, flufenoxuron, gamma-cyhalothrin, IKA 2002, imidacloprid, imidaclothiz, indoxacarb, L-cyhalothrin, lufenuron, metaflumizone, methoxyfenozide, milbemectin, novaluron, profenofos, pymetrozine, pyridaben, pyridalyl, rynaxypyr, spinetoram, spinosad, β-cyfluthrin, sulfoxaflor, tebufenpyrad, thiacloprid, thiamethoxam, transfluthrin, triazophos, triflumuron, compound II-28-2, compound II-29-28, compound II-29-29 and compound II-29-31,
comprising, as compound of the formula (I), the compound of the formula (I-3) and, as active compound of the formula (II), an active compound selected from the group consisting of abamectin, acephate, acetamiprid, AKD 1022, alpha-cypermethrin, amitraz, bifenthrin, buprofezin, chloranthraniliprole, chlorfenapyr, chlorpyrifos, clothianidin, cyazypyr, cyenopyrafen, cyflumetofen, cypermethrin, cyromazine, deltamethrin, diafenthiuron, dinotefuran, emamectin benzoate, ethiprole, fenpyroximate, fipronil, flonicamid, flubendiamid, flufenoxuron, gamma-cyhalothrin, IKA 2002, imidacloprid, imidaclothiz, indoxacarb, L-cyhalothrin, lufenuron, metaflumizone, methoxyfenozide, milbemectin, novaluron, profenofos, pymetrozine, pyridaben, pyridalyl, rynaxypyr, spinetoram, spinosad, β-cyfluthrin, sulfoxaflor, tebufenpyrad, thiacloprid, thiamethoxam, transfluthrin, triazophos, triflumuron, compound II-28-2, compound II-29-28, compound II-29-29 and compound II-29-31.

In addition, the active compound combinations may also comprise other fungicidally, acaricidally or insecticidally active components which may be admixed.

If the active compounds are present in the active compound combinations according to the invention in certain weight ratios, the enhanced activity becomes evident. However, the weight ratios of the active compounds in the active compound combinations can be varied within a relatively wide range. In general, the combinations according to the invention comprise active compounds of the formula (I), in particular of the formulae (I-1) to (I-6), and the co-component of the formula (II) in the preferred and particularly preferred mixing ratios indicated in the table below:

the mixing ratios are based on weight ratios. The ratio is to be understood as active compound of the formula (I-1) to formula (I-6): mixing partner

| | | | Particularly | Very particularly |
|---|---|---|---|---|
| | | Preferred mixing | preferred mixing | preferred mixing |
| | Mixing partner | ratio | ratio | ratio |
| 1. | acrinathrin | 125:1 to 1:125 | 25:1 to 1:25 | 5:1 to 1:5 |
| 2. | alpha-cypermethrin | 125:1 to 1:125 | 25:1 to 1:25 | 5:1 to 1:5 |
| 3. | betacyfluthrin | 125:1 to 1:125 | 25:1 to 1:25 | 5:1 to 1:5 |
| 4. | cyhalothrin | 125:1 to 1:125 | 25:1 to 1:25 | 5:1 to 1:5 |
| 5. | cypermethrin | 125:1 to 1:125 | 25:1 to 1:25 | 5:1 to 1:5 |
| 6. | deltamethrin | 125:1 to 1:125 | 25:1 to 1:25 | 5:1 to 1:5 |
| 7. | esfenvalerate | 125:1 to 1:125 | 25:1 to 1:25 | 5:1 to 1:5 |
| 8. | etofenprox | 125:1 to 1:125 | 25:1 to 1:25 | 5:1 to 1:5 |
| 9. | fenpropathrin | 125:1 to 1:125 | 25:1 to 1:25 | 5:1 to 1:5 |
| 10. | fenvalerate | 125:1 to 1:125 | 25:1 to 1:25 | 5:1 to 1:5 |
| 11. | flucythrinate | 125:1 to 1:125 | 25:1 to 1:25 | 5:1 to 1:5 |
| 12.a | lambda-cyhalothrin | 125:1 to 1:125 | 25:1 to 1:25 | 5:1 to 1:5 |
| 12.b | gamma-cyhalothrin | 125:1 to 1:125 | 25:1 to 1:25 | 5:1 to 1:5 |
| 13. | permethrin | 125:1 to 1:125 | 25:1 to 1:25 | 5:1 to 1:5 |
| 14. | tau-fluvalinate | 125:1 to 1:125 | 25:1 to 1:25 | 5:1 to 1:5 |
| 15. | tralomethrin | 125:1 to 1:125 | 25:1 to 1:25 | 5:1 to 1:5 |
| 16. | zeta-cypermethrin | 125:1 to 1:125 | 25:1 to 1:25 | 5:1 to 1:5 |
| 17. | cyfluthrin | 125:1 to 1:125 | 25:1 to 1:25 | 5:1 to 1:5 |
| 18. | bifenthrin | 125:1 to 1:125 | 25:1 to 1:25 | 5:1 to 1:5 |
| 19. | cycloprothrin | 125:1 to 1:125 | 25:1 to 1:25 | 5:1 to 1:5 |
| 20. | eflusilanate | 125:1 to 1:125 | 25:1 to 1:25 | 5:1 to 1:5 |
| 21. | fubfenprox | 125:1 to 1:125 | 25:1 to 1:25 | 5:1 to 1:5 |
| 22. | transfluthrin | 125:1 to 1:125 | 25:1 to 1:25 | 5:1 to 1:5 |
| 23. | pyrethrin | 125:1 to 1:125 | 25:1 to 1:25 | 5:1 to 1:5 |
| 24. | resmethrin | 125:1 to 1:125 | 25:1 to 1:25 | 5:1 to 1:5 |
| 25. | imidacloprid | 125:1 to 1:125 | 25:1 to 1:25 | 5:1 to 1:5 |
| 26. | acetamiprid | 125:1 to 1:125 | 25:1 to 1:25 | 5:1 to 1:5 |
| 27. | thiamethoxam | 125:1 to 1:125 | 25:1 to 1:25 | 5:1 to 1:5 |
| 28. | nitenpyram | 125:1 to 1:125 | 25:1 to 1:25 | 5:1 to 1:5 |
| 29. | thiacloprid | 125:1 to 1:125 | 25:1 to 1:25 | 5:1 to 1:5 |
| 30. | dinotefuran | 125:1 to 1:125 | 25:1 to 1:25 | 5:1 to 1:5 |
| 31. | clothianidin | 125:1 to 1:125 | 25:1 to 1:25 | 5:1 to 1:5 |
| 32. | imidaclothiz | 125:1 to 1:125 | 25:1 to 1:25 | 5:1 to 1:5 |
| 33. | chlorfluazuron | 125:1 to 1:125 | 25:1 to 1:25 | 5:1 to 1:5 |
| 34. | diflubenzuron | 125:1 to 1:125 | 25:1 to 1:25 | 5:1 to 1:5 |
| 35. | lufenuron | 125:1 to 1:125 | 25:1 to 1:25 | 5:1 to 1:5 |
| 36. | teflubenzuron | 125:1 to 1:125 | 25:1 to 1:25 | 5:1 to 1:5 |
| 37. | triflumuron | 125:1 to 1:125 | 25:1 to 1:25 | 5:1 to 1:5 |
| 38. | novaluron | 125:1 to 1:125 | 25:1 to 1:25 | 5:1 to 1:5 |
| 39. | flufenoxuron | 125:1 to 1:125 | 25:1 to 1:25 | 5:1 to 1:5 |
| 40. | hexaflumuron | 125:1 to 1:125 | 25:1 to 1:25 | 5:1 to 1:5 |
| 41. | bistrifluoron | 125:1 to 1:125 | 25:1 to 1:25 | 5:1 to 1:5 |
| 42. | noviflumuron | 125:1 to 1:125 | 25:1 to 1:25 | 5:1 to 1:5 |
| 43. | buprofezin | 125:1 to 1:125 | 25:1 to 1:25 | 5:1 to 1:5 |
| 44. | cyromazine | 125:1 to 1:125 | 25:1 to 1:25 | 5:1 to 1:5 |
| 45. | methoxyfenozide | 125:1 to 1:125 | 25:1 to 1:25 | 5:1 to 1:5 |
| 46. | tebufenozide | 125:1 to 1:125 | 25:1 to 1:25 | 5:1 to 1:5 |
| 47. | halofenozide | 125:1 to 1:125 | 25:1 to 1:25 | 5:1 to 1:5 |
| 48. | fufenozide (JS-118) | 125:1 to 1:125 | 25:1 to 1:25 | 5:1 to 1:5 |
| 49. | chromafenozide | 125:1 to 1:125 | 25:1 to 1:25 | 5:1 to 1:5 |
| 50. | endosulfan | 125:1 to 1:125 | 25:1 to 1:25 | 5:1 to 1:5 |
| 51. | fipronil | 125:1 to 1:125 | 25:1 to 1:25 | 5:1 to 1:5 |
| 52. | ethiprole | 125:1 to 1:125 | 25:1 to 1:25 | 5:1 to 1:5 |
| 53. | pyrafluprole | 125:1 to 1:125 | 25:1 to 1:25 | 5:1 to 1:5 |
| 54. | pyriprole | 125:1 to 1:125 | 25:1 to 1:25 | 5:1 to 1:5 |
| 55. | flubendiamide | 125:1 to 1:125 | 25:1 to 1:25 | 5:1 to 1:5 |
| 56. | compound II-28-2 | 125:1 to 1:125 | 25:1 to 1:25 | 5:1 to 1:5 |
| 57. | Rynaxapyr | 125:1 to 1:125 | 25:1 to 1:25 | 5:1 to 1:5 |
| 58. | Cyazypyr | 125:1 to 1:125 | 25:1 to 1:25 | 5:1 to 1:5 |
| 59. | emamectin | 125:1 to 1:125 | 25:1 to 1:25 | 5:1 to 1:5 |
| 60. | emamectin benzoate | 125:1 to 1:125 | 25:1 to 1:25 | 5:1 to 1:5 |
| 61. | abamectin | 125:1 to 1:125 | 25:1 to 1:25 | 5:1 to 1:5 |
| 62. | ivermectin | 125:1 to 1:125 | 25:1 to 1:25 | 5:1 to 1:5 |
| 63. | milbemectin | 125:1 to 1:125 | 25:1 to 1:25 | 5:1 to 1:5 |
| 64. | lepimectin | 125:1 to 1:125 | 25:1 to 1:25 | 5:1 to 1:5 |
| 65. | tebufenpyrad | 125:1 to 1:125 | 25:1 to 1:25 | 5:1 to 1:5 |
| 66. | fenpyroximate | 125:1 to 1:125 | 25:1 to 1:25 | 5:1 to 1:5 |
| 67. | pyridaben | 125:1 to 1:125 | 25:1 to 1:25 | 5:1 to 1:5 |
| 68. | fenazaquin | 125:1 to 1:125 | 25:1 to 1:25 | 5:1 to 1:5 |
| 69. | pyrimidifen | 125:1 to 1:125 | 25:1 to 1:25 | 5:1 to 1:5 |
| 70. | tolfenpyrad | 125:1 to 1:125 | 25:1 to 1:25 | 5:1 to 1:5 |
| 71. | dicofol | 125:1 to 1:125 | 25:1 to 1:25 | 5:1 to 1:5 |
| 72. | cyenopyrafen | 125:1 to 1:125 | 25:1 to 1:25 | 5:1 to 1:5 |
| 73. | cyflumetofen | 125:1 to 1:125 | 25:1 to 1:25 | 5:1 to 1:5 |
| 74. | acequinocyl | 125:1 to 1:125 | 25:1 to 1:25 | 5:1 to 1:5 |
| 75. | fluacrypyrin | 125:1 to 1:125 | 25:1 to 1:25 | 5:1 to 1:5 |
| 76. | bifenazate | 125:1 to 1:125 | 25:1 to 1:25 | 5:1 to 1:5 |
| 77. | diafenthiuron | 125:1 to 1:125 | 25:1 to 1:25 | 5:1 to 1:5 |
| 78. | etoxazole | 125:1 to 1:125 | 25:1 to 1:25 | 5:1 to 1:5 |
| 79. | clofentezine | 125:1 to 1:125 | 25:1 to 1:25 | 5:1 to 1:5 |
| 80. | spinosad | 125:1 to 1:125 | 25:1 to 1:25 | 5:1 to 1:5 |
| 81. | triarathen | 125:1 to 1:125 | 25:1 to 1:25 | 5:1 to 1:5 |
| 82. | tetradifon | 125:1 to 1:125 | 25:1 to 1:25 | 5:1 to 1:5 |
| 83. | propargite | 125:1 to 1:125 | 25:1 to 1:25 | 5:1 to 1:5 |
| 84. | hexythiazox | 125:1 to 1:125 | 25:1 to 1:25 | 5:1 to 1:5 |
| 85. | bromopropylate | 125:1 to 1:125 | 25:1 to 1:25 | 5:1 to 1:5 |
| 86. | chinomethionat | 125:1 to 1:125 | 25:1 to 1:25 | 5:1 to 1:5 |
| 87. | amitraz | 125:1 to 1:125 | 25:1 to 1:25 | 5:1 to 1:5 |
| 88. | pyrifluquinazon NNI 0101 | 125:1 to 1:125 | 25:1 to 1:25 | 5:1 to 1:5 |
| 89. | pymetrozine | 125:1 to 1:125 | 25:1 to 1:25 | 5:1 to 1:5 |
| 90. | flonicamid | 125:1 to 1:125 | 25:1 to 1:25 | 5:1 to 1:5 |
| 91. | pyriproxyfen | 125:1 to 1:125 | 25:1 to 1:25 | 5:1 to 1:5 |
| 92. | diofenolan | 125:1 to 1:125 | 25:1 to 1:25 | 5:1 to 1:5 |
| 93. | chlorfenapyr | 125:1 to 1:125 | 25:1 to 1:25 | 5:1 to 1:5 |
| 94. | metaflumizone | 125:1 to 1:125 | 25:1 to 1:25 | 5:1 to 1:5 |
| 95. | indoxacarb | 125:1 to 1:125 | 25:1 to 1:25 | 5:1 to 1:5 |
| 96. | chlorpyrifos | 125:1 to 1:125 | 25:1 to 1:25 | 5:1 to 1:5 |
| 97. | spirodiclofen | 125:1 to 1:125 | 25:1 to 1:25 | 5:1 to 1:5 |
| 98. | spiromesifen | 125:1 to 1:125 | 25:1 to 1:25 | 5:1 to 1:5 |
| 99. | spirotetramat | 125:1 to 1:125 | 25:1 to 1:25 | 5:1 to 1:5 |
| 100. | pyridalyl | 125:1 to 1:125 | 25:1 to 1:25 | 5:1 to 1:5 |
| 101. | compound II-29-28 | 125:1 to 1:125 | 25:1 to 1:25 | 5:1 to 1:5 |
| 102. | compound II-29-29 | 125:1 to 1:125 | 25:1 to 1:25 | 5:1 to 1:5 |
| 103. | spinetoram | 125:1 to 1:125 | 25:1 to 1:25 | 5:1 to 1:5 |
| 104. | compound II-29-31 | 125:1 to 1:125 | 25:1 to 1:25 | 5:1 to 1:5 |
| 105. | sulfoxaflor | 125:1 to 1:125 | 25:1 to 1:25 | 5:1 to 1:5 |

The active compound combinations according to the invention are suitable for controlling animal pests, preferably arthropods and nematodes, in particular insects and arachnids found in viticulture, the cultivation of fruit, agriculture, in animal health, in forests, in the protection of stored products and materials and in, the hygiene sector. They are active against normally sensitive and resistant species and also against all or some stages of development. The abovementioned pests include:

From the order of the Anoplura (Phthiraptera), for example, Damalinia spp., Haematopinus spp., Linognathus spp., Pediculus spp., Trichodectes spp.

From the class of the Arachnida, for example, Acarus siro, Aceria sheldoni, Aculops spp., Aculus spp., Amblyomma spp., Argas spp., Boophilus spp., Brevipalpus spp., Bryobia praetiosa, Chorioptes spp., Dermanyssus gallinae, Eotetranychus spp., Epitrimerus pyri, Eutetranychus spp., Eriophyes spp., Hemitarsonemus spp., Hyalomma spp., Ixodes spp., Latrodectus mactans, Metatetranychus spp., Oligonychus spp., Ornithodoros spp., Panonychus spp., Phyllocoptruta oleivora, Polyphagotarsonemus latus, Psoroptes spp., Rhipicephalus spp., Rhizoglyphus spp., Sarcoptes spp., Scorpio maurus, Stenotarsonemus spp., Tarsonemus spp., Tetranychus spp., Vasates lycopersici.

From the class of the Bivalva, for example, Dreissena spp.

From the order of the Chilopoda, for example, Geophilus spp., Scutigera spp.

From the order of the Coleoptera, for example, Acanthoscelides obtectus, Adoretus spp., Agelastica alni, Agriotes spp., Amphimallon solstitialis, Anobium punctatum, Anoplophora spp., Anthonomus spp., Anthrenus spp., Apogonia spp., Atomaria spp., Attagenus spp., Bruchidius obtectus, Bruchus spp., Ceuthorhynchus spp., Cleonus mendicus, Conoderus spp., Cosmopolites spp., Costelytra zealandica, Curculio spp., Cryptorhynchus lapathi, Dermestes spp., Diabrotica spp., Epilachna spp., Faustinus cubae, Gibbium psylloides, Heteronychus arator, Hylamorpha elegans, Hylotrupes bajulus, Hypera postica, Hypothenemus spp., Lachnosterna consanguinea, Leptinotarsa decemlineata, Lissorhoptrus oryzophilus, Lixus spp., Lyctus spp., Meligethes aeneus, Melolontha melolontha, Migdolus spp., Monochamus spp., Naupactus xanthographus, Niptus hololeucus, Oryctes rhinoceros, Oryzaephilus surinamensis, Otiorrhynchus sulcatus, Oxycetonia jucunda, Phaedon cochleariae, Phyllophaga spp., Popillia japonica, Premnotrypes spp., Psylliodes chrysocephala, Ptinus spp., Rhizobius ventralis, Rhizopertha dominica, Sitophilus spp., Sphenophorus spp., Sternechus spp., Symphyletes spp., Tenebrio molitor, Tribolium spp., Trogoderma spp., Tychius spp., Xylotrechus spp., Zabrus spp.

From the order of the Collembola, for example, Onychiurus armatus.

From the order of the Dermaptera, for example, Forficula auricularia.

From the order of the Diplopoda, for example, Blaniulus guttulatus.

From the order of the Diptera; for example, Aedes spp., Anopheles spp., Bibio hortulanus, Calliphora erythrocephala, Ceratitis capitata, Chrysomyia spp., Cochliomyia spp., Cordylobia anthropophaga, Culex spp., Cuterebra spp., Dacus oleae, Dermatobia hominis, Drosophila spp., Fannia spp., Gastrophilus spp., Hylemyia spp., Hyppobosca spp., Hypoderma spp., Liriomyza spp. Lucilia spp., Musca spp., Nezara spp., Oestrus spp., Oscinella frit, Pegomyia hyoscyami, Phorbia spp., Stomoxys spp., Tabanus spp., Tannia spp., Tipula paludosa, Wohlfahrtia spp.

From the class of the Gastropoda, for example, Arion spp., Biomphalaria spp., Bulinus spp., Deroceras spp., Galba spp., Lymnaea spp., Oncomelania spp., Succinea spp.

From the class of the helminths, for example, Ancylostoma duodenale, Ancylostoma ceylanicum, Acylostoma braziliensis, Ancylostoma spp., Ascaris lubricoides, Ascaris spp., Brugia malayi, Brugia timori, Bunostomum spp., Chabertia spp., Clonorchis spp., Cooperia spp., Dicrocoelium spp., Dictyocaulus filaria, Diphyllobothrium latum, Dracunculus inedinensis, Echinococcus granulosus, Echinococcus multilocularis, Enterobius vermicularis, Faciola spp., Haemonchus spp., Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercoralis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichuria, Wuchereria bancrofti.

It is furthermore possible to control protozoa, such as Eimeria.

From the order of the Heteroptera, for example, Anasa tristis, Antestiopsis spp., Blissus spp., Calocoris spp., Campylomma livida, Cavelerius spp., Cimex spp., Creontiades dilutus, Dasynus piperis, Dichelops furcatus, Diconocoris hewetti, Dysdercus spp., Euschistus spp., Eurygaster spp., Heliopeltis spp., Horcias nobilellus, Leptocorisa spp., Leptoglossus phyllopus, Lygus spp., Macropes excavatus, Miridae, Nezara spp., Oebalus spp., Pentomidae, Piesma quadrata, Piezodorus spp., Psallus seriatus, Pseudacysta persea, Rhodnius spp., Sahlbergella singularis, Scotinophora spp., Stephanitis nashi, Tibraca spp., Triatoma spp.

From the order of the Homoptera, for example, Acyrthosipon spp., Aeneolamia spp., Agonoscena spp., Aleurodes spp., Aleurolobus barodensis, Aleurothrixus spp., Amrasca spp., Anuraphis cardui, Aonidiella spp., Aphanostigma piri, Aphis spp., Arboridia apicalis, Aspidiella spp., Aspidiotus spp., Atanus spp., Aulacorthum solani, Bemisia spp., Brachycaudus helichrysii, Brachycolus spp., Brevicoryne brassicae, Calligypona marginata, Carneocephala fulgida, Ceratovacuna lanigera, Cercopidae, Ceroplastes spp., Chaetosiphon fragaefolii, Chionaspis tegalensis, Chlorita onukii, Chromaphis juglandicola, Chrysomphalus ficus, Cicadulina mbila, Coccomytilus halli, Coccus spp., Cryptomyzus ribis, Dalbulus spp., Dialeurodes spp., Diaphorina spp., Diaspis spp., Doralis spp., Drosicha spp., Dysaphis spp., Dysmicoccus spp., Empoasca spp., Eriosoma spp., Erythroneura spp., Euscelis bilobatus, Geococcus coffeae, Homalodisca coagulata, Hyalopterus arundinis, Icerya spp., Idiocerus spp., Idioscopus spp., Laodelphax striatellus, Lecanium spp., Lepidosaphes spp., Lipaphis erysimi, Macrosiphum spp., Mahanarva fimbriolata, Melanaphis sacchari, Metcalfiella spp., Metopolophium dirhodum, Monellia costalis, Monelliopsis pecanis, Myzus spp., Nasonovia ribisnigri, Nephotettix spp., Nilaparvata lugens, Oncometopia spp., Orthezia praelonga, Parabemisia myricae, Paratrioza spp., Parlatoria spp., Pemphigus spp., Peregrinus maidis, Phenacoccus spp., Phloeomyzus passerinii, Phorodon humuli, Phylloxera spp., Pinnaspis aspidistrae, Planococcus spp., Protopulvinaria pyriformis, Pseudaulacaspis pentagona, Pseudococcus spp., Psylla spp., Pteromalus spp., Pyrilla spp., Quadraspidiotus spp., Quesada gigas, Rastrococcus spp., Rhopalosiphum spp., Saissetia spp., Scaphoides titanus, Schizaphis graminum, Selenaspidus articulatus, Sogata spp., Sogatella furcifera, Sogatodes spp., Stictocephala festina, Tenalaphara malayensis, Tinocallis caryaefoliae, Tomaspis spp., Toxoptera spp., Trialeurodes vaporariorum, Trioza spp., Typhlocyba spp., Unaspis spp., Viteus vitifolii.

From the order of the Hymenoptera, for example, Diprion spp., Hoplocampa spp., Lasius spp., Monomorium pharaonis and Vespa spp.

From the order of the Isopoda, for example, Armadillidium vulgare, Oniscus asellus and Porcellio scaber.

From the order of the Isoptera, for example, Reticulitermes spp. and Odontotermes spp.

From the order of the Lepidoptera, for example, Acronicta major, Aedia leucomelas, Agrotis spp., Alabama argillacea, Anticarsia spp., Barathra brassicae, Bucculatrix thurberiella, Bupalus piniarius, Cacoecia podana, Capua reticulana, Carpocapsa pomonella, Cheimatobia brumata, Chilo spp., Choristoneura fumiferana, Clysia ambiguella, Cnaphalocerus spp., Earias insulana, Ephestia kuehniella, Euproctis chrysorrhoea, Euxoa spp., Feltia spp., Galleria mellonella, Helicoverpa spp., Heliothis spp., Hofmannophila pseudospretella, Homona magnanima, Hyponomeuta padella, Laphygma spp., Lithocolletis blancardella, Lithophane antennata, Loxagrotis albicosta, Lymantria spp., Malacosoma neustria, Mamestra brassicae, Mocis repanda, Mythimna separata, Oria spp., Oulema oryzae, Panolis flammea, Pectinophora gossypiella, Phyllocnistis citrella, Pieris spp., Plutella xylostella, Prodenia spp., Pseudaletia spp., Pseudoplusia includens, Pyrausta nubilalis, Spodoptera spp., Thermesia gemmatalis, Tinea pellionella, Tineola bisselliella, Tortrix viridana, Trichoplusia spp.

From the order of the Orthoptera, for example, Acheta domesticus, Blatta orientalis, Blattella germanica, Gryllotalpa spp., Leucophaea maderae, Locusta spp., Melanoplus spp., Periplaneta americana, Schistocerca gregaria.

From the order of the Siphonaptera, for example, Ceratophyllus spp. and Xenopsylla cheopis.

From the order of the Symphyla, for example, Scutigerella immaculata.

From the order of the Thysanoptera, for example, Baliothrips biformis, Enneothrips flavens, Frankliniella spp., Heliothrips spp., Hercinothrips femoralis, Kakothrips spp., Rhipiphorothrips cruentatus, Scirtothrips spp., Taeniothrips cardamoni and Thrips spp.

From the order of the Thysanura, for example, Lepisma saccharina.

The phytoparasitic nematodes include, for example, Anguina spp., Aphelenchoides spp., Belonoaimus spp., Bursaphelenchus spp., Ditylenchus dipsaci, Globodera spp., Heliocotylenchus spp., Heterodera spp., Longidorus spp., Meloidogyne spp., Pratylenchus spp., Radopholus similis, Rotylenchus spp., Trichodorus spp., Tylenchorhynchus spp., Tylenchulus spp., Tylenchulus semipenetrans and Xiphinema spp.

The active compound combinations can be converted into the customary formulations such as solutions, emulsions, wettable powders, suspensions, powders, dusts, pastes, soluble powders, granules, suspension-emulsion concentrates, natural and synthetic materials impregnated with active compound, and microencapsulations in polymeric materials.

These formulations are produced in a known manner, for example by mixing the active compounds with extenders, that is, liquid solvents and/or solid carriers, optionally with the use of surfactants, that is to say emulsifiers and/or dispersants and/or foam-formers.

If the extender used is water, it is also possible to employ, for example, organic solvents as auxiliary solvents. Essentially, suitable liquid solvents are: aromatics such as xylene, toluene or alkylnaphthalenes, chlorinated aromatics and chlorinated aliphatic hydrocarbons such as chlorobenzenes, chloroethylenes or methylene chloride, aliphatic hydrocarbons such as cyclohexane or paraffins, for example mineral oil fractions, mineral and vegetable oils, alcohols such as butanol or glycol and their ethers and esters, ketones such as acetone, methyl ethyl ketone, methyl isobutyl ketone or cyclohexanone, strongly polar solvents such as dimethylformamide and dimethyl sulphoxide, or else water.

Suitable solid carriers are:

for example ammonium salts and ground natural minerals such as kaolins, clays, talc, chalk, quartz, attapulgite, montmorillonite or diatomaceous earth, and ground synthetic materials such as highly disperse silica, alumina and silicates; suitable solid carriers for granules are: for example crushed and fractionated natural rocks such as calcite, marble, pumice, sepiolite and dolomite, or else synthetic granules of inorganic and organic meals, and granules of organic material such as sawdust, coconut shells, maize cobs and tobacco stalks; suitable emulsifiers and/or foam-formers are: for example nonionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates and also protein hydrolysates; as dispersants there are suitable: for example lignosulphite waste liquors and methylcellulose.

Tackifiers such as carboxymethylcellulose and natural and synthetic polymers in the form of powders, granules or latices, such as gum arabic, polyvinyl alcohol and polyvinyl acetate, as well as natural phospholipids such as cephalins and lecithins, and synthetic phospholipids, can be used in the formulations. Other possible additives are mineral and vegetable oils.

It is possible to use colorants such as inorganic pigments, for example iron oxide, titanium oxide and Prussian Blue, and organic colorants such as alizarin colorants, azo colorants and metal phthalocyanine colorants, and trace nutrients such as salts of iron, manganese, boron, copper, cobalt, molybdenum and zinc.

The formulations generally comprise between 0.1 and 95% by weight of active compound, preferably between 0.5 and 90%.

The active compound combinations according to the invention can be present in their commercially available formulations and in the use forms, prepared from these formulations, as a mixture with other active compounds, such as insecticides, attractants, sterilants, bactericides, acaricides, nematicides, fungicides, growth-regulating substances or herbicides. The insecticides include, for example, phosphoric acid esters, carbamates, carboxylates, chlorinated hydrocarbons, phenylureas and substances produced by microorganisms, inter alia.

A mixture with other known active compounds, such as herbicides, or with fertilizers and growth regulators, is also possible.

When used as insecticides, the active compound combinations according to the invention can furthermore be present in their commercially available formulations and in the use forms, prepared from these formulations, as a mixture with synergists. Synergists are compounds which increase the action of the active compounds, without it being necessary for the synergists added to be active itself.

The active compound content of the use forms prepared from the commercially available formulations can vary within wide limits. The active compound concentration of the use forms can be from 0.0000001 to 95% by weight of active compound, preferably between 0.0001 and 1% by weight.

Application is in a customary manner appropriate for the use forms.

All plants and plant parts can be treated in accordance with the invention. By plants are understood here all plants and plant populations such as desired and undesired wild plants or crop plants (including naturally occurring crop plants). Crop plants can be plants which can be obtained by conventional breeding and optimization methods or by biotechnological and genetic engineering methods or combinations of these methods, including the transgenic plants and including the plant varieties which can or cannot be protected by varietal property rights. Examples which may be mentioned are the important crop plants, such as cereals (wheat, rice), maize, soya beans, potatoes, sugar beet, tomatoes, peas and other vegetable species, cotton, tobacco, oilseed rape and also fruit plants (with the fruits apples, pears, citrus fruits and grapes). Plant parts are to be understood as meaning all above-ground and below-ground parts and organs of plants, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offsets and seeds.

Treatment according to the invention of the plants and plant parts with the active compound combinations is carried out directly or by allowing the combinations to act on the surroundings, environment or storage space by the customary treatment methods, for example by immersion, spraying, evaporation, fogging, scattering, painting on and, in the case of propagation material, in particular in the case of seeds, also by applying one or more coats.

As already mentioned above, it is possible to treat all plants and their parts according to the invention. In a preferred embodiment, wild plant species and plant cultivars, or those obtained by conventional biological breeding methods, such as crossing or protoplast fusion, and also parts thereof, are treated. In a further preferred embodiment, transgenic plants and plant cultivars obtained by genetical engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention.

Depending on the plant species or plant cultivars, their location and growth conditions (soils, climate, vegetation period, nutrition), the treatment according to the invention may also result in superadditive (“synergistic”) effects. Thus possible are, for example, reduced application rates and/or a widening of the activity spectrum and/or an increase of the activity of the compounds and compositions usable according to the invention, better plant growth, increased tolerance to high or low temperatures, increased tolerance to drought or to water or soil salt content, increased flowering, easier harvesting, accelerated maturation, higher harvest yields, higher quality and/or higher nutritional value of the harvested products, increased storability and/or processability of the harvested products, which exceed the effects normally to be expected.

The preferred transgenic plants or plant cultivars (i.e. those obtained by genetic engineering) which are to be treated according to the invention include all plants which, in the genetic modification, received genetic material which imparts particular advantageous useful properties (“traits”) to these plants. Examples of such properties are better plant growth, increased tolerance to high or low temperatures, increased tolerance to drought or to water or soil salt content, increased flowering, easier harvesting, accelerated maturation, higher harvest yields, higher quality and/or a higher nutritional value of the harvested products, better storability and/or processability of the harvested products. Further and particularly emphasized examples of such properties are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, oilseed rape and also fruit plants (with the fruits apples, pears, citrus fruits and grapes), and particular emphasis is given to maize, soya beans, potatoes, cotton and oilseed rape. Traits that are emphasized are in particular increased defence of the plants against insects by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c Cry2Ab, Cry3Bb and CryIF and also combinations thereof) (hereinbelow referred to as “Bt plants”). Traits that are furthermore particularly emphasized are the increased tolerance of the plants to certain herbicidally active compounds, for example imidazolinones, sulphonylureas, glyphosate or phosphinothricin (for example the “PAT” gene). The genes which impart the desired traits in question can also be present in combinations with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinothricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plants will be developed and/or marketed in the future.

The plants listed can be treated according to the invention in a particularly advantageous manner with the active compound mixture according to the invention. The preferred ranges stated above for the mixtures also apply to the treatment of these plants. Particular emphasis is given to the treatment of plants with the mixtures specifically mentioned in the present text.

The good insecticidal and acaricidal action of the active compound combinations according to the invention can be seen from the examples which follow. While the individual active compounds show weaknesses in their action, the combinations show an action which exceeds a simple sum of actions.

A synergistic effect in insecticides and acaricides is always present when the action of the active compound combinations exceeds the total of the actions of the active compounds when applied individually.

### BIOLOGICAL EXAMPLES

The expected action for a given combination of two active compounds can be calculated as follows, using the formula of S. R. Colby, Weeds 15 (1967), 20-22:
If
X is the kill rate, expressed as % of the untreated control, when employing active compound A at an application rate of m g/ha or in a concentration of in ppm,
Y is the kill rate, expressed as % of the untreated control, when employing active compound B at an application rate of n g/ha or in a concentration of n ppm and
E is the kill rate, expressed as % of the untreated control, when employing active compounds A and B at application rates of m and n g/ha or in a concentration of m and n ppm,
then

$$E = X + Y - \frac{X \cdot Y}{100}$$

If the actual kill rate exceeds the calculated value, the action of the combination is superadditive, i.e. a synergistic effect is present. In this case, the actually observed kill rate must exceed the value calculated using the above formula for the expected kill rate (E).

### Example A

### Myzus persicae test

Solvent: 78 parts by weight of acetone
1.5 parts by weight of dimethylformamide

Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Cabbage leaves (Brassica oleracea) which are heavily infested by the green peach aphid (Myzus persicae) are treated by spraying with the active compound preparation of the desired concentration.

After the desired period of time, the kill in % is determined. 100% means that all of the aphids have been killed; 0% means that none of the aphids have been killed. The kill rates determined are entered into Colby's formula.

In this test, for example, the following active compound combinations in accordance with the present application showed a synergistically enhanced activity compared to the active compounds applied individually:

TABLE A-1
Myzus persicae test

| | Concentration | | |
|---|---|---|---|
| Active compound | in g/ha | Kill in % after 1^{d} | |
| compound of the formula (I-2) | 500 | 0 | |
| | 100 | 0 | |
| | 20 | 0 | |
| | 4 | 0 | |
| compound of the formula (I-3) | 500 | 0 | |
| | 100 | 0 | |
| | 20 | 0 | |
| | 4 | 0 | |
| imidacloprid | 0.16 | 0 | |
| | | found* | calc.** |
| compound of the formula (I-2) + | 4 + 0.16 | 90 | 0 |
| imidacloprid (25:1) | | | |
| according to the invention | | | |
| thiacloprid | 0.16 | 0 | |
| | | found* | calc.** |
| compound of the formula (I-2) + | 4 + 0.16 | 70 | 0 |
| thiacloprid (25:1) | | | |
| according to the invention | | | |
| | | found* | calc.** |
| compound of the formula (I-3) + | 4 + 0.16 | 70 | 0 |
| thiacloprid (25:1) | | | |
| according to the invention | | | |
| thiamethoxam | 0.16 | 0 | |
| | | found* | calc.** |
| compound of the formula (I-2) + | 4 + 0.16 | 80 | 0 |
| thiamethoxam (25:1) | | | |
| according to the invention | | | |
| dinotefuran | 4 | 0 | |
| | | found* | calc.** |
| compound of the formula (I-2) + | 20 + 4 | 70 | 0 |
| Dinotefuran (5:1) | | | |
| according to the invention | | | |
| abamectin | 0.16 | 0 | |
| | | found* | calc.** |
| compound of the formula (I-2) + | 20 + 0.16 | 70 | 0 |
| abamectin (125:1) | | | |
| according to the invention | | | |
| emamectin benzoate | 0.8 | 0 | |
| | | found* | calc.** |
| compound of the formula (I-3) + | 100 + 0.8 | 80 | 0 |
| emamectin benzoate (125:1) | | | |
| according to the invention | | | |
| Cyazypyr | 0.8 | 0 | |
| | | found* | calc.** |
| Compound of the formula (I-2) + | 20 + 0.8 | 80 | 0 |
| Cyazypyr (25:1) | | | |
| according to the invention | | | |
| | | found* | calc.** |
| compound of the formula (I-3) + | 20 + 0.8 | 80 | 0 |
| Cyazypyr (25:1) | | | |
| according to the invention | | | |
| thiodicarb | 100 | 0 | |
| | | found* | calc.** |
| compound of the formula (I-2) + | 500 + 100 | 80 | 0 |
| thiodicarb (5:1) | | | |
| according to the invention | | | |
| L-cyhalothrin | 0.032 | 0 | |
| | | found* | calc.** |
| compound of the formula (I-2) + | 4 + 0.032 | 90 | 0 |
| L-cyhalothrin (125:1) | | | |
| according to the invention | | | |
| cypermethrin | 0.8 | 70 | |
| | 0.16 | 0 | |
| | | found* | calc.** |
| compound of the formula (I-2) + | 4 + 0.16 | 80 | 0 |
| cypermethrin (25:1) | | | |
| according to the invention | | | |
| | | found* | calc.** |
| compound of the formula (I-3) + | 20 + 0.8 | 90 | 70 |
| cypermethrin (25:1) | | | |
| according to the invention | | | |
| β-cyfluthrin | 0.032 | 0 | |
| | | found* | calc.** |
| compound of the formula (I-3) + | 4 + 0.032 | 70 | 0 |
| β-cyfluthrin (125:1) | | | |
| according to the invention | | | |
| deltamethrin | 0.032 | 70 | |
| | | found* | calc.** |
| compound of the formula (I-2) + | 4 + 0.032 | 90 | 70 |
| deltamethrin (125:1) | | | |
| according to the invention | | | |
| 4-{[(6-chloropyrid-3- | 4 | 70 | |
| yl)methyl](2,2-difluoro- | | | |
| ethyl)amino}furan-2(5H)-one | | | |
| | | found* | calc.** |
| compound of the formula (I-3), 4- | 100 + 4 | 90 | 70 |
| {[(6-chloropyrid-3-yl)methyl](2,2- | | | |
| difluoroethyl)amino}furan-2(5H)- | | | |
| one (25:1) | | | |
| according to the invention | | | |
| ethiprole | 20 | 0 | |
| | | found* | calc.** |
| compound of the formula (I-2) + | 500 + 20 | 90 | 0 |
| ethiprole (25:1) | | | |
| according to the invention | | | |
| | | found* | calc.** |
| compound of the formula (I-3) + | 500 + 20 | 90 | 0 |
| ethiprole (25:1) | | | |
| according to the invention | | | |
| chloranthraniliprole | 0.8 | 0 | |
| | | found* | calc.** |
| compound of the formula (I-3) + | 100 + 0.8 | 80 | 0 |
| chloranthraniliprole (125:1) | | | |
| according to the invention | | | |
| diafenthiuron | 20 | 0 | |
| | | found* | calc.** |
| compound of the formula (I-2) + | 100 + 20 | 70 | 0 |
| diafenthiuron (5:1) | | | |
| according to the invention | | | |
| | | found* | calc.** |
| compound of the formula (I-3) + | 100 + 20 | 70 | 0 |
| diafenthiuron (5:1) | | | |
| according to the invention | | | |
| tebufenpyrad | 20 | 0 | |
| | | found* | calc.** |
| compound of the formula (I-2) + | 100 + 20 | 70 | 0 |
| tebufenpyrad (5:1) | | | |
| according to the invention | | | |
| gamma-cyhalothrin | 0.032 | 0 | |
| | | found* | calc.** |
| compound of the formula (I-2) + | 4 + 0.032 | 80 | 0 |
| gamma-cyhalothrin (125:1) | | | |
| according to the invention | | | |
| | | found* | calc.** |
| compound of the formula (I-3) + | 4 + 0.032 | 90 | 0 |
| gamma-cyhalothrin (125:1) | | | |
| according to the invention | | | |
| alpha-cypermethrin | 0.16 | 0 | |
| | | found* | calc.** |
| compound of the formula (I-3) + | 20 + 0.16 | 80 | 0 |
| alpha-cypermethrin (125:1) | | | |
| according to the invention | | | |
| tefluthrin | 4 | 70 | |
| | | found* | calc.** |
| compound of the formula (I-2) + | 100 + 4 | 100 | 70 |
| tefluthrin (25:1) | | | |
| according to the invention | | | |
| | | found* | calc.** |
| compound of the formula (I-3) + | 100 + 4 | 100 | 70 |
| tefluthrin (25:1) | | | |
| according to the invention | | | |

*found = activity found
**calc. = activity calculated using Colby's formula

TABLE A-2
Myzus persicae test

| | | |
|---|---|---|
| | Concentration | Kill |
| Active compound | in g/ha | in % after 6^{d} |

| | | |
|---|---|---|
| compound of the formula (I-3) | 20 | 70 |
| | 4 | 70 |
| thiacloprid | 0.16 | 0 |

| | | found* | calc.** |
|---|---|---|---|
| compound of the formula (I-3) + | 4 + 0.16 | 100 | 70 |
| thiacloprid (25:1) | | | |
| according to the invention | | | |
| thiamethoxam | 0.16 | 0 | |
| | | found* | calc.** |
| compound of the formula (I-3) + | 4 + 0.16 | 100 | 70 |
| thiamethoxam (25:1) | | | |
| according to the invention | | | |
| acetamiprid | 0.16 | 0 | |
| | | found* | calc.** |
| compound of the formula (I-3) + | 4 + 0.16 | 100 | 70 |
| acetamiprid (25:1) | | | |
| according to the invention | | | |
| dinotefuran | 4 | 0 | |
| | | found* | calc.** |
| compound of the formula (I-3) + | 20 + 4 | 100 | 70 |
| dinotefuran (5:1) | | | |
| according to the invention | | | |
| flubendiamide | 0.8 | 0 | |
| | | found* | calc.** |
| compound of the formula (I-3) + | 20 + 0.8 | 100 | 70 |
| flubendiamide (25:1) | | | |
| according to the invention | | | |
| metaflumizone | 4 | 0 | |
| | | found* | calc.** |
| compound of the formula (I-3) + | 20 + 4 | 100 | 70 |
| metaflumizone (5:1) | | | |
| according to the invention | | | |
| spirotetramat | 0.16 | 0 | |
| | | found* | calc.** |
| compound of the formula (I-3) + | 4 + 0.16 | 100 | 70 |
| spirotetramat (25:1) | | | |
| according to the invention | | | |
| spiromesifen | 0.8 | 0 | |
| | | found* | calc.** |
| compound of the formula (I-3) + | 20 + 0.8 | 100 | 70 |
| spiromesifen (25:1) | | | |
| according to the invention | | | |
| spirodiclofen | 4 | 0 | |
| | | found* | calc.** |
| compound of the formula (I-3) + | 20 + 4 | 100 | 70 |
| spirodiclofen (5:1) | | | |
| according to the invention | | | |
| abamectin | 0.16 | 0 | |
| | | found* | calc.** |
| compound of the formula (I-3) + | 20 + 0.16 | 90 | 70 |
| abamectin (125:1) | | | |
| according to the invention | | | |
| emamectin benzoate | 0.16 | 0 | |
| | | found* | calc.** |
| compound of the formula (I-3) + | 20 + 0.16 | 100 | 70 |
| emamectin benzoate (125:1) | | | |
| according to the invention | | | |
| pyridalyl | 0.8 | 0 | |
| | | found* | calc.** |
| compound of the formula (I-3) + | 20 + 0.8 | 100 | 70 |
| pyridalyl (25:1) | | | |
| according to the invention | | | |
| buprofezin | 500 | 0 | |
| | | found* | calc.** |
| compound of the formula (I-3) + | 20 + 500 | 100 | 70 |
| buprofezin (1:25) | | | |
| according to the invention | | | |

*found = activity found
**calc. = activity calculated using Colby's formula

### Example B

### Phaedon Cochleariae Larvae Test

Solvent: 78 parts by weight of acetone
1.5 parts by weight of dimethylformamide

Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Cabbage leaves (Brassica oleracea) are treated by spraying with the active compound preparation of the desired concentration and populated with larvae of the mustard beetle (Phaedon cochleariae) while the leaves are still moist.

After the desired period of time, the kill in % is determined. 100% means that all beetle larvae have been killed; 0% means that none of the beetle larvae have been killed. The kill rates determined are entered into Colby's formula.

In this test, the following active compound combinations in accordance with the present application showed a synergistically enhanced activity compared to the active compounds applied individually:

TABLE B-1
Phaedon cochleariae larvae test

| | Concentration | Kill | |
|---|---|---|---|
| Active compound | in g/ha | in % after 2^{d} | |
| compound of the formula (I-2) | 500 | 0 | |
| | 100 | 0 | |
| | 20 | 0 | |
| | 4 | 0 | |
| compound of the formula (I-3) | 500 | 0 | |
| | 100 | 0 | |
| | 20 | 0 | |
| | 4 | 0 | |
| dinotefuran | 20 | 17 | |
| | | found* | calc.** |
| compound of the formula (I-2) + | 100 + 20 | 67 | 17 |
| dinotefuran (5:1) | | | |
| according to the invention | | | |
| emamectin benzoate | 0.8 | 50 | |
| | | found* | calc.** |
| compound of the formula (I-2) + | 100 + 0.8 | 83 | 50 |
| emamectin benzoate (125:1) | | | |
| according to the invention | | | |
| compound of the formula (I-3) + | 100 + 0.8 | 83 | 50 |
| emamectin benzoate (125:1) | | | |
| according to the invention | | | |
| Cyazypyr | 0.8 | 50 | |
| | | found* | calc.** |
| compound of the formula (I-3) + | 20 + 0.8 | 83 | 50 |
| Cyazypyr (25:1) | | | |
| according to the invention | | | |
| methiocarb | 100 | 50 | |
| | | found* | calc.** |
| compound of the formula (I-2) + | 500 + 100 | 100 | 50 |
| methiocarb (5:1) | | | |
| according to the invention | | | |
| compound of the formula (I-3) + | 500 + 100 | 100 | 50 |
| methiocarb (5:1) | | | |
| according to the invention | | | |
| cypermethrin | 4 | 17 | |
| | | found* | calc.** |
| compound of the formula (I-2) + | 100 + 4 | 67 | 17 |
| cypermethrin (25:1) | | | |
| according to the invention | | | |
| deltamethrin | 0.8 | 67 | |
| | | found* | calc.** |
| compound of the formula (I-2) + | 100 + 0.8 | 100 | 67 |
| deltamethrin (125:1) | | | |
| according to the invention | | | |
| spinosad | 4 | 33 | |
| | | found* | calc.** |
| compound of the formula (I-2) + | 100 + 4 | 83 | 33 |
| spinosad (25:1) | | | |
| according to the invention | | | |
| fipronil | 0.8 | 50 | |
| | | found* | calc.** |
| compound of the formula (I-3) + | 4 + 0.8 | 100 | 50 |
| fipronil (5:1) | | | |
| according to the invention | | | |
| Rynaxypyr | 0.8 | 67 | |
| | | found* | calc.** |
| compound of the formula (I-3) + | 100 + 0.8 | 100 | 67 |
| Rynaxypyr (125:1) | | | |
| according to the invention | | | |
| spinetoram | 4 | 50 | |
| | | found* | calc.** |
| compound of the formula (I-3) + | 500 + 4 | 100 | 50 |
| spinetoram (125:1) | | | |
| according to the invention | | | |
| fenpyroximate | 20 | 0 | |
| | | found* | calc.** |
| compound of the formula (I-2) + | 500 + 20 | 80 | 0 |
| fenpyroximate (25:1) | | | |
| according to the invention | | | |

*found = activity found
**calc. = activity calculated using Colby's formula

TABLE B-2
Phaedon cochleariae larvae test

| | Concentration | Kill | |
|---|---|---|---|
| Active compound | in g/ha | in % after 6^{d} | |
| compound of the formula (I-2) | 500 | 0 | |
| | 100 | 0 | |
| | 20 | 0 | |
| | 4 | 0 | |
| compound of the formula (I-3) | 500 | 0 | |
| | 100 | 0 | |
| | 4 | 0 | |
| imidacloprid | 20 | 33 | |
| | | found* | calc.** |
| compound of the formula (I-3) + | 500 + 20 | 67 | 33 |
| imidacloprid (25:1) | | | |
| according to the invention | | | |
| thiacloprid | 20 | 0 | |
| | | found* | calc.** |
| compound of the formula (I-2) + | 500 + 20 | 50 | 0 |
| thiacloprid (25:1) | | | |
| according to the invention | | | |
| compound of the formula (I-3) + | 500 + 20 | 50 | 0 |
| thiacloprid (25:1) | | | |
| according to the invention | | | |
| thiamethoxam | 20 | 50 | |
| | | found* | calc.** |
| compound of the formula (I-2) + | 500 + 20 | 100 | 50 |
| thiamethoxam (25:1) | | | |
| according to the invention | | | |
| acetamiprid | 20 | 0 | |
| | | found* | calc.** |
| compound of the formula (I-2) + | 500 + 20 | 33 | 0 |
| acetamiprid (25:1) | | | |
| according to the invention | | | |
| compound of the formula (I-3) + | 500 + 20 | 83 | 0 |
| acetamiprid (25:1) | | | |
| according to the invention | | | |
| abamectin | 0.16 | 0 | |
| | | found* | calc.** |
| compound of the formula (I-2) + | 20 + 0.16 | 50 | 0 |
| abamectin (125:1) | | | |
| according to the invention | | | |
| Cyazypyr | 0.16 | 33 | |
| | | found* | calc.** |
| compound of the formula (I-2) + | 4 + 0.16 | 67 | 33 |
| Cyazypyr (25:1) | | | |
| according to the invention | | | |
| 1-{2-fluoro-4-methyl-5-[(2,2,2- | 100 | 0 | |
| trifluoroethyl)sulphinyl]phenyl}-3- | | | |
| (trifluoromethyl)-1H-1,2,4- | | | |
| triazole-5-amine | | | |
| | | found* | calc.** |
| compound of the formula (I-2) + 1- | 500 + 100 | 100 | 0 |
| {2-fluoro-4-methyl-5-[(2,2,2- | | | |
| trifluoroethyl)sulphinyl]phenyl}-3- | | | |
| (trifluoromethyl)-1H-1,2,4- | | | |
| triazole-5-amine | | | |
| (5:1) | | | |
| according to the invention | | | |
| compound of the formula (I-3) + 1- | 500 + 100 | 100 | 0 |
| {2-fluoro-4-methyl-5-[(2,2,2- | | | |
| trifluoroethyl)sulphinyl]phenyl}-3- | | | |
| (trifluoromethyl)-1H-1,2,4- | | | |
| triazole-5-amine (5:1) | | | |
| according to the invention | | | |
| L-cyhalothrin | 0.8 | 33 | |
| | | found* | calc.** |
| compound of the formula (I-2) + | 100 + 0.8 | 100 | 33 |
| L-cyhalothrin (125:1) | | | |
| according to the invention | | | |
| compound of the formula (I-3) + | 100 + 0.8 | 100 | 33 |
| L-cyhalothrin (125:1) | | | |
| according to the invention | | | |
| β-cyfluthrin | 0.8 | 33 | |
| | | found* | calc.** |
| compound of the formula (I-3) + | 100 + 0.8 | 67 | 33 |
| β-cyfluthrin (125:1) | | | |
| according to the invention | | | |
| ethiprole | 0.16 | 0 | |
| | | found* | calc.** |
| compound of the formula (I-2) + | 4 + 0.16 | 50 | 0 |
| ethiprole (25:1) | | | |
| according to the invention | | | |
| compound of the formula (I-3) + | 4 + 0.16 | 67 | 0 |
| ethiprole (25:1) | | | |
| according to the invention | | | |
| indoxacarb | 0.8 | 0 | |
| | | found* | calc.** |
| compound of the formula (I-2) + | 4 + 0.8 | 67 | 0 |
| indoxacarb (5:1) | | | |
| according to the invention | | | |
| compound of the formula (I-3) + | 4 + 0.8 | 50 | 0 |
| indoxacarb (5:1) | | | |
| according to the invention | | | |
| lufenuron | 100 | 33 | |
| | | found* | calc.** |
| compound of the formula (I-2) + | 500 + 100 | 67 | 33 |
| lufenuron (5:1) | | | |
| according to the invention | | | |
| tebufenpyrad | 100 | 0 | |
| | | found* | calc.** |
| compound of the formula (I-2) + | 500 + 100 | 100 | 0 |
| tebufenpyrad (5:1) | | | |
| according to the invention | | | |
| compound of the formula (I-3) + | 500 + 100 | 67 | 0 |
| tebufenpyrad (5:1) | | | |
| according to the invention | | | |
| milbemectin | 20 | 0 | |
| | | found* | calc.** |
| compound of the formula (I-2) + | 500 + 20 | 67 | 0 |
| milbemectin (25:1) | | | |
| according to the invention | | | |
| compound of the formula (I-3) + | 500 + 20 | 33 | 0 |
| milbemectin (25:1) | | | |
| according to the invention | | | |
| novaluron | 100 | 0 | |
| | | found* | calc.** |
| compound of the formula (I-3) + | 500 + 100 | 33 | 0 |
| novaluron (5:1) | | | |
| according to the invention | | | |
| alpha-cypermethrin | 4 | 67 | |
| | | found* | calc.** |
| compound of the formula (I-2) + | 500 + 4 | 100 | 67 |
| alpha-cypermethrin (125:1) | | | |
| according to the invention | | | |
| compound of the formula (I-3) + | 500 + 4 | 100 | 67 |
| alpha-cypermethrin (125:1) | | | |
| according to the invention | | | |
| tefluthrin | 20 | 33 | |
| | | found* | calc.** |
| compound of the formula (I-3) + | 500 + 20 | 67 | 33 |
| tefluthrin (25:1) | | | |
| according to the invention | | | |

*found = activity found
**calc. = activity calculated using Colby's formula

### Example C

### Spodoptera Frugiperda Larvae Test

Solvent: 78 parts by weight of acetone
1.5 parts by weight of dimethylformamide

Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Cabbage leaves (Brassica oleracea) are treated by being sprayed with the preparation of active compound of the desired concentration and are populated with the armyworm (Spodoptera frugiperda) while the leaves are still moist.

After the desired period of time, the kill in % is determined. 100% means that all caterpillars have been killed; 0% means that none of the caterpillars have been killed. The kill rates determined are entered, into Colby's formula.

In this test, the following active compound combinations in accordance with the present application showed a synergistically enhanced activity compared to the active compounds applied individually:

TABLE C-1
Spodoptera frugiperda larvae test

| | Concentration | Kill | |
|---|---|---|---|
| Active compound | in g/ha | in % after 2^{d} | |
| compound of the formula (I-2) | 500 | 0 | |
| | 100 | 0 | |
| | 20 | 0 | |
| compound of the formula (I-3) | 500 | 0 | |
| metaflumizone | 100 | 0 | |
| | | found* | calc.** |
| compound of the formula (I-3) + | 500 + 100 | 33 | 0 |
| metaflumizone (5:1) | | | |
| according to the invention | | | |
| emamectin benzoate | 0.16 | 0 | |
| | | found* | calc.** |
| compound of the formula (I-2) + | 20 + 0.16 | 33 | 0 |
| emamectin benzoate (125:1) | | | |
| according to the invention | | | |
| methiocarb | 100 | 0 | |
| | | found* | calc.** |
| compound of the formula (I-3) + | 500 + 100 | 33 | 0 |
| methiocarb (5:1) | | | |
| according to the invention | | | |
| indoxacarb | 100 | 50 | |
| | | found* | calc.** |
| compound of the formula (I-2) + | 500 + 100 | 100 | 50 |
| indoxacarb (5:1) | | | |
| according to the invention | | | |
| compound of the formula (I-3) + | 500 + 100 | 83 | 50 |
| indoxacarb (5:1) | | | |
| according to the invention | | | |
| Rynaxypyr | 4 | 67 | |
| | | found* | calc.** |
| compound of the formula (I-2) + | 500 + 4 | 100 | 67 |
| Rynaxypyr (125:1) | | | |
| according to the invention | | | |
| compound of the formula (I-3) + | 500 + 4 | 100 | 67 |
| Rynaxypyr (125:1) | | | |
| according to the invention | | | |
| chlorfenapyr | 100 | 50 | |
| | | found* | calc.** |
| compound of the formula (I-2) + | 500 + 100 | 83 | 50 |
| chlorfenapyr (5:1) | | | |
| according to the invention | | | |
| compound of the formula (I-3) + | 500 + 100 | 100 | 50 |
| chlorfenapyr (5:1) | | | |
| according to the invention | | | |
| methoxyfenozide | 20 | 33 | |
| | | found* | calc.** |
| compound of the formula (I-2) + | 100 + 20 | 50 | 33 |
| methoxyfenozide (5:1) | | | |
| according to the invention | | | |

*found = activity found
**calc. = activity calculated using Colby's formula

TABLE C-2

| | Concentration | Kill | |
|---|---|---|---|
| Active compound | in g/ha | in % after 6^{d} | |
| compound of the formula (I-2) | 500 | 0 | |
| | 100 | 0 | |
| | 20 | 0 | |
| compound of the formula (I-3) | 500 | 0 | |
| | 100 | 0 | |
| | 20 | 0 | |
| flubendiamide | 4 | 33 | |
| | | found* | calc.** |
| compound of the formula (I-2) + | 100 + 4 | 50 | 33 |
| flubendiamide (25:1) | | | |
| according to the invention | | | |
| compound of the formula (I-3) + | 100 + 4 | 50 | 33 |
| flubendiamide (25:1) | | | |
| according to the invention | | | |
| pyridalyl | 4 | 17 | |
| | | found* | calc.** |
| compound of the formula (I-2) + | 100 + 4 | 50 | 17 |
| pyridalyl (25:1) | | | |
| according to the invention | | | |
| compound of the formula (I-3) + | 100 + 4 | 50 | 17 |
| pyridalyl (25:1) | | | |
| according to the invention | | | |
| Cyazypyr | 0.8 | 50 | |
| | | found* | calc.** |
| compound of the formula (I-2) + | 20 + 0.8 | 83 | 50 |
| Cyazypyr (25:1) | | | |
| according to the invention | | | |
| compound of the formula (I-3) + | 20 + 0.8 | 83 | 50 |
| Cyazypyr (25:1) | | | |
| according to the invention | | | |
| chlorpyrifos | 4 | 0 | |
| | | found* | calc.** |
| compound of the formula (I-2) + | 20 + 4 | 67 | 0 |
| chlorpyrifos (5:1) | | | |
| according to the invention | | | |
| compound of the formula (I-3) + | 20 + 4 | 50 | 0 |
| chlorpyrifos (5:1) | | | |
| according to the invention | | | |
| L-cyhalothrin | 0.8 | 50 | |
| | 0.16 | 0 | |
| | | found* | calc.** |
| compound of the formula (I-2) + | 100 + 0.8 | 100 | 50 |
| L-cyhalothrin (125:1) | | | |
| according to the invention | | | |
| compound of the formula (I-3) + | 20 + 0.16 | 33 | 0 |
| L-cyhalothrin (125:1) | | | |
| according to the invention | | | |
| β-cyfluthrin | 0.16 | 0 | |
| | | found* | calc.** |
| compound of the formula (I-2) + | 20 + 0.16 | 33 | 0 |
| β-cyfluthrin (125:1) | | | |
| according to the invention | | | |
| compound of the formula (I-3) + | 20 + 0.16 | 50 | 0 |
| β-cyfluthrin (125:1) | | | |
| according to the invention | | | |
| deltamethrin | 0.032 | 33 | |
| | | found* | calc.** |
| compound of the formula (I-3) + | 4 + 0.032 | 67 | 33 |
| deltamethrin (125:1) | | | |
| according to the invention | | | |
| fipronil | 4 | 0 | |
| | | found* | calc.** |
| compound of the formula (I-3) + | 20 + 4 | 33 | 0 |
| fipronil (5:1) | | | |
| according to the invention | | | |
| lufenuron | 4 | 0 | |
| | | found* | calc.** |
| compound of the formula (I-2) + | 20 + 4 | 33 | 0 |
| lufenuron (5:1) | | | |
| according to the invention | | | |
| compound of the formula (I-3) + | 20 + 4 | 50 | 0 |
| lufenuron (5:1) | | | |
| according to the invention | | | |
| transfluthrin | 4 | 33 | |
| | | found* | calc.** |
| compound of the formula (I-2) + | 20 + 4 | 50 | 33 |
| transfluthrin (5:1) | | | |
| according to the invention | | | |
| compound of the formula (I-3) + | 20 + 4 | 50 | 33 |
| transfluthrin (5:1) | | | |
| according to the invention | | | |
| carbofuran | 4 | 0 | |
| | | found* | calc.** |
| compound of the formula (I-2) + | 20 + 4 | 33 | 0 |
| carbofuran (5:1) | | | |
| according to the invention | | | |
| flufenoxuron | 20 | 33 | |
| | | found* | calc.** |
| compound of the formula (I-2) + | 500 + 20 | 100 | 33 |
| flufenoxuron (25:1) | | | |
| according to the invention | | | |
| compound of the formula (I-3) + | 500 + 20 | 100 | 33 |
| flufenoxuron (25:1) | | | |
| according to the invention | | | |
| aldicarb | 100 | 0 | |
| | | found* | calc.** |
| compound of the formula (I-2) + | 500 + 100 | 50 | 0 |
| aldicarb (5:1) | | | |
| according to the invention | | | |
| compound of the formula (I-3) + | 500 + 100 | 33 | 0 |
| aldicarb (5:1) | | | |
| according to the invention | | | |
| alpha-cypermethrin | 0.8 | 33 | |
| | | found* | calc.** |
| compound of the formula (I-2) + | 100 + 0.8 | 83 | 33 |
| alpha-cypermethrin (125:1) | | | |
| according to the invention | | | |
| compound of the formula (I-3) + | 100 + 0.8 | 83 | 33 |
| alpha-cypermethrin (125:1) | | | |
| according to the invention | | | |
| triflumuron | 4 | 17 | |
| | | found* | calc.** |
| compound of the formula (I-2) + | 20 + 4 | 100 | 17 |
| triflumuron (5:1) | | | |
| according to the invention | | | |
| compound of the formula (I-3) + | 20 + 4 | 50 | 17 |
| triflumuron (5:1) | | | |
| according to the invention | | | |
| acrinathrin | 0.8 | 0 | |
| | | found* | calc.** |
| compound of the formula (I-2) + | 20 + 0.8 | 50 | 0 |
| acrinathrin (25:1) | | | |
| according to the invention | | | |
| compound of the formula (I-3) + | 20 + 0.8 | 50 | 0 |
| acrinathrin (25:1) | | | |
| according to the invention | | | |

*found = activity found
**calc. = activity calculated using Colby's formula

### Example D

### Tetranychus Test

### OP-Resistant/Spray Treatment

Solvent: 78 parts by weight of acetone
1.5 parts by weight of dimethylformamide

Emulsifier: 0.5 part by weight of alkylaryl polyglycol ether

To produce a suitable preparation of active compound, 1 part by weight of active compound is mixed with the stated amounts of solvent and emulsifier, and the concentrate is diluted with emulsifier-containing water to the desired concentration.

Discs of bean leaves (Phaseolus vulgaris) which are infested by all stages of the greenhouse red spider mite (Tetranychus urticae) are sprayed with an active compound preparation of the desired concentration.

After the desired period of time, the effect in % is determined. 100% means that all of the spider mites have been killed; 0% means that none of the spider mites have been killed.

In this test, the following active compound combination in accordance with the present application showed a synergistically enhanced activity compared to the active compounds applied individually:

TABLE D-1
Tetranychus urticae test

| | Concentration | Kill | |
|---|---|---|---|
| Active compound | in g/ha | in % after 2^{d} | |
| Compound of the formula (I-2) | 500 | 0 | |
| | 100 | 0 | |
| | 20 | 0 | |
| | 4 | 0 | |
| Compound of the formula (I-3) | 500 | 0 | |
| | 20 | 0 | |
| | 4 | 0 | |
| spiromesifen | 20 | 0 | |
| | | found* | calc.** |
| compound of the formula (I-2) + | 500 + 20 | 20 | 0 |
| spiromesifen (25:1) | | | |
| according to the invention | | | |
| abamectin | 4 | 0 | |
| | | found* | calc.** |
| compound of the formula (I-2) + | 500 + 4 | 90 | 0 |
| abamectin (125:1) | | | |
| according to the invention | | | |
| compound of the formula (I-3) + | 500 + 4 | 100 | 0 |
| abamectin (125:1) | | | |
| according to the invention | | | |
| emamectin benzoate | 0.032 | 0 | |
| | | found* | calc.** |
| compound of the formula (I-3) + | 4 + 0.032 | 70 | 0 |
| emamectin benzoate (125:1) | | | |
| according to the invention | | | |
| Cyazypyr | 20 | 0 | |
| | | found* | calc.** |
| compound of the formula (I-3) + | 500 + 20 | 20 | 0 |
| Cyazypyr (25:1) | | | |
| according to the invention | | | |
| diafenthiuron | 4 | 0 | |
| | | found* | calc.** |
| compound of the formula (I-2) + | 20 + 4 | 20 | 0 |
| diafenthiuron (5:1) | | | |
| according to the invention | | | |
| compound of the formula (I-3) + | 20 + 4 | 20 | 0 |
| diafenthiuron (5:1) | | | |
| according to the invention | | | |
| tebufenpyrad | 4 | 70 | |
| | 0.8 | 0 | |
| | | found* | calc.** |
| compound of the formula (I-2) + | 4 + 0.8 | 20 | 0 |
| tebufenpyrad (5:1) | | | |
| according to the invention | | | |
| compound of the formula (I-3) + | 20 + 4 | 100 | 70 |
| tebufenpyrad (5:1) | | | |
| according to the invention | | | |
| gamma-cyhalothrin | 0.8 | 0 | |
| | | found* | calc.** |
| compound of the formula (I-2) + | 100 + 0.8 | 20 | 0 |
| gamma-cyhalothrin (125:1) | | | |
| according to the invention | | | |
| aldicarb | 100 | 0 | |
| | | found* | calc.** |
| compound of the formula (I-2) + | 500 + 100 | 70 | 0 |
| aldicarb (5:1) | | | |
| according to the invention | | | |

*found = activity found
**calc. = activity calculated using Colby's formula

TABLE D-2

| | Concentration | Kill |
|---|---|---|
| Active compound | in g/ha | in % after 6^{d} |
| compound of the formula (I-2) | 500 | 0 |
| | 4 | 0 |
| compound of the formula (I-3) | 500 | 0 |
| | 100 | 0 |
| | 20 | 0 |
| | 4 | 0 |
| spirodiclofen | 0.8 | 20 |

| | | found* | calc.** |
|---|---|---|---|
| compound of the formula (I-2) + | 4 + 0.8 | 70 | 20 |
| spirodiclofen (5:1) | | | |
| according to the invention | | | |
| compound of the formula (I-3) + | 4 + 0.8 | 70 | 20 |
| spirodiclofen (5:1) | | | |
| according to the invention | | | |
| pyridalyl | 20 | 10 | |
| | | found* | calc.** |
| compound of the formula (I-3) + | 500 + 20 | 30 | 10 |
| pyridalyl (25:1) | | | |
| according to the invention | | | |
| chlorpyrifos | 100 | 0 | |
| | | found* | calc.** |
| compound of the formula (I-3) + | 500 + 100 | 50 | 0 |
| chlorpyrifos (5:1) | | | |
| according to the invention | | | |
| 1-{2-fluoro-4-methyl-5-[(2,2,2- | 4 | 80 | |
| trifluoroethyl)sulphinyl]phenyl}-3- | 0.8 | 0 | |
| (trifluoromethyl)-1H-1,2,4- | | | |
| triazole-5-amine | | | |
| | | found* | calc.** |
| compound of the formula (I-2) + | 4 + 0.8 | 20 | 0 |
| 1-{2-fluoro-4-methyl-5-[(2,2,2- | | | |
| trifluoroethyl)sulphinyl]phenyl}- | | | |
| 3-(trifluoromethyl)-1H-1,2,4- | | | |
| triazole-5-amine (5:1) | | | |
| according to the invention | | | |
| compound of the formula (I-3) + 1- | 20 + 4 | 100 | 80 |
| {2-fluoro-4-methyl-5-[(2,2,2- | | | |
| trifluoroethyl)sulphinyl]phenyl}-3- | | | |
| (trifluoromethyl)-1H-1,2,4- | | | |
| triazole-5-amine (5:1) | | | |
| according to the invention | | | |
| sulfoxaflor | 4 | 0 | |
| | | found* | calc.** |
| compound of the formula (I-2) + | 500 + 4 | 70 | 0 |
| sulfoxaflor (125:1) | | | |
| according to the invention | | | |
| pyrifluquinazone | 100 | 0 | |
| | | found* | calc.** |
| compound of the formula (I-2) + | 500 + 100 | 20 | 0 |
| pyrifluquinazone (5:1) | | | |
| according to the invention | | | |
| L-cyhalothrin | 4 | 80 | |
| | 0.8 | 0 | |
| | | found* | calc.** |
| compound of the formula (I-2) + | 500 + 4 | 100 | 80 |
| L-cyhalothrin (125:1) | | | |
| according to the invention | | | |
| compound of the formula (I-3) + | 100 + 0.8 | 80 | 0 |
| L-cyhalothrin (125:1) | | | |
| according to the invention | | | |
| cypermethrin | 20 | 0 | |
| | | found* | calc.** |
| compound of the formula (I-2) + | 500 + 20 | 30 | 0 |
| cypermethrin (25:1) | | | |
| according to the invention | | | |
| compound of the formula (I-3) + | 500 + 20 | 20 | 0 |
| cypermethrin (25:1) | | | |
| according to the invention | | | |
| β-cyfluthrin | 4 | 0 | |
| | | found* | calc.** |
| compound of the formula (I-2) + | 500 + 4 | 80 | 0 |
| β-cyfluthrin (125:1) | | | |
| according to the invention | | | |
| compound of the formula (I-3) + | 500 + 4 | 20 | 0 |
| β-cyfluthrin (125:1) | | | |
| according to the invention | | | |
| spinosad | 20 | 80 | |
| | | found* | calc.** |
| compound of the formula (I-2) + | 500 + 20 | 100 | 80 |
| spinosad (25:1) | | | |
| according to the invention | | | |
| compound of the formula (I-3) + | 500 + 20 | 100 | 80 |
| spinosad (25:1) | | | |
| according to the invention | | | |
| fipronil | 100 | 0 | |
| | | found* | calc.** |
| compound of the formula (I-3) + | 500 + 100 | 30 | 0 |
| fipronil (5:1) | | | |
| according to the invention | | | |
| ethiprole | 20 | 0 | |
| | | found* | calc.** |
| compound of the formula (I-2) + | 500 + 20 | 30 | 0 |
| ethiprole (25:1) | | | |
| according to the invention | | | |
| compound of the formula (I-3) + | 500 + 20 | 20 | 0 |
| ethiprole (25:1) | | | |
| according to the invention | | | |

*found = activity found
**calc. = activity calculated using Colby's formula

1. A composition comprising at least one compound of the formula (I) 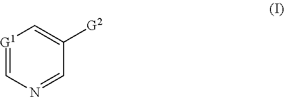
in which
(Ia)
G¹ represents N, CH or C-halogen,
G² represents 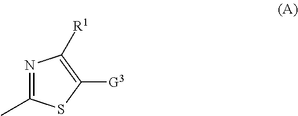
wherein
R¹ represents hydrogen or alkyl and
G³ represents optionally substituted heterocyclyl, represents optionally substituted heteroaryl or represents optionally substituted aryl or
(Ib)
G¹ represents N or C-halogen,
G² represents 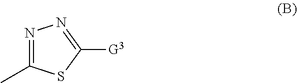
wherein
G³ represents optionally substituted heterocyclyl, represents optionally substituted heteroaryl or represents optionally substituted aryl or
(Ic)
G¹ represents CH,
G² represents 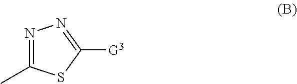
wherein
G³ represents optionally substituted heterocyclyl or represents substituted furanyl or represents thienyl which is substituted by halogen, nitro, amino, alkylamino, dialkylamino, haloalkyl, cycloalkylalkyl, alkoxy, haloalkoxy, alkylthio, alkoxyalkyl, bis(alkoxy)alkyl, alkoxycarbonyl, alpha-hydroxyiminoalkoxycarbonylmethyl, alpha-alkoxyiminoalkoxycarbonylmethyl, C(X)NR²R³, in which X represents oxygen or sulphur, R² represents hydrogen or alkyl and R³ represents alkyl, haloalkyl, alkoxy, cyanoalkyl, alkynyl, cycloalkyl; cycloalkylalkyl, alkoxyalkyl, alkylthioalkyl or arylalkyl or R² and R³ together with the nitrogen atom to which they are attached form a ring, alkylsulphinyl, alkylsulphonyl, heterocyclyl, aryl which may be substituted by halogen, cyano, nitro, alkyl or haloalkyl, heteroaryl which may be substituted by halogen, nitro, alkyl, haloalkyl, alkoxy, haloalkoxy, alkoxyalkyl, alkylthio, alkylthioalkyl or cycloalkyl, heteroarylalkyl which may be substituted by halogen, nitro, alkyl, haloalkyl, alkoxy, haloalkoxy, alkoxyalkyl, alkylthio, alkylthioalkyl or cycloalkyl or represents in each case optionally substituted hetaryl selected from the group consisting of pyrrolyl, pyrazolyl, imidazolyl, 1,2,3-triazolyl, 1,2,4-triazolyl, oxazolyl, isoxazolyl, thiazolyl, isothiazolyl, 1,2,3-oxadiazolyl, 1,2,4-oxadiazolyl, 1,3,4-oxadiazolyl, 1,2,5-oxadiazolyl, 1,2,3-thiadiazolyl, 1,2,4-thiadiazolyl, 1,3,4-thiadiazolyl, 1,2,5-thiadiazolyl, pyridyl, pyrimidinyl, pyridazinyl, pyrazinyl, 1,2,3-triazinyl, 1,2,4-triazinyl, 1,3,5-triazinyl, benzofuryl, benzisofuryl, benzothienyl, benzisothienyl, indolyl, isoindolyl, indazolyl, benzothiazolyl, benzisothiazolyl, benzoxazolyl, benzisoxazolyl, benzimidazolyl, 2,1,3-benzoxadiazole, quinolinyl, isoquinolinyl, cinnolinyl, phthalazinyl, quinazolinyl, quinoxalinyl, naphthyridinyl, benzotriazinyl, purinyl, pteridinyl and indolizinyl or represents cyano-, nitro-, haloalkoxy- or heterocyclyl-substituted aryl
or
(Id)
G¹ represents N, CH or C-halogen,
G² represents 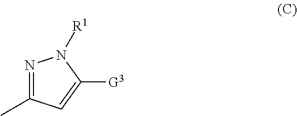
wherein
R¹ represents hydrogen or alkyl and
G³ represents optionally substituted heterocyclyl or represents optionally substituted heteroaryl or represents optionally substituted aryl,
and also salts, metal complexes and N-oxides of the compounds of the formula (I);
and one or more further active compounds from the group:
acetylcholine esterase (AChE) inhibitors II-1,
GABA-controlled chloride channel antagonists II-2,
sodium channel modulators/voltage-dependent sodium channel blockers II-3,
agonists/antagonists of the nicotinergic acetylcholine receptor II-4,
allosteric modulators of the acetylcholine receptor (agonists),
chloride channel activators,
II-7A juvenile hormone analogues,
active compounds having unknown or non-specific mechanisms of action,
II-8 fumigants,
II-9 selective antifeedants,
II-10 mite growth inhibitors,
inhibitors of oxidative phosphorylation, ATP disruptors II-12,
decouplers of oxidative phosphorylation by interruption of the H-proton gradient II-13,
microbial disruptors of the insect gut membrane,
inhibitors of chitin biosynthesis,
moulting disruptors,
ecdysone agonists/disruptors (II-18),
octopaminergic agonists,
II-20 site III electron transport inhibitors/site II electron transport inhibitors,
electron transport inhibitors,
II-22 blockers of voltage-gated sodium channels,
II-23 inhibitors of fatty acid biosynthesis,
II-25 neuronal inhibitors having an unknown mechanism of action,
ryanodine receptor effectors,
II-28 diamides, and
II-29 active compounds having an unknown mechanism of action.

2. The composition according to claim 1 further comprising extenders and/or surfactants.

3. The composition according to claim 1 comprising one compound of formula (I).

4. A method for controlling animal pests, comprising applying the composition according to claim 1 to said animal pests and/or a habitat thereof.

5. A process for preparing a composition according to claim 2, comprising mixing the composition according to claim 1 with extenders and/or surfactants.

6. The composition according to claim 1 wherein the (II-28) diamides are selected from the group consisting of
flubendiamide (II-28-1), 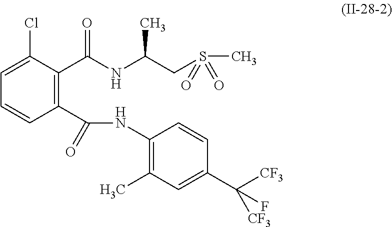
chlorantraniliprole (Rynaxypyr, II-28-3), and
cyantraniliprole (Cyazypyr, II-28-4) [chemical structure]
